(19) United States
(12) Patent Application Publication
(10) Pub. No.: US 2024/0331568 A1
(43) Pub. Date: Oct. 3, 2024

(54) DISPLAY OF TEXTS

(71) Applicant: READ TWOGETHER LTD., Jerusalem (IL)

(72) Inventors: David Allen Fesbinder, Jerusalem (IL); Alexander Postnikov, Cambridge, MA (US)

(21) Appl. No.: 18/732,461

(22) Filed: Jun. 3, 2024

Related U.S. Application Data
(63) Continuation-in-part of application No. 18/062,503, filed on Dec. 6, 2022, now Pat. No. 12,001,507.
(60) Provisional application No. 63/286,378, filed on Dec. 6, 2021.
(60) Provisional application No. 63/350,636, filed on Jun. 9, 2022.

(51) Int. Cl. G09B 19/06; G06F 40/106; G06F 40/109; G06F 40/40

(52) U.S. Cl. CPC G09B 19/06; G06F 40/106; G06F 40/109; G06F 40/40

(57) ABSTRACT

This invention presents a method and system for displaying text strings on an electronic display to reduce visual interference and enhance readability. The method involves receiving first and corresponding second text strings, which are translations or transliterations, and displaying them in paired formats. In some embodiments, horizontal offsets between the primary and secondary substrings, selective indentations, and real-time dynamic adjustments are made based on update conditions. The display format emphasizes clarity through distinct styling and careful spacing between substring pairs, preventing overlap and visual confusion. The system comprises processing circuitry and memory with executable instructions to implement these functionalities, ensuring optimal readability for bilingual or multilingual texts. This technology is particularly useful in digital educational tools and multilingual documentation, facilitating easier reading and comprehension.

### CROSS-REFERENCE TO RELATED APPLICATIONS

This application is a continuation-in-part of U.S. non-provisional patent application Ser. No. 18/062,503, filed on Dec. 6, 2022, which claims priority to U.S. provisional patent application No. 63/286,378, filed on Dec. 6, 2021, and U.S. provisional patent application No. 63/350,636, filed on Jun. 9, 2022. The contents of the above-referenced applications are hereby incorporated by reference in their entirety.

### BACKGROUND

The present disclosure relates to the field of displaying text, and, in particular, to the field of simultaneously displaying primary substrings and secondary substrings in an interference reducing manner.

### SCOPE OF PRIOR ART

The terms used to describe the prior art are listed at the start of the detailed description. One of the best ways to learn a foreign language is by reading foreign texts in that language. However, a reader may not understand every word in a given foreign text. Thus, to aid readers, language learning programs often display a native language translation of the foreign text immediately above the foreign text. For example, FIG. 1 shows an English translation immediately above a Danish foreign text. The proximity of these texts improves a reader's learning experience as he or she may quickly reference the English text to improve his or her understanding of the Danish text. While such arrangements good start, it is not immediately obvious which words or phrases in the Danish text correspond to which words or phrases in the English text. Here, does the Danish word “nyde” correspond to the English word “enjoy” or to “this”? Such ambiguities are especially prevalent for texts of different scripts or interlinear texts.

There is therefore a need in the art for a method and system of displaying a foreign text string and a translation text string such that the foreign substrings are delineated, and there is a correspondence between the foreign substrings and their corresponding translation substrings.

### SUMMARY

The present disclosure satisfies the foregoing needs by providing, inter alia, methods and systems for displaying substring pairs in an interference reducing manner.

One aspect of the present invention is directed to an advanced method and system for displaying two text strings on an electronic display in a manner that reduces visual interference and enhances readability. Specifically, it involves the innovative alignment and formatting of primary and secondary text strings, which consist of multiple substrings. The primary substrings could be any textual content, whereas the secondary substrings are translations or transliterations corresponding to the primary substrings, allowing for bilingual or multilingual display with minimized visual confusion.

Each primary substring is paired with its corresponding secondary substring to form a substring pair. The alignment of these pairs may include horizontally offsetting secondary substrings from their corresponding primary substrings. This offset may align with the reading direction of the text, enhancing the natural flow of reading. Furthermore, adjustments may be made to ensure the secondary substrings do not overlap more with adjacent primary substrings than with their corresponding primary ones. This careful spacing and alignment aim to prevent the text from becoming jumbled, thereby aiding in the reader's comprehension.

Additional sophisticated features include different styling options for primary and secondary substrings, which could involve variations in font, size, or color, thus distinguishing the translated or transliterated parts visually from the original text. The layout is dynamically adjusted in real-time based on certain update conditions, and the system is designed to continuously monitor for such conditions, ensuring that the display is always optimized for the latest content.

The method is flexible in handling different text structures and arrangements. For instance, substrings can be arranged vertically or non-vertically, and specific lines may be dedicated solely to cither primary or secondary substrings, avoiding the inclusion of unrelated text. This method also considers the spatial relationships between substrings, such as the overlap, indentation, and horizontal or vertical distances, to fine-tune the visual presentation.

Moreover, the invention includes a system embodiment comprising memory, processing circuitry, and executable instructions that when executed cause the system to implement the described method. There's also a non-transitory computer storage media aspect that stores the executable instructions which, when executed by computing devices, enable the described text display method.

In essence, this invention provides a methodical approach to displaying dual-language texts in a clear, organized, and visually appealing manner on digital displays, which can be particularly beneficial in educational tools, multilingual documentation, and electronic reading materials where clarity and ease of understanding are paramount.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 shows an English translation immediately above a Danish foreign text, as seen in the prior art.

FIGS. 2a-2p show definitions used throughout the disclosure.

FIG. 3 shows a block diagram illustrating example physical components of a computing device with which aspects of the disclosure may be practiced.

FIG. 4 is a flowchart showing steps of an exemplary method for the simultaneous display of a primary text string comprised of primary substrings and a secondary text string comprised of secondary substrings.

FIGS. 5a-5e show the steps of the method of FIG. 4 as applied to a computing device, according to an embodiment.

FIG. 6 shows demarcated substring pairs where the visual demarcations are equidistant from each other, according to an embodiment.

FIG. 7 shows demarcated substring pairs where the visual demarcations have a width of the substring pair, according to an embodiment.

FIG. 8 shows demarcated substring pairs where the visual demarcations have a reduced width, according to an embodiment.

FIG. 9 shows demarcated substring pairs where the visual demarcations are entirely above or entirely below the substrings pairs, according to an embodiment.

FIG. 10 shows demarcated substring pairs where the visual demarcations are consistently placed relative to the primary substrings, according to an embodiment.

FIG. 11 shows demarcated substring pairs where the secondary substrings are offset from their corresponding primary substrings, according to an embodiment.

FIGS. 12a-12c shows demarcated substring pairs where the visual demarcations comprise shapes that cause the secondary substrings to appear on a separate perspective plane relative to their corresponding primary substrings, according to an embodiment.

FIG. 13 shows demarcated substring pairs where the visual demarcations border or overlap only one of the substrings.

FIG. 14 shows demarcated substring pairs where the visual demarcations border or overlap both of the substrings.

FIG. 15 shows demarcated substring pairs where the topmost point of each visual demarcation overlaps a lower substring in a substring pair.

FIG. 16 shows demarcated substring pairs where the font size of each secondary substring is smaller than the font size of its corresponding primary substring, according to an embodiment.

FIG. 17 shows demarcated substring pairs where each secondary substring has a lighter shade than its corresponding primary substring, according to an embodiment.

FIG. 18 shows demarcated substring pairs where the demarcations are non-elliptical lines, according to an embodiment.

FIG. 19 shows demarcated substring pairs where one of the demarcations overlaps each of the primary substrings, according to an embodiment.

FIG. 20 shows demarcated substring pairs where the demarcation is an implied transparent oblique parallelogram with at least two shadow-outlined edges, according to an embodiment.

FIGS. 21-55 show substring pairs visually demarcated in multiple formats/modes, according to various non-limiting embodiments.

FIG. 56 is a flowchart showing steps of an exemplary method for the simultaneous display of a primary text string comprised of primary substrings and a secondary text string comprised of secondary substrings.

FIGS. 57a-57c show the steps of the method of FIG. 56 as applied to a computing device, according to an embodiment.

FIGS. 58-74 show substring pairs in multiple formats/configurations, according to various non-limiting embodiments.

FIG. 75a shows two sets of demarcations, according to an embodiment.

FIG. 75b shows a demarcated Spanish text string with defined substructures and superstructures, according to an embodiment.

FIG. 75c shows two sets of demarcations (top) and a demarcated Spanish text string (bottom) where immediately adjacent related demarcations are not distinguishable.

FIG. 75d shows two sets of demarcations (top) and a demarcated Spanish text string (bottom) where immediately adjacent related demarcations are not visually linked.

FIG. 75e shows two sets of demarcations (top) and a demarcated Spanish text string (bottom) where immediately adjacent unrelated demarcations are visually linked.

FIGS. 75f-75y show sets of demarcations (top) and demarcated text strings (bottom) with defined substructures and superstructures, according to various embodiments.

FIGS. 76a-76e show sets of demarcations (top) and demarcated text strings (bottom) with defined associations among text substrings, according to various embodiments.

FIGS. 77a-77c show sets of demarcations (top) and demarcated text strings (bottom) with defined associations among text substrings, according to various embodiments.

FIG. 78 shows a block diagram illustrating example physical components of a rendering device with which aspects of the disclosure may be practiced.

FIG. 79 shows a method for displaying, on an electronic display, a demarcated text string, according to an embodiment.

FIGS. 80a-80b show the method of FIG. 79 as applied to an electronic device, according to an embodiment.

FIG. 81a shows a set of demarcations, according to an embodiment.

FIG. 81b shows a demarcated text string, according to an embodiment.

FIG. 82 shows a method for displaying, on an electronic display, a demarcated text string, according to an embodiment.

FIGS. 83a-83b show the method of FIG. 82 as applied to an electronic device, according to an embodiment.

FIG. 84 shows a comparative-text display format (CTDF) that can employ a related text layout, according to an embodiment.

FIG. 85 is a sample augmented reality screen with the original spoken words and translated words superimposed on the image.

FIG. 86 shows demarcated substring pairs, according to an embodiment.

FIGS. 87a-87b shows two text strings, according to an embodiment.

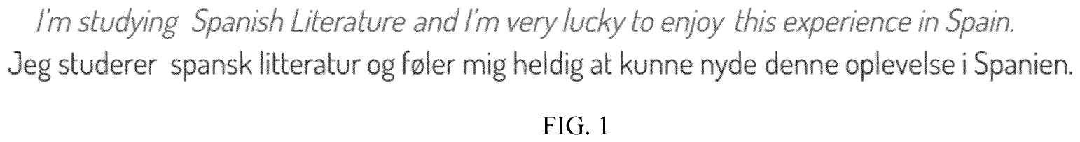

### DETAILED DESCRIPTION

The disclosed approaches may be provided in a variety of manners, for example, procedural, computer implement, integrated into a system or apparatus, provided as a computer programming product, and the like.

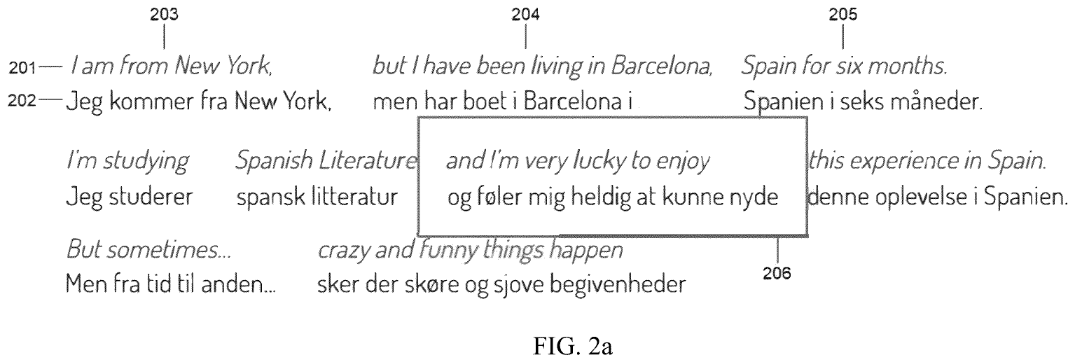

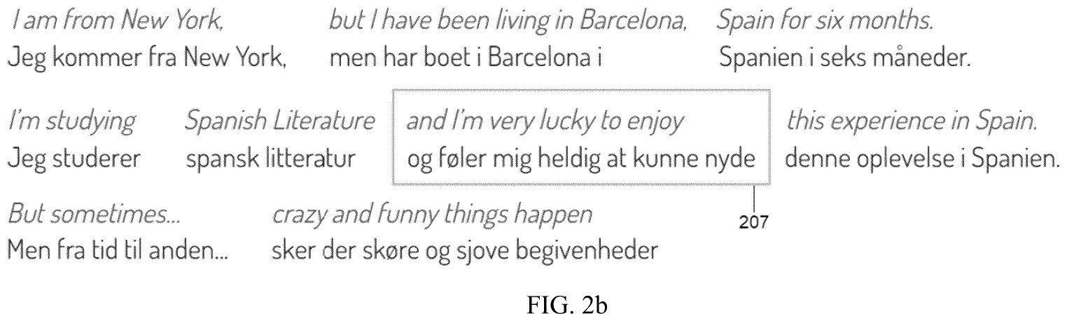

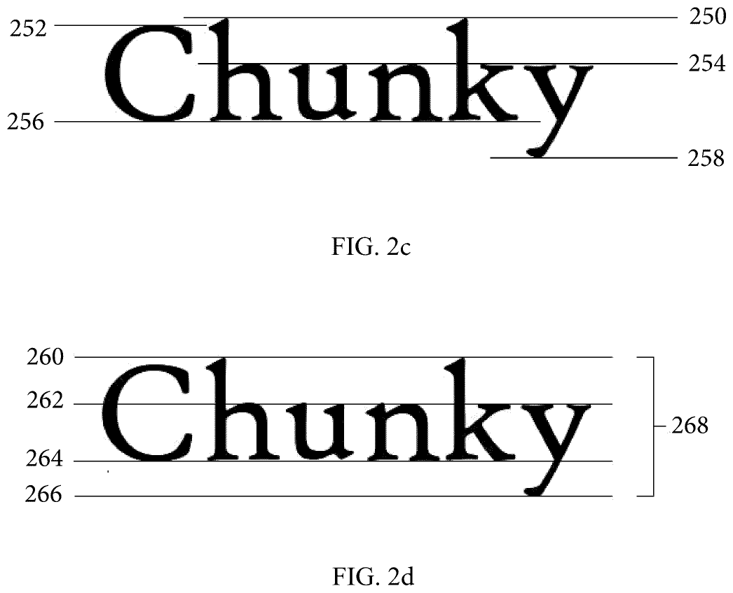

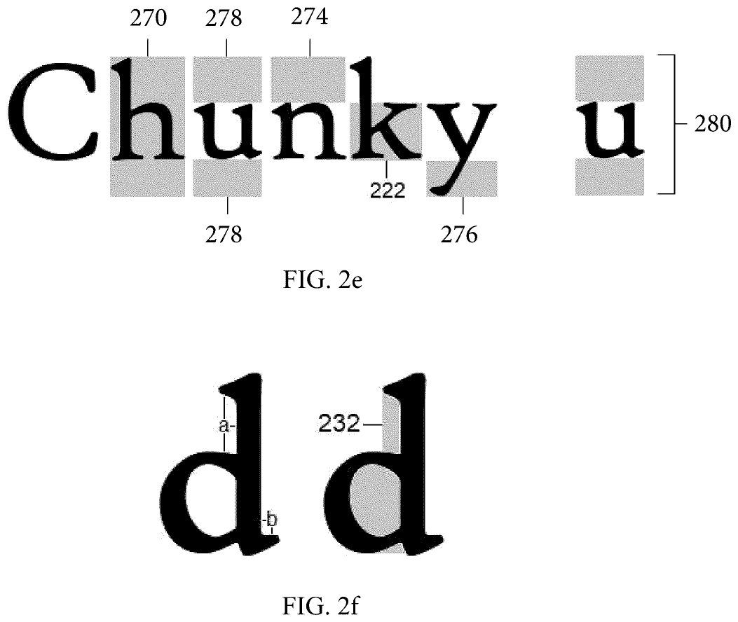

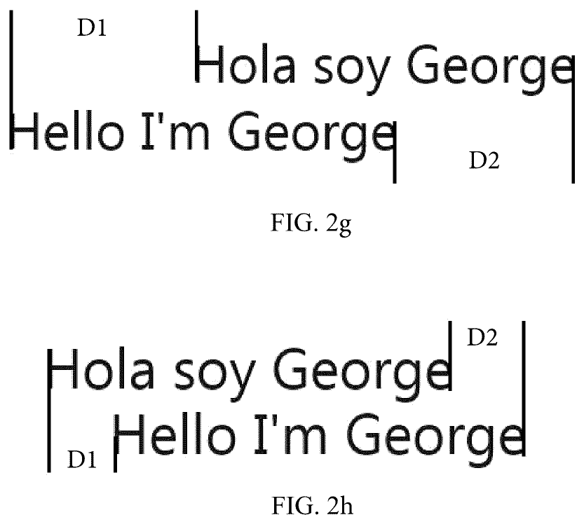

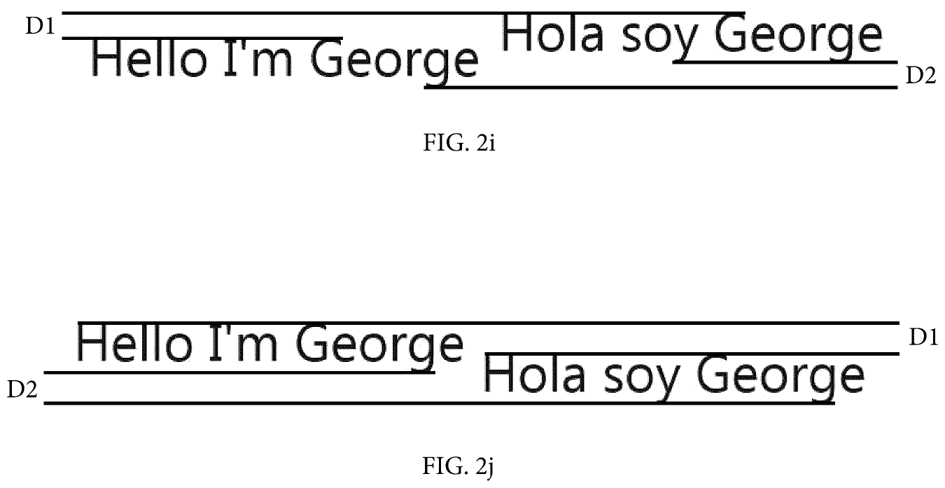

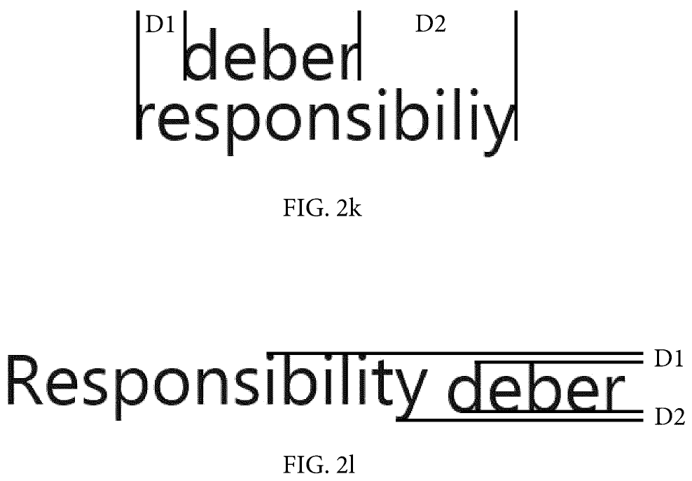

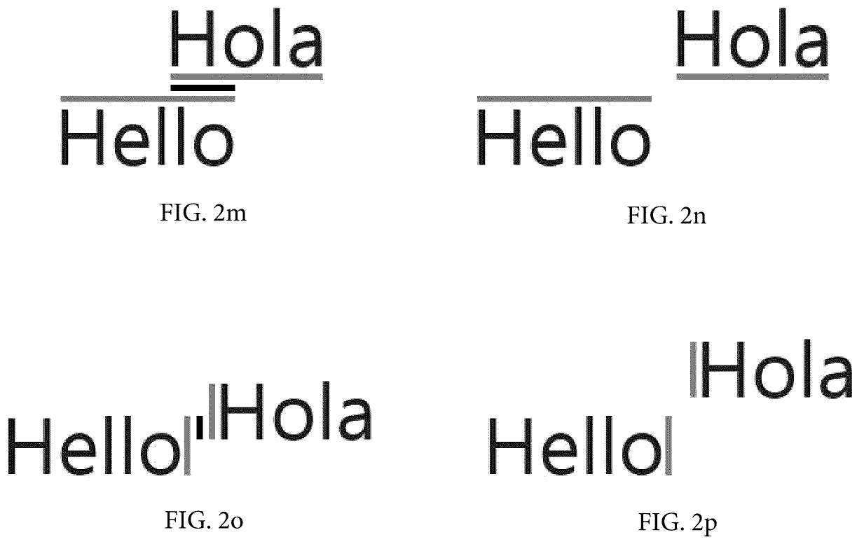

For the sake of convenience, the terms used to describe the prior art and various embodiments of the present invention are defined below. Some terms are illustrated in FIGS. 2a-2p for further clarification.

Display (verb): The verb “display,” unless specified otherwise, refers to the act of presenting texts and/or content strings in any format that may be perceived by a reader of the texts and/or content strings, for example, but not limited to, presenting the texts and/or content strings on digital screens, printed medium, as holographs, and the like.

Display (noun): The noun “display,” unless specified otherwise, refers to any sort of presentation of texts and/or content strings that may be perceived by a reader of the texts and/or content strings, for example, but not limited to, a presentation of the texts and/or content strings on digital screens, printed medium, as holographs, and the like.

Bordering: A text or object borders another text or object when an edge of the text or object is flush with the edge of another text or object.

Overlapping: A text or object overlaps another text or object when the body of the text or object occupies the same space as the body of another text or object.

Superimposing: A first text or object superimposes another text or object when only one of the texts or objects is visible in any overlapping portions.

Text string: A string of at least one character.

Primary text string (202): A text string that is the primary focus of a reader's attention. In FIG. 2, the Danish text string is the primary focus for a reader learning Danish, for instance. It would be appreciated that while the ‘string’ has been exemplified in the instant disclosure in the form of a text, it could be any other form/representation of a string, for instance, of one or more numbers, alphanumeric representations, codes, written expressions, graphical symbols, or a combination thereof. This non-limiting definition of ‘text’ and scope thereof is therefore applicable to all the below texts.

Secondary text string (201): A text string that is the secondary focus of a reader's attention. In FIG. 2, the English text string is the secondary focus for a reader learning Danish.

Substrings (203, 204, 205): Unique portions of a text string. In FIG. 2, the primary and secondary text strings have been split into three primary substrings and three secondary substrings.

Substring pair: A secondary substring placed adjacent to its corresponding primary substring, indicating a correspondence and/or association and/or mapping of any desired/defined nature between the two substrings. In FIG. 2, the English substring “I'm studying” and its corresponding Danish substring “Jeg studerer” form a substring pair, for instance.

Substructure: Substructures may be any smaller portion of a text string, including, but not limited to, words, groups of words, or phrases. A plurality of text string substructures comprises a text string superstructure.

Superstructures: Superstructures may be any larger portion of a text string including, but not limited to, groups of words, phrases, or sentences. Text string superstructures are comprised of a plurality of text string substructures.

Structural Unit: A structural unit can be any portion of a text string or the entirety of the text string. For example, letters, words, phrases, sentences, paragraphs, etc, are all types of structural units that can comprise a text string.

Correspondence area (206): A rectangular area containing a single substring pair where the top edge of the correspondence area extends to, but does not border, an immediately above text or object, the bottom edge of the correspondence area extends to, but does not border, an immediately below text or object, the right edge of the correspondence area extends to, but does not border, an immediately right text or object, and the left edge of the correspondence area extends to, but does not border, an immediately left text or object. In FIG. 2a, a grey reference box 206 outlines the correspondence area of the substring pair comprised of the English substring “and I'm very lucky to enjoy” and its corresponding Danish substring “og foler mig heldig at kunne nyde.” It would be appreciated that the visual demarcation can be of any desired shape, size, dimension or any other graphic representation that can encompass or create a boundary including dotted lines or dots or any other representation to help demarcate and separately display/identify the substring pair. It would further be appreciated that correspondence area may not be displayed per se to the reader, and can be computed for placement of demarcations using the instant method(s).

Reduced correspondence area (207): A rectangular area containing a single substring pair where the top edge of the reduced correspondence area extends halfway to an immediately above text or object, the bottom edge of the correspondence area extends halfway to an immediately below text or object, the right edge of the correspondence area extends halfway to an immediately right text or object, and the left edge of the correspondence area extends halfway to an immediately left text or object. In FIG. 2b, a grey reference box 207 outlines the reduced correspondence area of the substring pair comprised of the English substring “and I'm very lucky to enjoy” and its corresponding Danish substring “og foler mig heldig at kunne nyde.” Alternatively, the reduced correspondence area is a rectangular area containing a single substring pair where the top edge of the reduced correspondence area extends less than halfway to an immediately above text or object, the bottom edge of the correspondence area extends less than halfway to an immediately below text or object, the right edge of the correspondence area extends less than halfway to an immediately right text or object, and the left edge of the correspondence area extends less than halfway to an immediately left text or object. Such reduced correspondence areas have an empty space in between adjacent substring pairs.

Ascender height 250: The height of the ascenders, considered characteristic of a given typeface, font, or script. As illustrated in FIG. 2c, the ascender height of “Chunky” would be the height of the topmost points of the “h” and “k.” The ascender height is sometimes referred to throughout the detailed description as the topmost point of a text in cases where the ascender height of a text is greater than or equal to the cap height of a text.

Ascender line: A horizontal line at the ascender height of a given typeface, font, or script.

Cap height 252: The height of capital letters, considered characteristic of a given typeface, font, or script. As illustrated in FIG. 2c, the cap height of “Chunky” would be the height of the topmost point of the “C.” The cap height is sometimes referred to throughout the detailed description as the topmost point of a text in cases where the cap height of a text is greater than or equal to the ascender height of a text.

Cap line: A horizontal line at the cap height of a given typeface, font, or script.

X-height 254: The height of a lower-case x, considered characteristic of a given typeface, font, or script. As illustrated in FIG. 2c, the x-height of “Chunky” would be the height of the topmost points of the “u,” “n,” and “y.” It shall be appreciated that for typefaces that do not employ Latin characters, such as Hebrew, an equivalent mean-height concept is applicable.

X-height line: A horizonal line at the x-height of a given typeface, font, or script. It shall be appreciated that for typefaces that do not employ Latin characters, such as Hebrew, an equivalent mean-line concept is applicable.

Base height 256: The height of the base of most letters of a given typeface, font, or script, typically set to 0. As illustrated in FIG. 2c, the base height of “Chunky” would be the height of the bottommost points of the “C,” “h,” “u,” “n,” and “k.”

Base line: A horizonal line at the base height of a given typeface, font, or script.

Descender height 258: The height of the descenders, considered characteristic of a given typeface, font, or script. As illustrated in FIG. 2c, the descender height of “Chunky” would be the height of the bottommost point of the “y.” The descender height is sometimes referred to throughout the description as the bottommost point of a text.

Descender line: A horizontal line at the descender height of a given typeface, font, or script.

Text ceiling 260: The typical position of the topmost points of a text, considered characteristic of a given typeface, font, or script. As illustrated in FIG. 2d, the text ceiling of the characters in “Chunky” is the position of topmost points of the “h,” and “k.”

Text x-height 262: The typical position of the x-height line of a text, considered characteristic of a given typeface, font, or script. As illustrated in FIG. 2d, the text x-height of the characters in “Chunky” is near the topmost points of the “u,” “n,” and “y.” It shall be appreciated that for typefaces that do not employ Latin characters, such as Hebrew, an equivalent text mean-height concept is applicable.

Text base line 264: The typical position of the base line of a text, considered characteristic of a given typeface, font, or script. As illustrated in FIG. 2d, the text base line the characters in “Chunky” is near the bottommost points of the “C,” “h,” “u,” “n,” “k”, and “y.”

Text floor 266: The typical position of the bottommost points of a text, considered characteristic of a given typeface, font, or script. As illustrated in FIG. 2d, the text floor of the characters in “Chunky” is the position of the bottommost point of the “y.”

Text height 268: The typical distance from the text floor to the text ceiling, considered characteristic of a given typeface, font, or script. As illustrated in FIG. 2d, the text height of the characters in “Chunky” is the distance from the bottommost point of “y” to the topmost points of “h” and “k.”

Footprint 270: A rectangular area for each character, the bottom edge of the footprint bounded by a horizontal line at the text floor, the top edge of the footprint bounded by a horizontal line at the text ceiling, the left edge of the footprint bounded by a vertical line at the leftmost point of the character, and the right edge of the footprint bounded by a vertical line at the rightmost point of the character. As illustrated in FIG. 2c, the footprint of the “h” in “Chunky” is highlighted with a grey reference box behind the “h.” The bottom edge of the footprint is bounded by a horizontal line at the text floor, the top edge of the footprint is bounded by a horizontal line at the text ceiling, the left edge of the footprint is bounded by a vertical line at the leftmost point of “k”, and the right edge of the footprint is bounded by a vertical line at the rightmost point of “k”.

Inner airspace 222: A rectangular area for each character, the bottom edge of the airspace bounded by the text base line, the top edge of the airspace bounded by the text x-height line, the left edge of the airspace bounded by a vertical line at the leftmost point of the character, and the right edge of the airspace bounded by a vertical line at the rightmost point of the character. As illustrated in FIG. 2c, the inner airspace of the “k” in “Chunky” is highlighted with a grey reference box behind the “k.” The bottom edge of the airspace is bounded by the text base line of “k”, the top edge of the airspace is bounded by the text x-height line of “k”, the left edge of the airspace is bounded by a vertical line at the leftmost point of “k”, and the right edge of the airspace is bounded by a vertical line at the rightmost point of “k”.

Upper airspace 274: A rectangular area for each character, the bottom edge of the airspace bounded by the text x-height line, the top edge of the airspace bounded by a horizontal line at the text ceiling, the left edge of the airspace bounded by a vertical line at the leftmost point of the character, and the right edge of the airspace bounded by a vertical line at the rightmost point of the character. As illustrated in FIG. 2e, the upper airspace of the of the “n” in “Chunky” is highlighted with a grey reference box. The bottom edge of the airspace bounded by the text x-height line of “n”, the top edge of the airspace is bounded by a horizonal line at the text ceiling, the left edge of the airspace is bounded by a vertical line at the leftmost point of “n”, and the right edge of the airspace bounded by a vertical line at the rightmost point of “n”.

Lower airspace 276: A rectangular area for each character, the bottom edge of the airspace bounded by a horizontal line at the text floor, the top edge of the airspace bounded by a horizontal line at the text base line, the left edge of the airspace bounded by a vertical line at the leftmost point of the character, and the right edge of the airspace bounded by a vertical line at the rightmost point of the character. As illustrated in FIG. 2c, the lower airspace of the of the “y” in “Chunky” is highlighted with a grey reference box. The bottom edge of the airspace is bounded by a horizontal line at the text floor, the top edge of the airspace is bounded by the text base line of “n”, the left edge of the airspace is bounded by a vertical line at the leftmost point of “n”, and the right edge of the airspace bounded by a vertical line at the rightmost point of “n”.

Outer airspace 278: The combination of the upper airspace and the lower airspace of each character. As illustrated in FIG. 2c, the outer airspace of the “u” in “Chunky” is highlighted with grey reference boxes.

Character height 280: The distance from the bottommost point of the outer airspace to the topmost point of the outer airspace of a character. As illustrated in FIG. 2e, the character height of the “u” in “Chunky” would be the distance from the bottommost point of the outer airspace to the topmost point of the outer airspace of the “u.”

Internal airspace 232: An area for each character, the area defined by the set of points that are surrounded by the character on at least three sides. As illustrated in FIG. 2f (left), point “a” falls within the internal airspace of the character “d” while point “b” falls outside of the internal airspace of the character “d”. The internal airspace of the character “d” is highlighted in grey shading in FIG. 2d (right).

Deemphasis: Any modification to text that makes the deemphasized text less prominent than nearby text. For example, deemphasizing a portion of a character or substring makes the deemphasized portion of the character or substring less prominent than a remainder of the character or substring. Types of deemphasis may include, but are not limited to, scaling down (e.g., reducing a width or height of text), shading (e.g., making text lighter), gradual shading (e.g., making text have a shading gradient), hollowing-out (e.g., removing an inside of a text, leaving only the edges of the text outlined), truncation (e.g, removing character strokes of a text), etc.

Horizontal offset: A second substring is horizontally offset from a fist substring if 1) the rightmost point of the second substring is to the right of the rightmost point of the first substring and 2) the leftmost point of the second substring is to the right of the leftmost point of the first substring or 1) the rightmost point of the second substring is to the left of the rightmost point of the first substring and 2) the leftmost point of the second substring is to the left of the leftmost point of the first substring. For example, in FIG. 2g, the second substring “Hola soy George” is horizontally offset to the right of the first substring “Hello I'm George” where the leftmost point of “Hola soy George” is distance D1 to right of the leftmost point of “Hello I'm George” and the rightmost point of “Hola soy George” is distance D2 to the right of the rightmost point of “Hello I'm George. Likewise, in FIG. 2h, the second substring “Hola soy George” is horizontally offset to the left of the first substring “Hello I'm George” where the leftmost point of “Hola soy George” is distance D1 to left of the leftmost point of “Hello I'm George” and the rightmost point of “Hola soy George” is distance D2 to the left of the rightmost point of “Hello I'm George.

A second substring is also horizontally offset from a fist substring if, when the reading direction of the first substring is left to right, the 1) the leftmost point of the second substring is to the right of the leftmost point of the first substring and 2) the majority of the width of the second substring is in between the center point of the first substring and the rightmost point of the first substring.

A second substring is also horizontally offset from a fist substring if, when the reading direction of the first substring is right to left, the 1) the rightmost point of the second substring is to the left of the rightmost point of the first substring and 2) the majority of the width of the second substring is in between the center point of the first substring and the leftmost point of the first substring.

A second substring is also horizontally offset from a first substring if, when the reading direction of the first substring is left to right, the 1) the leftmost point of the second substring is to the right of the leftmost point of the first substring and 2) at least two thirds of the width of the second substring is in between the center point of the first substring and the rightmost point of the first substring.

A second substring is also horizontally offset from a first substring if, when the reading direction of the first substring is right to left, the 1) the rightmost point of the second substring is to the left of the rightmost point of the first substring and 2) at least two thirds of the width of the second substring is in between the center point of the first substring and the leftmost point of the first substring.

Vertical offset: A second substring is vertically offset from a first substring if 1) the topmost point of the second substring is above the topmost point of the first substring and 2) the bottommost point of the second substring is above the bottommost point of the first substring or 1) the topmost point of the second substring is below the topmost point of the first substring and 2) the bottommost point of the second substring is below the bottommost point of the first substring. For example, in FIG. 2i, the second substring “Hola soy George” is vertically offset above the first substring “Hello I'm George” where the topmost point of “Hola soy George” is distance D1 above the topmost point of “Hello I'm George” and the bottommost point of “Hola soy George” is distance D2 above the bottommost point of “Hello I'm George. Likewise, in FIG. 2j, the second substring “Hola soy George” is vertically offset below the first substring “Hello I'm George” where the topmost point of “Hola soy George” is distance D1 below the topmost point of “Hello I'm George” and the bottommost point of “Hola soy George” is distance D2 below the bottommost point of “Hello I'm George.

Horizontal indent: A second substring is horizontally indented from a first substring if 1) the rightmost point of the second substring is to the left of the rightmost point of the first substring or 2) the leftmost point of the second substring is to the right of the leftmost point of the first substring. For example, in FIG. 2k, the second substring “deber” is horizontally indented to the right of the first substring “responsibility” where the leftmost point of “deber” is distance D1 to right of the leftmost point of “responsibility”. Likewise, the second substring “deber” is also horizontally indented to the left of the first substring “responsibility” where the rightmost point of “deber” is distance D2 to the left of the rightmost point of “responsibility”.

Vertical indent: A second substring is vertically indented from a first substring if 1) the topmost point of the second substring is below the topmost point of the first substring or 2) the bottommost point of the second substring is above the bottommost point of the first substring. For example, in FIG. 2l, the second substring “deber” is vertically indented below the first substring “responsibility” where the topmostpoint of “deber” is distance D1 below the topmost point of “responsibility”. Likewise, the second substring “deber” is also vertically indented above the first substring “responsibility” where the bottommost point of “deber” is distance D2 above the bottommost point of “responsibility”.

Horizontal overlap: A first substring and a second substring horizontally overlap if 1) the width of the second substring is in the same column as the width of the first substring. For example, in FIG. 2m, the second substring “Hola” horizontally overlaps the first substring “Hello” where the grey line below “Hola” demarcates the width of “Hola”, the grey line above “Hello” demarcates the width of “Hello” and the black line in between “Hola” and “Hello” demarcates the width of the horizontal overlap of “Hola” and “Hello”. In contrast, the “Hola” and “Hello” of FIG. 2n do not horizontally overlap.

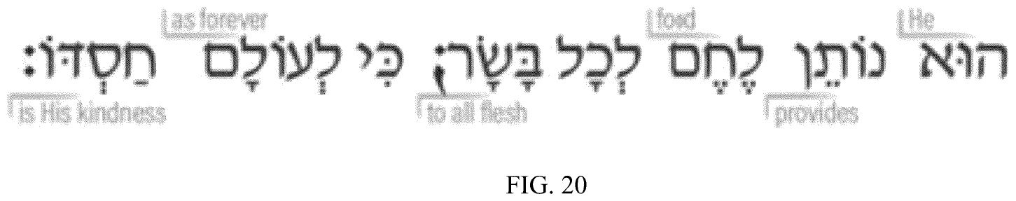

Vertical overlap: A first substring and a second substring vertically overlap if 1) the height of the second substring is in the same row as the height of the first substring. For example, in FIG. 20, the second substring “Hola” vertically overlaps the first substring “Hello” where the grey line to the left of “Hola” demarcates the height of “Hola”, the grey line to the right of “Hello” demarcates the height of “Hello” and the black line in between “Hola” and “Hello” demarcates the height of the horizontal overlap of “Hola” and “Hello”. In contrast, the “Hola” and “Hello” of FIG. 2p do not vertically overlap.

The definitions for horizontal offset, vertical offset, horizontal indent, vertical indent, horizontal overlap, and vertical overlap are provided for texts strings with a generally left-to-right or right-to-left reading directionality. However, for these definitions to be applicable to text strings with a top-to-bottom or bottom-to-top reading directionality, positional terms in these definitions should be consistently rotated by 90 degrees. For example, the positional term “rightmost” should be replaced with “bottommost”, the positional term “leftmost” should be replaced with “topmost”, and so on. Alternatively, for these definitions to be application to text strings with a non-standard reading direction (e.g., any non-horizontal reading direction), the frame of reference needs to be adjusted such that the reading directionality of the text string becomes left-to-right or right-to-left. For example, if a reading directionality of the text string is bottom-left to top-right, the frame of reference is rotated 45 degrees such that the reading directionality of the text string becomes left-to-right. Such measures ensure that the methods described herein are applicable to text strings with any reading directionality.

Visual demarcation (herein referred to as a demarcation): A continuous non-background, non-text object. While the instant specification focuses on rectangular demarcations, demarcations can be of any shape, color, contour, boundary, or a combination thereof. Also, it may be appreciated that the demarcations can be kept consistent in terms of its position and representation for each pair of substrings with other visual demarcations to enable smoother reading for the user.

The “Style” of a character or substring includes its font, size, and other typographic parameters that dictate the appearance of the character or substring.

Receiving: Any method for a computing device to obtain data and/or metadata. For example, the computing device can receive character data from a user input (e.g., using a keyboard), from internal memory (e.g., a hard drive), from external memory (e.g., a database), from data generation (e.g., a translation module generates a translation of another text), and so on.

It shall be noted that, unless specified otherwise, the following exemplary methods can be applied to characters and texts of any typeface, font, and size. For example, the methods can be applied to characters displayed in 12-point Times New Roman typeface as well as to characters displayed in 10-point Calibri typeface. These examples, as well as all other illustrated and described typefaces, font sizes, and fonts, are not inclusive and shall not be interpreted in any way to limit the scope of the present invention.

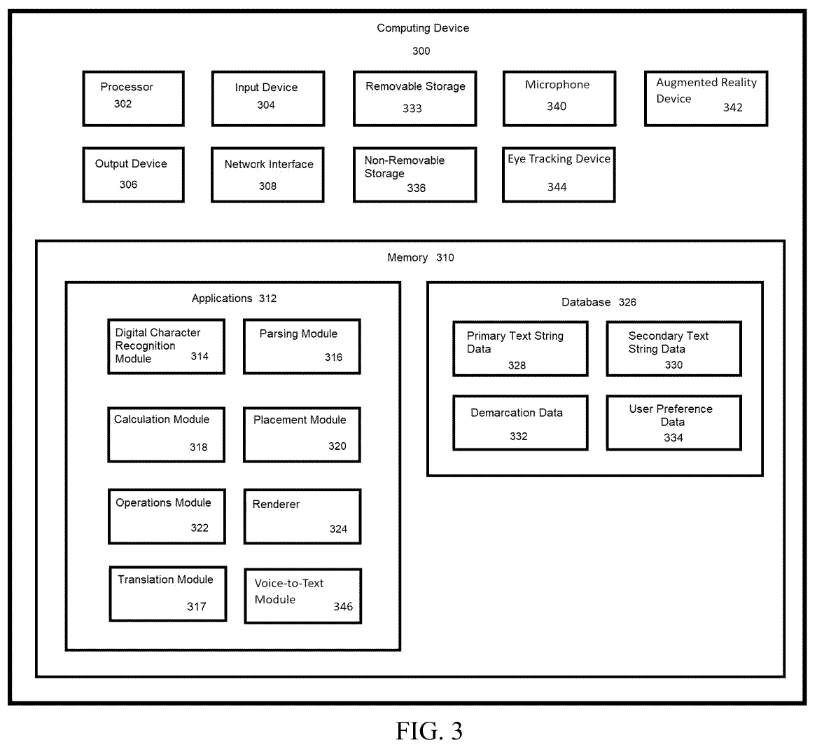

Reference is now made to FIG. 3, which shows a block diagram illustrating example physical components of a computing device 300 with which aspects of the disclosure may be practiced. The computing device may be referred to as the system.

In a preferred embodiment, the computing device 300 includes at least one processor 302, an input device 304 such as a keyboard, mouse, and or touchscreen, and an output device 306 such as a printer or an electronic display in any of the various forms associated with computing devices. The computing device may also include a network interface 308 for network enablement. It should be appreciated that processing may be implemented either locally or remotely via various forms of wireless or wired networking technologies or a combination of both.

In some embodiments, the computing device 300 includes a microphone 340 electrically connected to the processor 302, either directly or through a network interface 308. The microphone 340 could be one of the input devices 304. Microphone 340 could be used to listen for spoken words and to provide an input of spoken words to the computing device 300.

The computing device 300 could also include an augmented reality device 342 electrically connected, either directly or through the network interface 308, to provide a view of a user's surroundings along with translated words of what is spoken. The augmented reality device 342 could be an output device 306.

An eye-tracking device 344 could also be electrically connected to the computer device 300, either directly or through a network interface 308. The eye tracking device 344 could be a small video camera that looks into a user's retina to see the image on the back of the eye, thus detecting what the eye is looking at. In other embodiments, the eye tracker 344 captures the position or location of the user's eyes on one small video camera and the place the eye is looking on a second video camera. The first video camera and the second video camera work together so that the second video camera captures what the eye is gazing upon. Both eye tracing 344 embodiments provide the computing device 300 with a video stream of what the eye is looking at.

The eye tracking device 344 could be used in conjunction with the renderer 324 to determine when the user has finished reading a page of text so that the renderer can display the next page of text/translation or scroll the next line of the text/translation.

In another embodiment, the eye tracking device 344 could be used to provide feedback to a language teacher on how fast a student is reading in the foreign language or to provide feedback to the teach on whether the student is looking at the foreign language or the translation. The feedback could also notify the teacher of areas where the student is having difficulty. The eye tracking device 344 could compile statistics on where the student's eyes are as the student reads a passage, and the statistics could be sent to the teacher. These statistics could include eye position, eye movements, and eye movement patterns. The statistics could be provided to a teacher and/or the student.

In one embodiment, the renderer 324 could fade (or deemphasize) the student's native text as the student progresses through the translation, forcing the student to rely on the foreign language.

The memory 310 may include various types of short and long-term memory as is known in the art. Memory 310 may be loaded with various applications 312 including a digital character recognition module 314 for identifying text strings on electronic displays as will be further discussed, a parsing module 316 for identifying text strings and associated text string metadata by parsing the tags of HTML content and associated Cascading Style Sheet (CSS) files as will be further discussed, a translation module 317 for translating various foreign languages into either English or other chosen languages, a calculation module 318 for defining correspondence areas of substring pairs as will be further discussed, a placement module 320 for placing text strings, substrings, and/or demarcations as will be further discussed, an operations module 322 for performing various modifications to text strings, substrings, and/or demarcations as will be further discussed, and a renderer 324 for rendering text strings, substrings, and/or demarcations for display as will be further discussed. Accordingly, memory 310 includes all necessary modules per each embodiment.

The parsing module 316 could be a series of instructions for the at least one processor 302, stored in the memory 310, and organized as an application or a subroutine. The parsing module 316 could identify text strings and associated text string metadata by parsing the tags of HTML content and associated Cascading Style Sheet (CSS) files. The parsing module 316 may take HTML content, CSS files, XML content, DOCX-encoded content, PDF-encoded content, simple ASCII strings, or similar. This module could use traditional parsing techniques of searching for delimiters such as spaces, periods, tabs, commas, and other punctuation types. The words in the table may next be analyzed to convert the word into its stem by removing parts of speech that are attached to the word, such as plurality. Some descriptions call finding this process lemmatization—figuring out the most basic form or lemma of each word in the sentence. For some models, the word is categorized as a noun, verb, adverb, adjective, etc. The lemmas are then combined into clauses. This is often referred to as natural language processing. In other embodiments, other machine learning techniques are used to separate pluralities of words into strings of clauses. The clusters of clauses may be stored in a source clause table.

The translation module 317 could be a series of instructions for the at least one processor 302, stored in the memory 310, and organized as an application or a subroutine. The translation module 317 translates the clauses, as stored in the table, from one human language into another. For instance, the translation of the clause could be from English to Hebrew, or back. In some embodiments, the clause clusters from the source string are run through a look-up table that returns the destination string in the second language. In some embodiments, the clause clusters are processed through a rules engine to return the translated clause. Other embodiments use neural networks or other machine learning techniques to convert the clauses into the second language. The translated clauses may be stored in a translation table. The translation module may also create a translated string.

The calculation module 318 could be a series of instructions for the at least one processor 302, stored in the memory 310, and organized as an application or a subroutine. The calculation module 318 defines the correspondence areas of substring pairs. This calculation module 318 could take the source cluster table and the text string and calculate the end of each clause in the text string. The calculation module 318 could also take the translation table and the translated string and calculate the end of each clause in the translated string. The end location of each clause could be stored in the source clause table or in the translation table.

The placement module 320 could be a series of instructions for the at least one processor 302, stored in the memory 310, and organized as an application or a subroutine. The placement module 320 places text strings, substrings, and/or demarcations. The placement module 320 arranges the source clauses and their corresponding translation clauses into a plurality of substring pairs. Each of the plurality of substring pairs includes a source clause and its corresponding translation.

The operations module 322 could be a series of instructions for the at least one processor 302, stored in the memory 310, and organized as an application or a subroutine. The operations module 322 may perform various modifications to text strings, substrings, and/or demarcations. In some embodiments, the operations module determines which clauses are at the end of a paragraph or at the end of a sentence, and modifies the plurality of substrings to reflect the end of the larger grammatical subdivisions. In some embodiments, the operations module 322 could also create lines or other demarcations between the clauses in the substring pairs.

The renderer 324 could be a series of instructions for the at least one processor 302, stored in the memory 310, and organized as an application or a subroutine. The renderer 324 renders text strings, substrings, and/or demarcations for display. In some embodiments, the renderer 324 takes the substring pairs and assembles HTML code around each of the substring pairs to create an image on a display device similar to those examples shown in the Figures. In some embodiments, an HTML template is input with the substring pairs, and the renderer 324 inserts the substrings into the HTML template to create an HTML string. This HTML string may then be sent to the display device. In other embodiments, XML and an XML template may be generated. In still other embodiments, bitmap structures or other screen encoding instructions may be generated.

In some embodiments, the parsing module 316, the translation module 317, the calculation module 318, the placement module 320, the operations module 322, and/or the renderer 324 could be located on another computing device and the parameters for the modules could be sent over a network.

Memory 310 may further include a database 326 loaded with primary text string data 328, secondary text string data 330, demarcation data 332, and user preference data 334. In certain embodiments, the database 326 may be implemented locally, whereas in other embodiments, the database 326 may be implemented remotely.

Primary text string data may include all metadata associated with primary text strings including, but not limited to, primary text string typefaces, fonts, point sizes, dimensions, etc. Secondary text string data may include metadata of secondary text strings including, but not limited to, secondary text string typefaces, fonts, point sizes, dimensions, etc. Demarcation data 332 may include demarcation appearance, design, dimensions, etc. User preference data 334 may include preferred user settings, languages, demarcations, and the like. Accordingly, the database 326 includes all necessary content per each embodiment.

The term computer readable media as used herein may include computer storage media. Computer storage media may include volatile and nonvolatile, removable and non-removable media implemented in any method or technology for storage of information, such as computer readable instructions, data structures, or program modules. The memory 310, the removable storage device 333 and the non-removable storage device 336 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 300. Any such computer storage media may be part of the computing device 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The computing device 300 is operative to employ various font technologies like variable fonts, raster, vector, TrueType, and Microsoft OpenType and the database 326 also includes associated font-resource files.

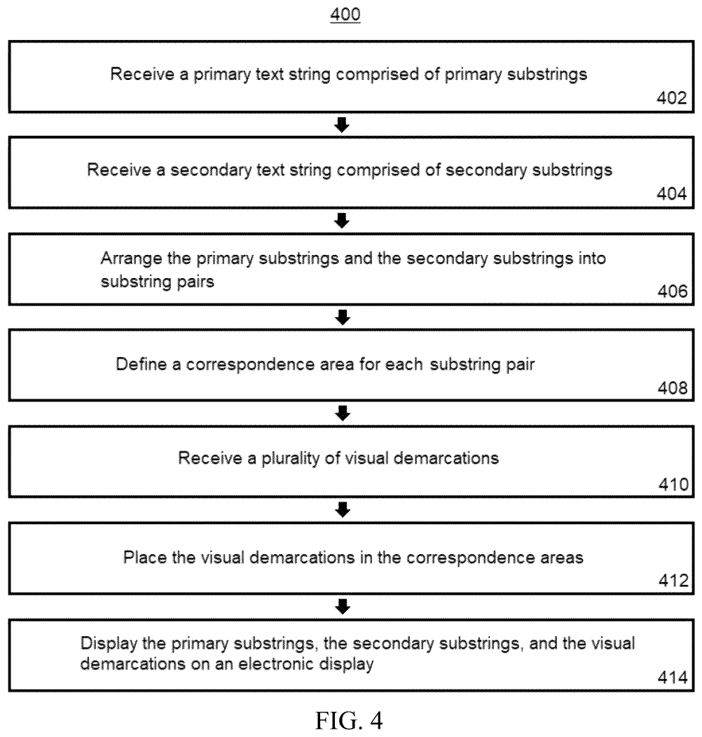

FIG. 4 is a flowchart showing steps of an exemplary method 400 for the simultaneous display of a primary text string comprised of primary substrings and a secondary text string comprised of secondary substrings. Demarcations are used to delineate adjacent substring pairs from each other and to further associate the secondary substrings to their corresponding primary substrings. The method may begin at step 402.

At step 402, a primary text string composed of primary substrings is received.

According to an embodiment, the primary text string is received when a user inputs the primary text string using an input device. The user may manually indicate the substrings that make up the text string. Alternatively, a native language processing engine can identify substrings within a string. For instance, exemplary rules can be based on punctuation, where periods indicate the start of a new text string and commas indicate the start of a new substring within that text string.

According to another embodiment, the primary text string is received when the digital character recognition module (314) scans the content of an electronic display to identify a primary text string. The entirety of the content may be scanned. Alternatively, a user may select a portion of the content to be scanned. Metadata (identity, position, typeface, font, etc.) of each character in the primary text string may be saved to primary text string data. A native language processing engine can identify substrings within a string.

According to yet another embodiment, the primary text string is received when the parsing module (316) parses HTML content and associated CSS files. The entirety of the HTML content and associated CSS files may be parsed. Alternatively, a user may select a portion of the HTML content and associated CSS files to be parsed. The parsing module parses the tags of the HTML content to identify characters in a primary text string as well as associated Cascading Style Sheet (CSS) files to identify associated character metadata. Metadata (identity, position, typeface, font, size, etc) of each character in the primary text string may be saved to primary text string data. A native language processing engine can identify substrings within a string.

At step 404, a secondary text string composed of secondary substrings is received. Each of the secondary substrings may uniquely correspond to one of the primary substrings. For example, each of the secondary substrings may be a translation of its corresponding primary substring. In an aspect, the secondary text string may either be machine-generated directly based on the primary text string or can be generated manually or through manual intervention. As mentioned above, the primary and secondary text strings need not necessarily be translations of each other, but can be associated in any other way, for instance the primary text string can be “One Two Three” and the secondary text string can be “1 2 3”. Alternatively, the primary and secondary text strings can both the graphical symbols/representations or can be any combination of the above.

According to an embodiment, the secondary text string is received when a user inputs the secondary string using an input device. The user may manually indicate the substrings that make up the text string. Alternatively, a native language processing engine can identify substrings within a string. For instance, exemplary rules can be based on punctuation, where periods indicate the start of a new text string and commas indicate the start of a new substring within that text string.

According to another embodiment, the secondary text string is received when the digital character recognition module (314) scans the content of an electronic display to identify a secondary text string. The entirety of the content may be scanned. Alternatively, a user may select a portion of the content to be scanned. Metadata (identity, position, typeface, font, etc.) of each character in the secondary text string may be saved to secondary text string data. A native language processing engine can identify substrings within a string.

According to yet another embodiment, the secondary text string is received when the parsing module (316) parses HTML content and associated CSS files. The entirety of the HTML content and associated CSS files may be parsed. Alternatively, a user may select a portion of the HTML content and associated CSS files to be parsed. The parsing module parses the tags of the HTML content to identify characters in a secondary text string as well as associated Cascading Style Sheet (CSS) files to identify associated character metadata. Metadata (identity, position, typeface, font, size, etc) of each character in the secondary text string may be saved to secondary text string data. A native language processing engine can identify substrings within a string.

At step 406, the primary substrings and the secondary substrings are arranged into substring pairs.

According to an embodiment, the placement module places each of the secondary substrings adjacent to its corresponding primary substring, creating substring pairs.

At step 408, a correspondence area is defined for each substring pair.

According to an embodiment, for each substring pair, the calculation module 318 scans the display screen, pixel by pixel, to determine the location of non-substring pair objects. The largest rectangular area containing the substring pair and not containing non-substring pair objects is defined as the correspondence area for that substring pair. Alternatively, the calculation module 319 defines the correspondence area of a substring pair by processing the metadata of substrings within that substring pair and adjacent objects to determine the topmost pixels of a below object, the bottommost pixels of an above object, leftmost pixels of a right object and the rightmost pixels of a left object and selecting a rectangular area containing pixels of the substring pair and not containing pixels of those objects.

At step 410, a plurality of visual demarcations are received. Each of the visual demarcations may be distinct such that a reader can distinguish adjacent demarcations. The number of demarcations may equal to the number of correspondence areas. Alternatively, there may be more demarcations than correspondence areas. Yet alternatively, there may be fewer demarcations than correspondence areas, with every other correspondence area not containing a demarcation.

According to an embodiment, demarcations are received when they are generated. The first step of generating a demarcation is retrieving a base demarcation from demarcation data. The operations module, in conjunction with the placement module (320), then modifies the base demarcation into a desired demarcation that, when placed in a correspondence area, results in the desired visual effect.

At step 412, the demarcations are placed into the correspondence areas.

According to an embodiment, the placement module places each of the desired demarcations into one of the correspondence areas such that the desired demarcation results in the desired visual effect.

At step 414, the primary substrings, secondary substrings, and visual demarcations are displayed on an electronic display.

It would be appreciated that the usage of the term “In proximity to” can be interpreted to mean close but not touching, touching, or overlapping, and the term “Interacting with” can touching or overlapping. There are no limitations in the claims below that require “interacting with” but such limitations will be in the specification in case we need to amend the claims to include such limitations later.

Alternatively, a native language processing engine can identify substrings within a string. For instance, exemplary rules can be based on, for example, Sentence must start with a Uppercase character (e.g. Noun/I/We/He etc.), then lowercase character follows, there must be spaces between words, the sentence must end with a full stop (.) after a word, two continuous spaces are not allowed, and two continuous upper case characters are not allowed. However, the sentence can end after an upper case character.

In another exemplary aspect, string can be divided into an array of substrings, and a computed implemented function can return a temporary array of the substrings. The function can be used in calculation statements wherever an array can be used, wherein a first operand can be the string to be split which can be alphanumeric, graphic, or UCS-2. The second operand can be the list of characters that indicate the end of each substring, can have same type and CCSID as the first operand. If it is not specified, the function can default to splitting at blanks. If the length of the second operand is greater than 1, any of the characters in the second operand indicate the end of each substring.

Another exemplary implementation to automatically find/form substrings from a string can be based on rules associated with parts of speech including noun, pronoun, verb, adjective, adverb, preposition, conjunction and interjection. Breaking a sentence down into its parts of speech requires knowledge of the word's meaning and how it relates to other words in the sentence. In an implementation, the substring formation can be based on identification of verbs, followed by identification of adverbs, followed by nouns, pronouns, and adjectives, followed by propositions and conjunctions and interjections, and then logically groping them together in parts based on defined set of rules.

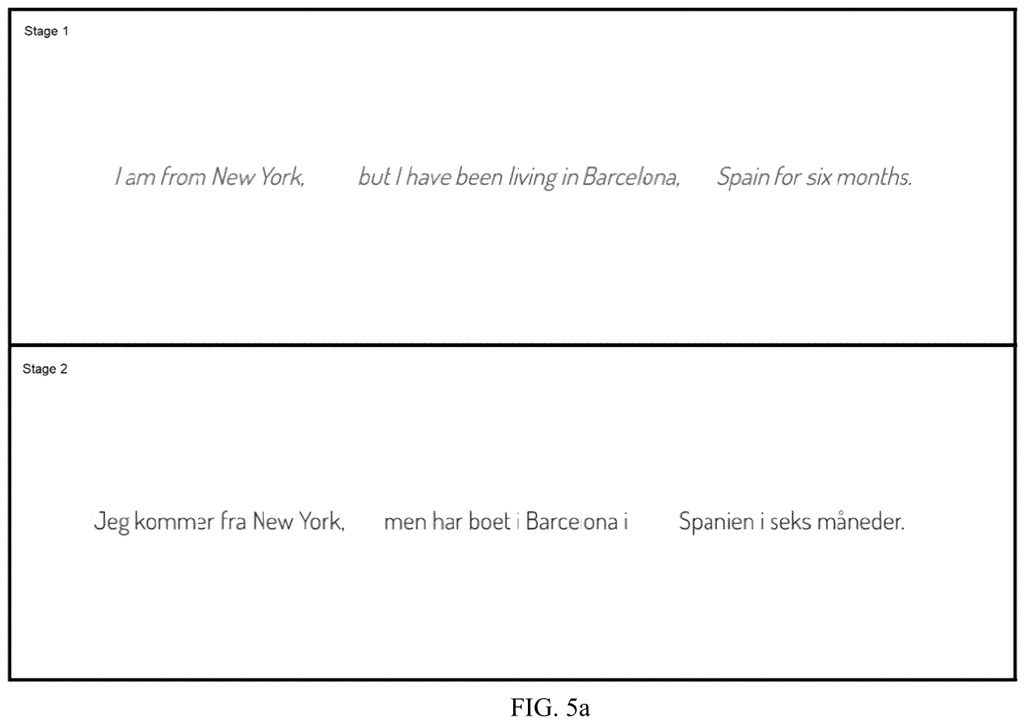

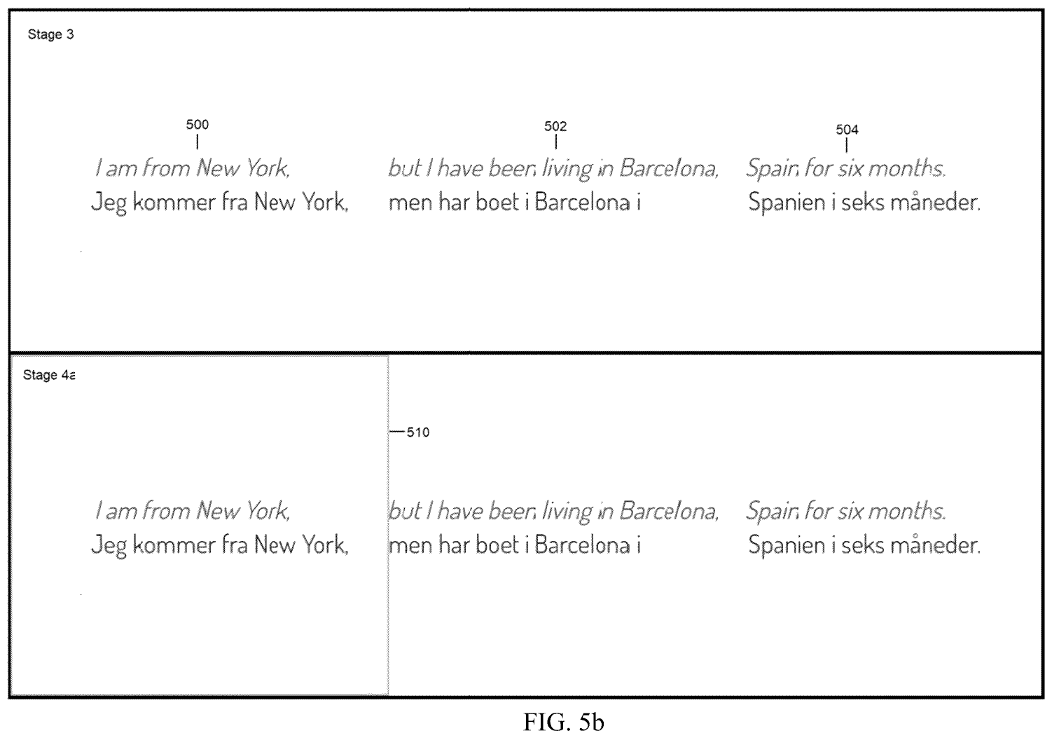

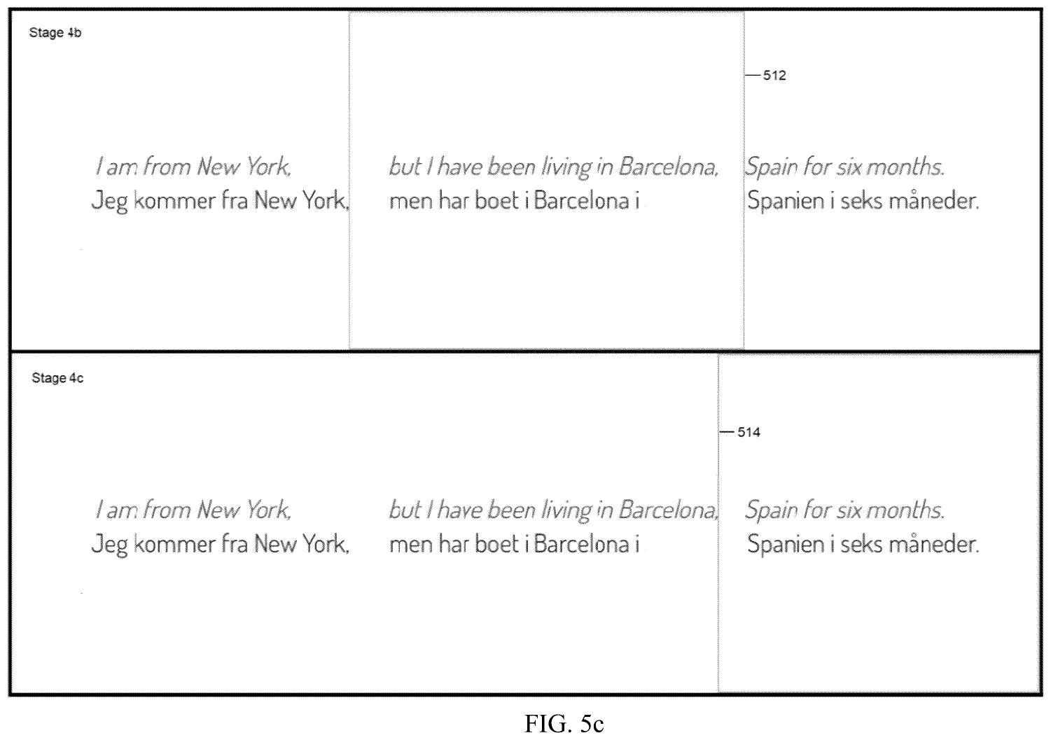

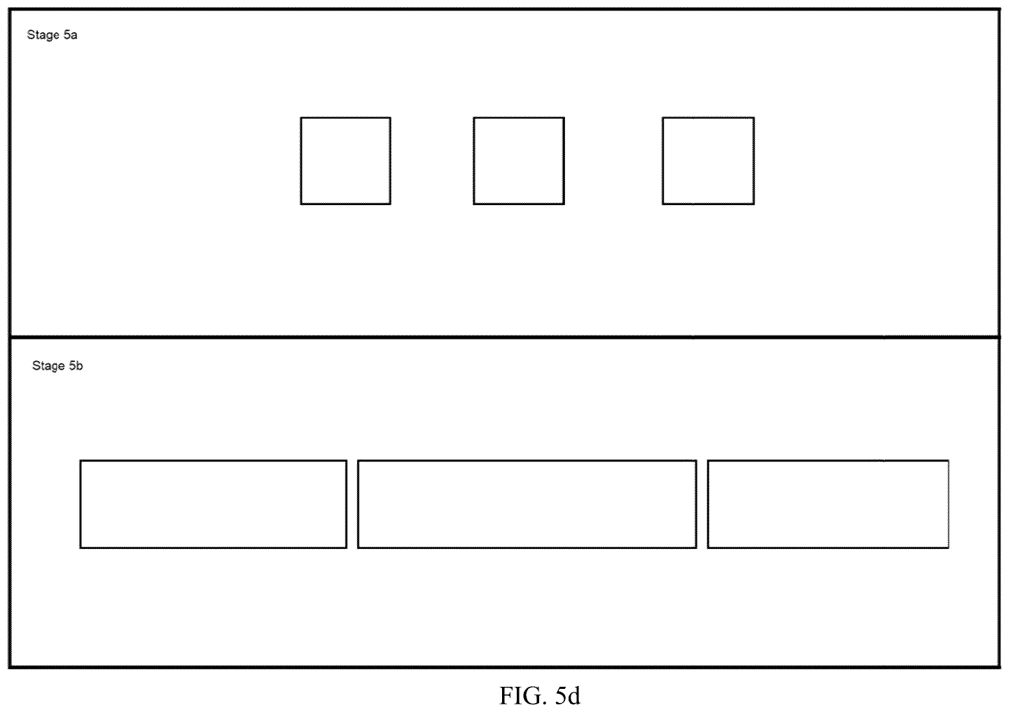

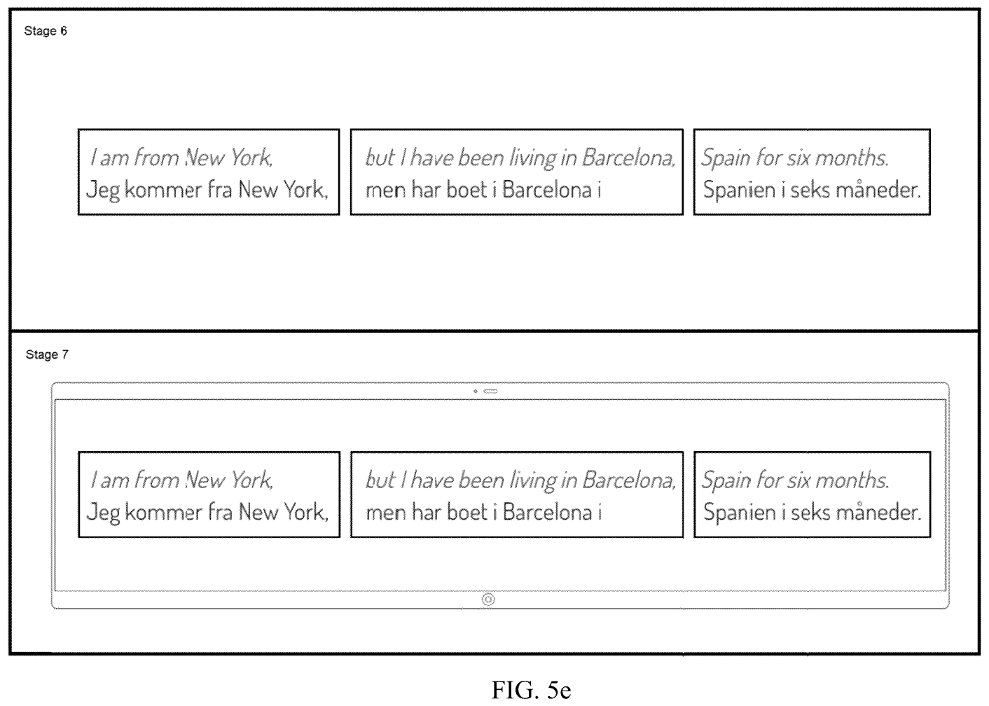

FIGS. 5a-5e show the steps of the method of FIG. 4 as applied to a computing device, according to an embodiment.

In Stage 1, Danish primary substrings of “Jeg kommer fra New York,” “men har boet i Barcelona i” and “Spanien i seks måneder” are received from user keyboard inputs.

In Stage 2, English secondary substrings of “I am from New York,” “but I have been living in Barcelona,” and “Spain for six months” are generated by the translation module as direct translations of the Danish primary substrings.

In Stage 3, the English secondary substrings are placed above their corresponding Danish primary substrings to form substring pairs 500 502 504.

In Stages 4a-4c, the correspondence areas are defined for each substring pair. The edges of each correspondence area are highlighted with reference boxes 510 512 514.

In Stages 5a-5b, the demarcations are generated. Boxes are chosen as a base demarcation. The hollow boxes are then scaled into a desired shape.

In Stage 6, the Box demarcations are placed in their respective correspondence areas. Here, the box demarcations surround the substring pairs.

In stage 7, the Danish primary substrings, the English secondary substrings, and the box demarcations are displayed on an electronic display. Here, the boxes function to delineate adjacent substring pairs from each other.

The system embodies a significant advance over existing systems that cannot display two text strings in a manner that delineates adjacent substring pairs. Additional desired visual effects may be achieved through the use of specific demarcations, demarcation placements, and substring modifications, as described below.

As an alternative to generating the demarcations, individual characters in the received primary and secondary substrings may each contain a portion of a demarcation such that, when substring pairs are formed out of the primary and secondary substrings, complete demarcations are formed from individual demarcation portions. For example, if a user indicates the use of box demarcations before the primary and secondary substrings are received, individual characters in the received primary and secondary substrings may appear underlined, with leftmost and rightmost individual characters having vertical portions. This will result in a box demarcations being formed as the substring pairs are formed out of the primary and secondary substrings.

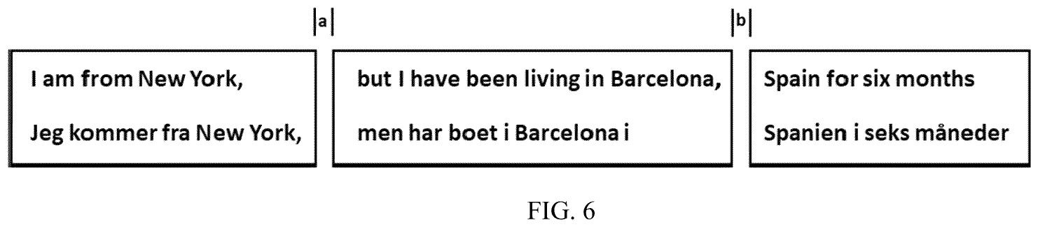

FIG. 6 shows demarcated substring pairs, according to an embodiment. Danish primary substrings and English secondary substrings are surrounded by box demarcations. The box demarcations are equidistant from each other such that ‘a’ is equal to ‘b’ where ‘a’ and ‘b’ are non-zero distances. At a glance, such visual demarcation spacing provides a rigid frame to otherwise randomly spaced substrings.

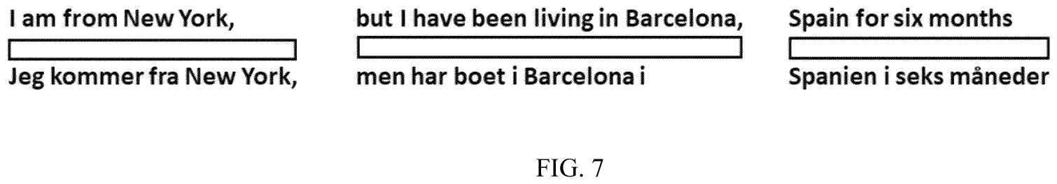

FIG. 7 shows demarcated substring pairs, according to an embodiment. Danish primary substrings and English secondary substrings are separated by rectangular demarcations. The leftmost point of a given visual demarcation is flush with the leftmost point of a substring pair and the rightmost point of a given visual demarcation is flush with the rightmost point of a substring pair. At a glance, such visual demarcation widths associate all substrings in horizontal alignment with a visual demarcation.

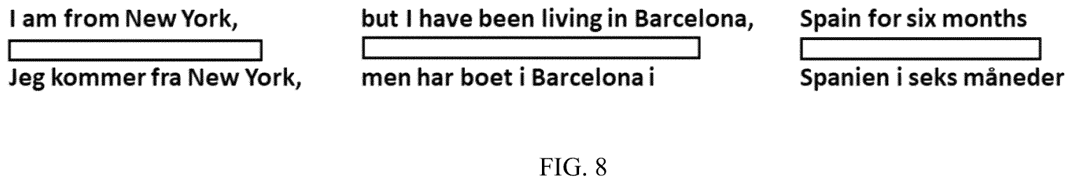

FIG. 8 shows demarcated substring pairs, according to an embodiment. Danish primary substrings and English secondary substrings are separated by rectangular demarcations. The leftmost point of a given visual demarcation is flush with or in between the leftmost point of a primary substring and the leftmost point of a corresponding secondary substring. The rightmost point of a given visual demarcation is flush with or in between the rightmost point of a primary substring and the rightmost point of a corresponding secondary substring. At a glance, such visual demarcation widths associate all substrings that are fully or partially horizontally aligned with a visual demarcation.

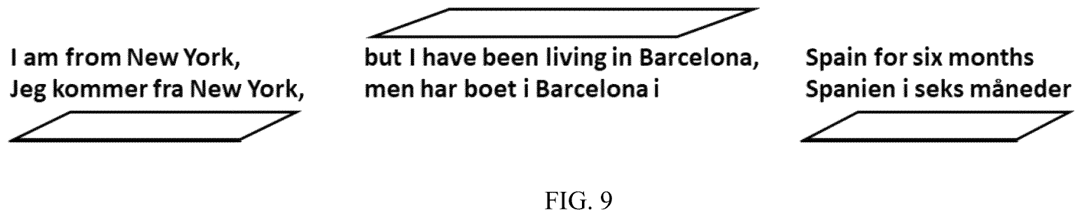

FIG. 9 shows demarcated substring pairs, according to an embodiment. Danish primary substrings and English secondary substrings are demarcated by parallelogram demarcations. The visual demarcations are entirely above or entirely below pairs of substrings. At a glance, such visual demarcation placements associate all substrings that are partially walled in by the visual demarcations.

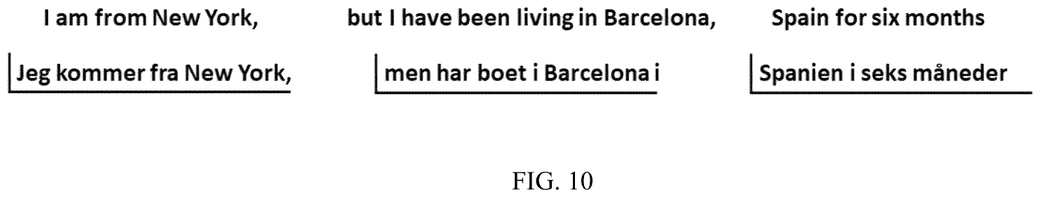

FIG. 10 shows demarcated substring pairs, according to an embodiment. Danish primary substrings and English secondary substrings are demarcated by perpendicular-line demarcations. The visual demarcations are consistently placed relative to the primary substrings. Alternatively, the visual demarcations may be consistently placed relative to the secondary substrings. At a glance, such visual demarcation placements provide a repeating consistency to otherwise inconsistent substrings.

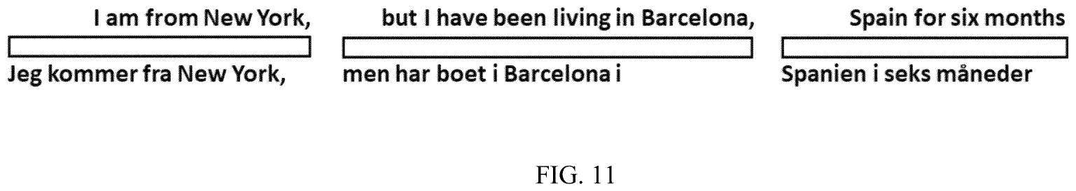

FIG. 11 shows demarcated substring pairs, according to an embodiment. Danish primary substrings and English secondary substrings are separated by rectangular demarcations where each English secondary substring is offset from its corresponding Danish primary substring. The rightmost point of each secondary substring is to the right of the rightmost point of its corresponding primary substring. Alternatively, the leftmost point of each secondary substring may be to the left of the leftmost point of its corresponding primary substring. Offsetting secondary substrings from their corresponding primary substrings, in the reading direction of the primary substrings, provides substring arrangements where the primary substrings are introduced before their corresponding secondary substrings. At a glance, such substring placements reduce visual and mental fatigue for a reader focusing on the primary text.

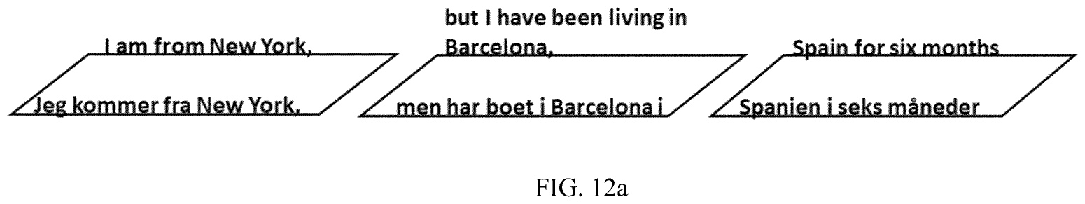

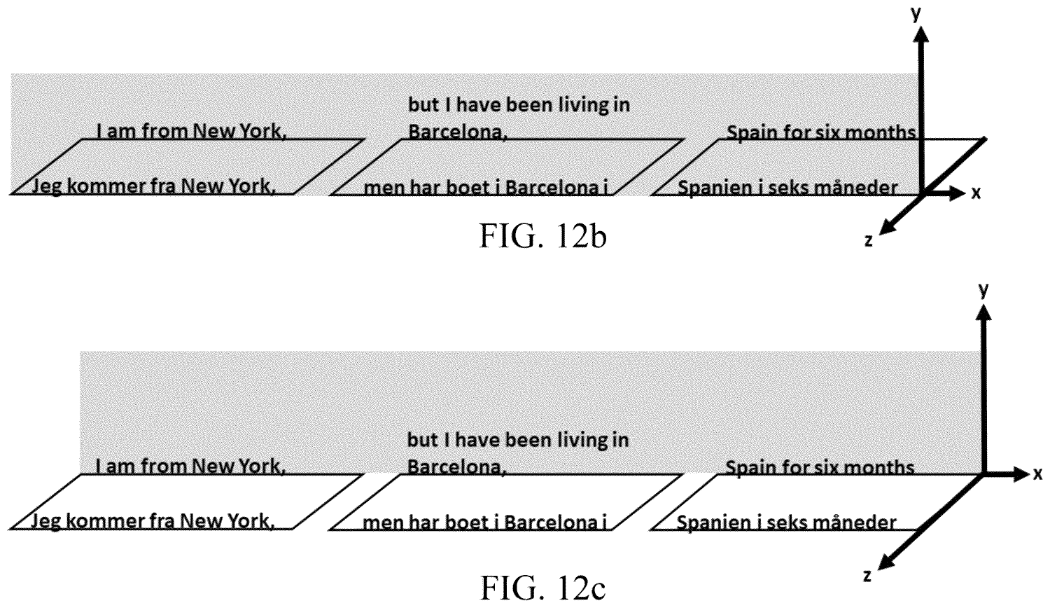

FIG. 12a shows demarcated substring pairs, according to an embodiment. Danish primary substrings and English secondary substrings border parallelogram demarcations. The demarcations comprise shapes that cause the secondary substrings to appear on a separate perspective plane relative to their corresponding primary substrings. Such shapes may include, but are not limited to, shapes with at least one sloped edge such as a parallelogram or trapezoid.

As shown in FIG. 12b, the primary substrings are caused to appear on a forward perspective plane due to bordering a bottom edge of the parallelogram demarcations, and, as shown in FIG. 12c, the secondary substrings are caused to appear on a recessed perspective plane due to bordering a top edge of the parallelogram demarcations. At a glance, causing the secondary substrings to appear on a recessed perspective plane deemphasizes the secondary substrings relative to the primary substrings, reducing visual and mental fatigue for readers focusing on the primary substrings.

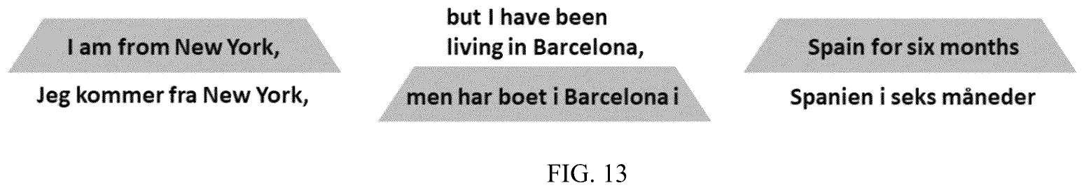

FIG. 13 shows demarcated substring pairs, according to an embodiment. Danish primary substrings and English secondary substrings overlap trapezoid demarcations. For each substring pair, the visual demarcations border or overlap only one of the substrings. At a glance, such visual demarcation placements delineate paired substrings from each other. Any other such mechanism/means to create substring pairs and visually demarcate them through any representation including, but not limited to a boundary, a shape, or a color based demarcation is well within the scope of the present disclosure.

In another exemplary implementation, system of the present disclosure can allow configuration/definition/modification of any rule based on which the demarcation would take place. For instance, apart from logical phrase-based demarcation, noun/verb/adjective based (i.e. the substring would be formed based on whenever a noun is identified, for instance), or specific character based demarcation can also be defined and undertaken, so as to allow a user to define how he/she would like to see the demarcated sections of pair of substrings. All such variations based on required use cases in different application areas are therefore well within the scope of the present invention.

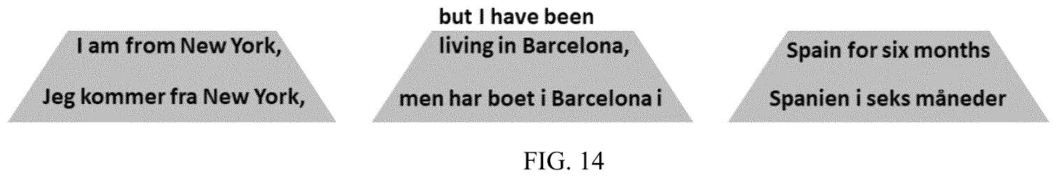

FIG. 14 shows demarcated substring pairs, according to an embodiment. Danish primary substrings and English secondary substrings overlap trapezoid demarcations. The visual demarcations border or overlap both substrings in each substring pair. At a glance, such visual demarcation placements associate paired substrings to each other.

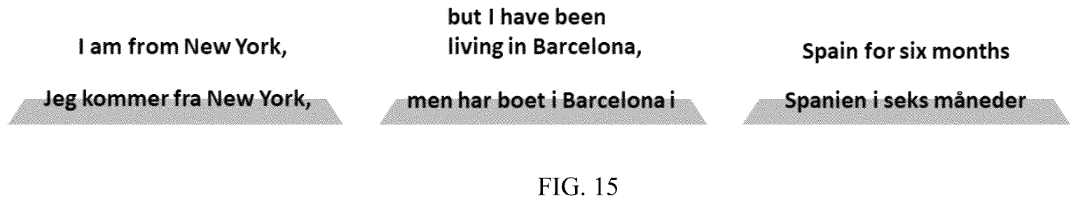

FIG. 15 shows demarcated substring pairs, according to an embodiment. English secondary substrings are placed above Danish primary substrings that overlap trapezoid demarcations. The topmost point of each visual demarcation overlaps a lower substring in a substring pair. At a glance, such visual demarcation placement causes the visual demarcations to act as a platform, drawing a reader's attention to the platformed substrings.

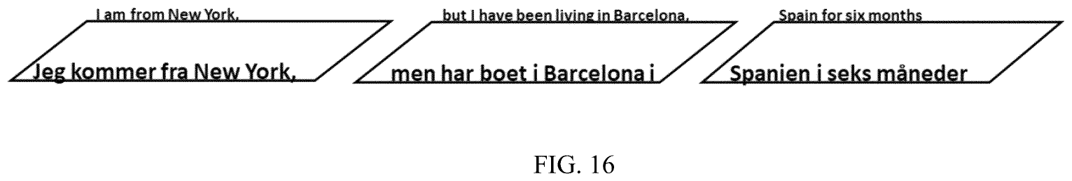

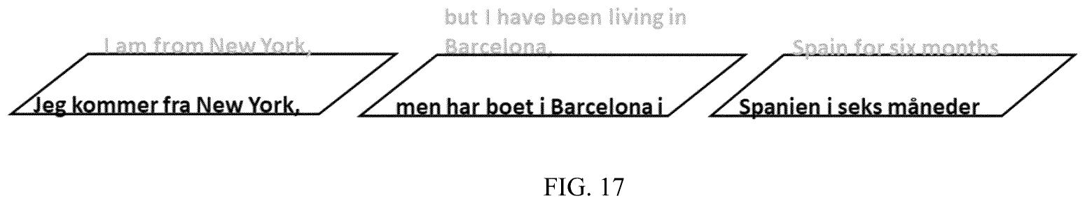

FIG. 16 shows demarcated substring pairs, according to an embodiment. Danish primary substrings and English secondary substrings border parallelogram demarcations where the font size of each English secondary substring is smaller than the font size of its corresponding Danish primary substring. At a glance, using smaller font sizes for the secondary substrings deemphasizes the secondary substrings relative to the primary substrings, reducing visual and mental fatigue for readers focusing on the primary substrings.

FIG. 17 shows demarcated substring pairs, according to an embodiment. Danish primary substrings and English secondary substrings border parallelogram demarcations where each English secondary substring has a lighter shade than its corresponding Danish primary substring. At a glance, using lighter shades for the secondary substrings deemphasizes the secondary substrings relative to the primary substrings, reducing visual and mental fatigue for readers focusing on the primary substrings.

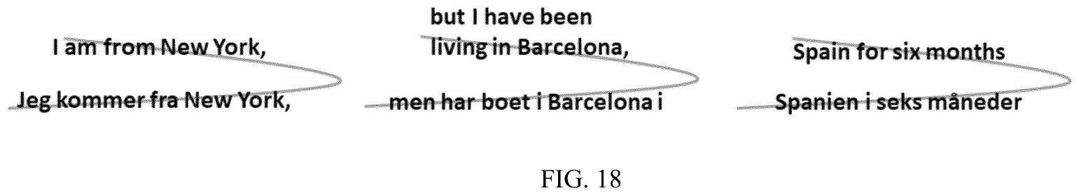

FIG. 18 shows demarcated substring pairs, according to an embodiment. Danish primary substrings and English secondary substrings overlap non-elliptical line demarcations. One arm of each non-elliptical line demarcation overlaps a primary substring and a second arm of each non-elliptical line demarcation overlaps a secondary substring. At a glance, such visual demarcations simultaneously delineate and associate substrings within substring pairs.

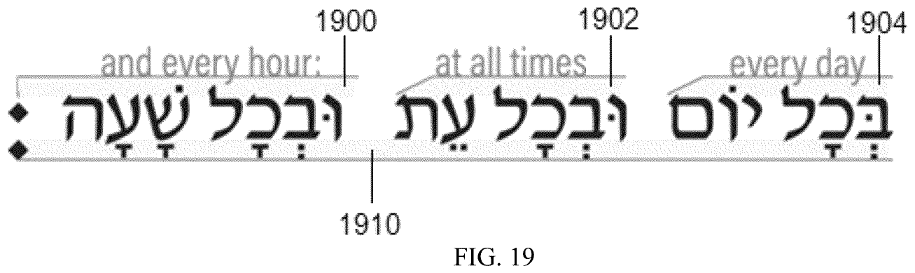

FIG. 19 shows demarcated substring pairs, according to an embodiment. Hebrew primary substrings and English secondary substrings overlap quadrilateral demarcations 1900 1902 1904. Furthermore, a rectangular demarcation 1910 overlaps each of the primary substrings. Alternatively, a visual demarcation may overlap each of the secondary substrings. At a glance, by overlapping multiple primary substrings, such visual demarcations associate adjacent primary substrings to each other. Such visual demarcations may also indicate a superstructure of multiple string pairs such as phrases or sentences.

FIG. 20 shows demarcated substring pairs, according to an embodiment. Hebrew primary substrings and English secondary substrings overlap shadow-outlined edges of an implied transparent oblique parallelogram.

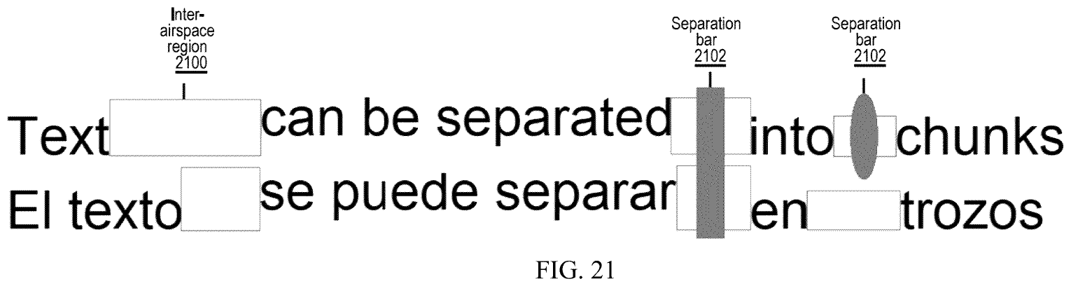

In an aspect, as illustrated in FIG. 21, visual demarcation can be configured through an inter-airspace region 2100 that can be configured as a rectangular space in between adjacent text segments. The left edge of each inter-airspace region can be immediately to the right of the rightmost point of the text segment to its left, the right edge of each inter-airspace region is immediately to the left of the leftmost point of the text segment to its right, the top edge of each inter-airspace region is flush with the higher of one of the top edge of the text segment to its left and the top edge of the text segment to its right, and the bottom edge of each inter-airspace region is flush with the lower of one of the bottom edge of the text segment to its left and the bottom edge of the text segment to its right. As illustrated in FIG. 21, one of the inter-airspace regions is located in between the text segment “Text,” and the text segment “can be separated.” The left edge of the inter-airspace region can be immediately to the right of the rightmost point of the “t” in “Text,” the right edge of the inter-airspace region 2100 is immediately to the left of the leftmost point of the “c” in “can,” the top edge of the inter-airspace region 2100 is flush with the topmost points of the “b,” “t,” and “d,” in “can be separated,” and the bottom edge of the inter-airspace region 2100 is flush with the bottommost points of the “T,” “e,” “x,” and “t,” in “Text.” Inter-airspace regions can be left empty or filled with separation bars to achieve different purposes, depending on user preference. FIG. 21 further discloses a separation bar 2102 that can be configured as a shaped marker placed in the inter-airspace region of adjacent text segments that can function to distinguish adjacent text segments from each other, where the shaped marker is, for example, but not limited to, a rectangle, line, square, oval, and the like. As illustrated in FIG. 21, one separation bar 2102 is rectangular and enters two inter-airspace regions, and the other separation bar 2102 is oval and enters a single inter-airspace region.

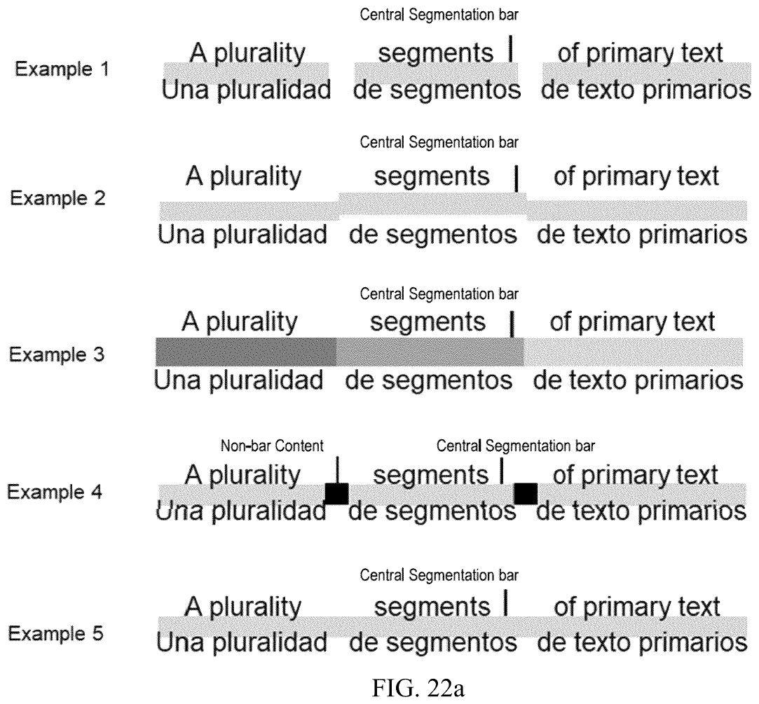

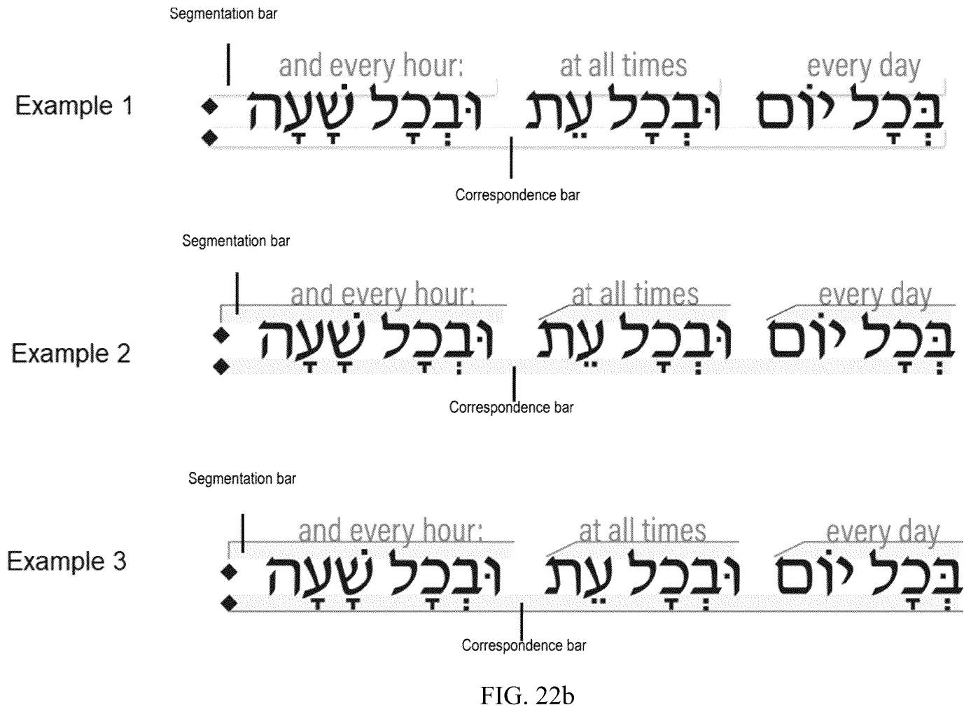

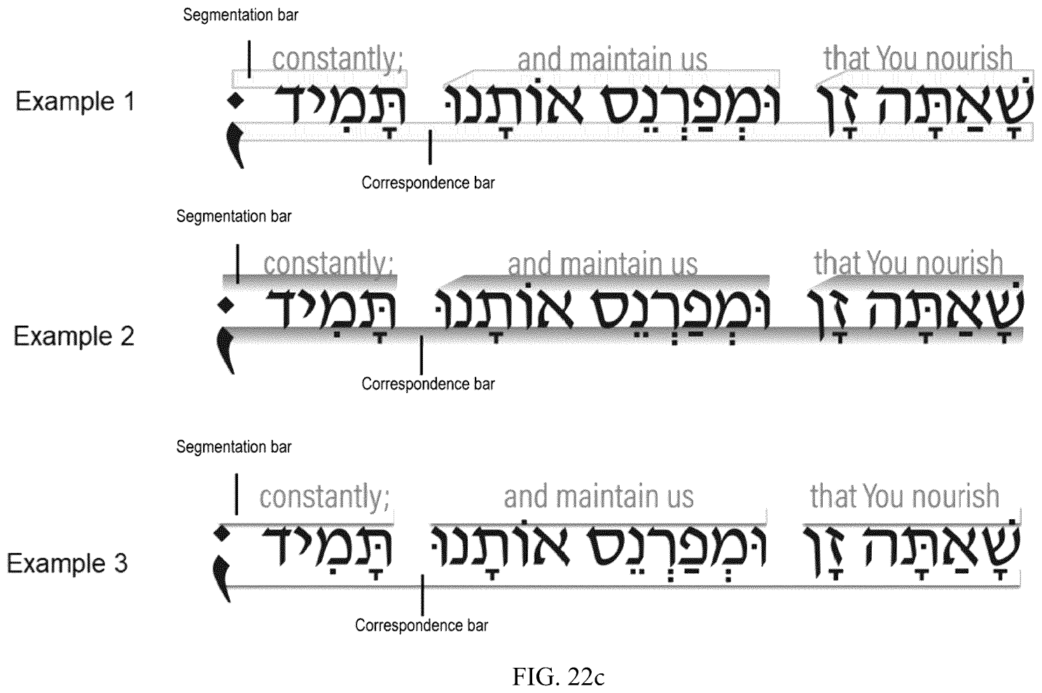

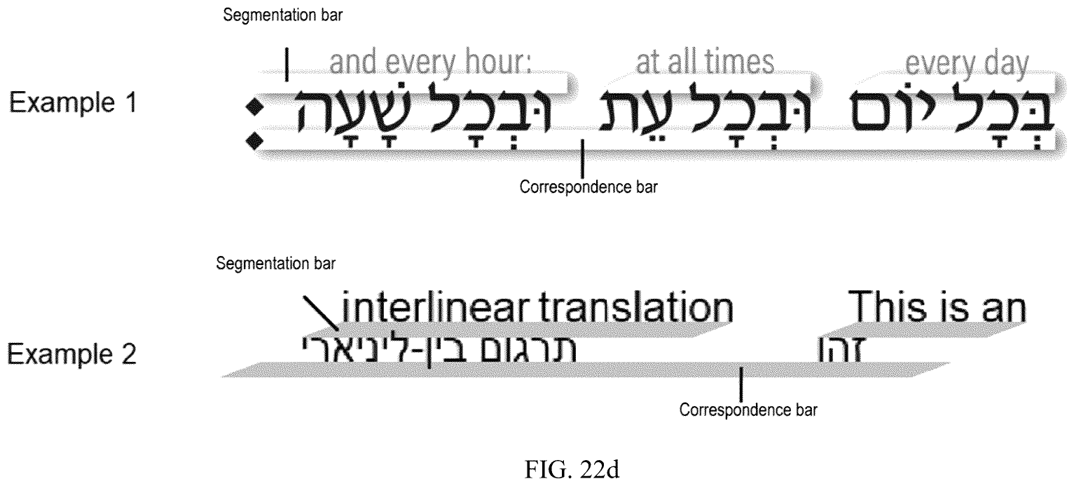

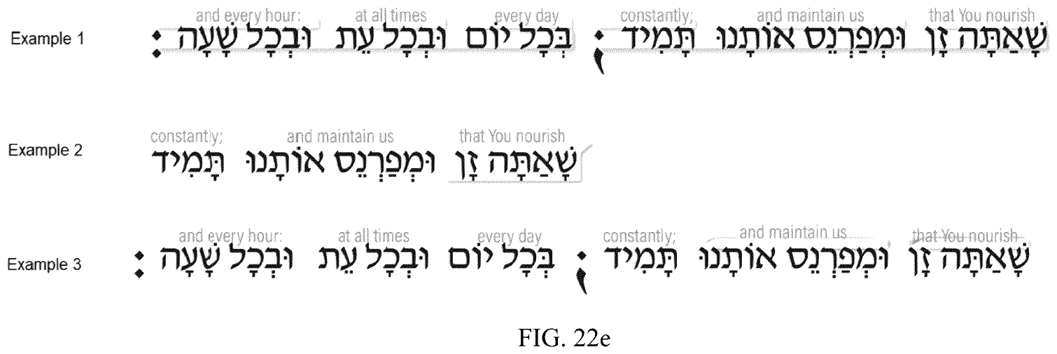

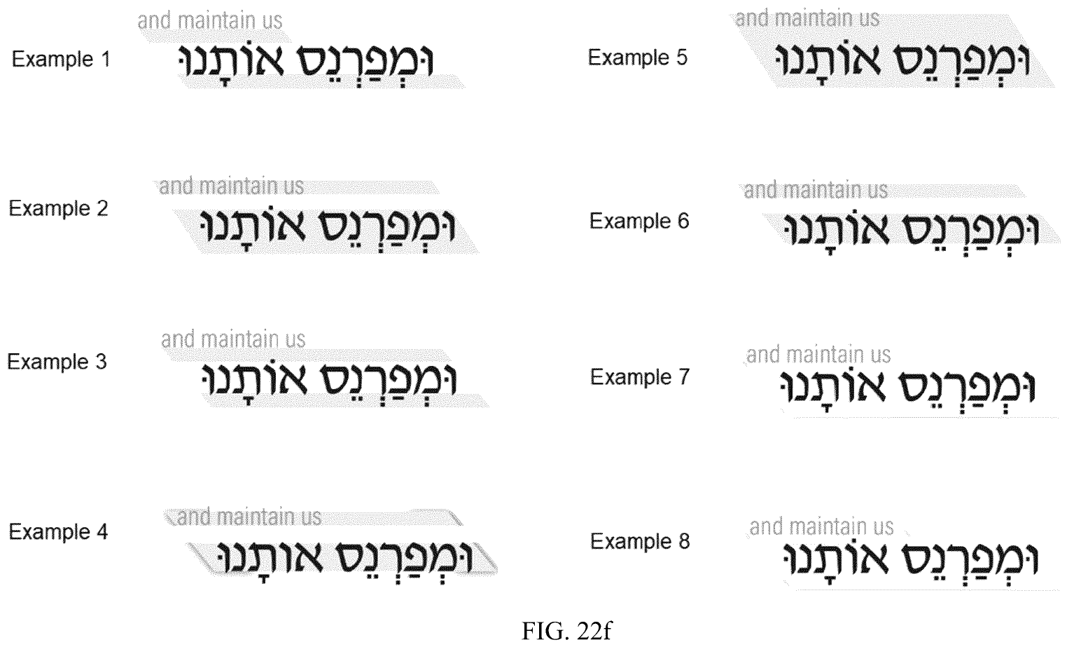

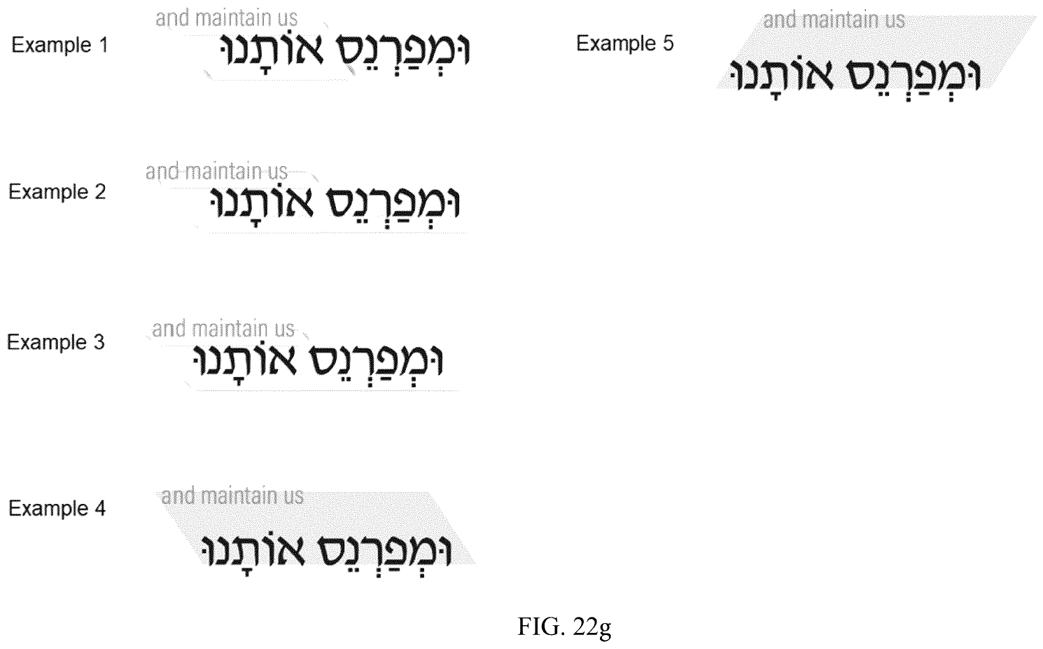

FIGS. 22a-22g illustrate further non-limiting examples of demarcations, all of which are well within the scope of the present disclosure/invention and are also well encompassed within the definition of demarcations.

In an aspect, as illustrated, visual demarcation can be created based on one or more segmentation bars to the left of the segmentation bar or another segmentation bar to the right of the segmentation bar, the segmentation bar may be colored, patterned, placed, or otherwise modified such that it is distinct from the other adjacent segmentation bars. For example, as illustrated in the instant figures, a central segmentation bar is distinct because there is empty space in between the bars, creating a clear distinction between the ends of the central segmentation bar and the ends of adjacent segmentation bars. As illustrated in other examples, the central segmentation bar may be distinct because the bottom and top edges of central segmentation bar are at different levels from the bottom and top edges of adjacent segmentation bars, creating a clear distinction between the ends of the central segmentation bar and the ends of adjacent segmentation bars. The central segmentation bar may further be distinct from adjacent segmentation bars because the bars have different colors, creating a clear distinction between the ends of the central segmentation bar and the ends of adjacent segmentation bars. As illustrated, the central segmentation bar can be distinct because there is non-bar content in between the segmentation bars, creating a clear distinction between the ends of the central segmentation bar and the ends of adjacent segmentation bars. As illustrated in other examples, the central segmentation bar is not distinct from adjacent segmentation bars because there is no clear distinction between the ends of the central segmentation bar and the ends of adjacent segmentation bars.

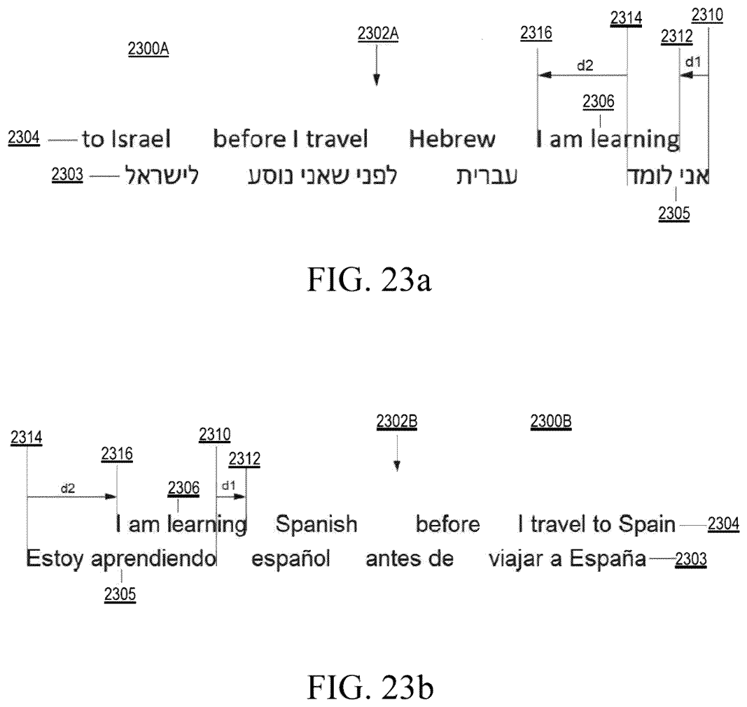

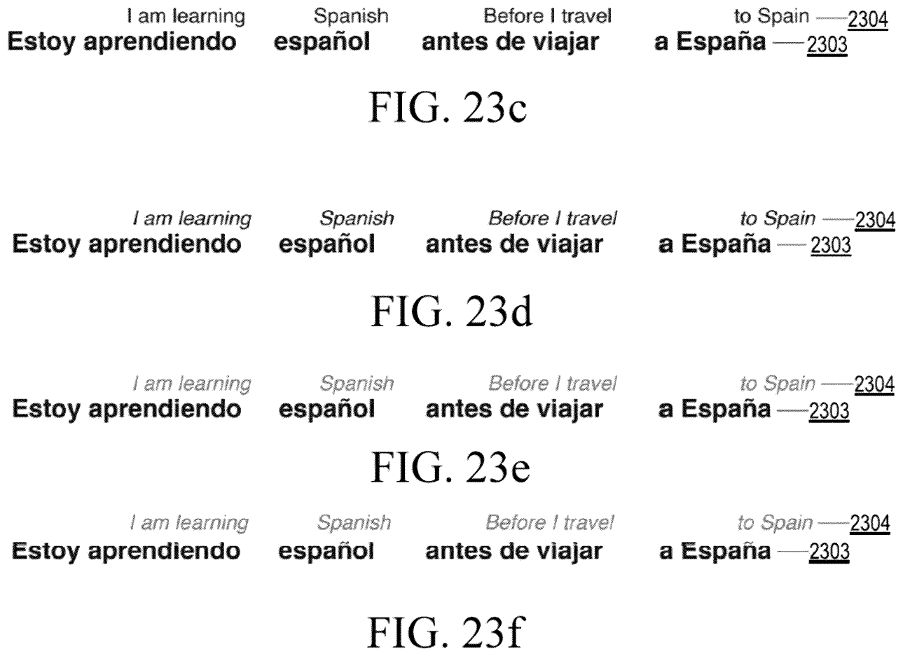

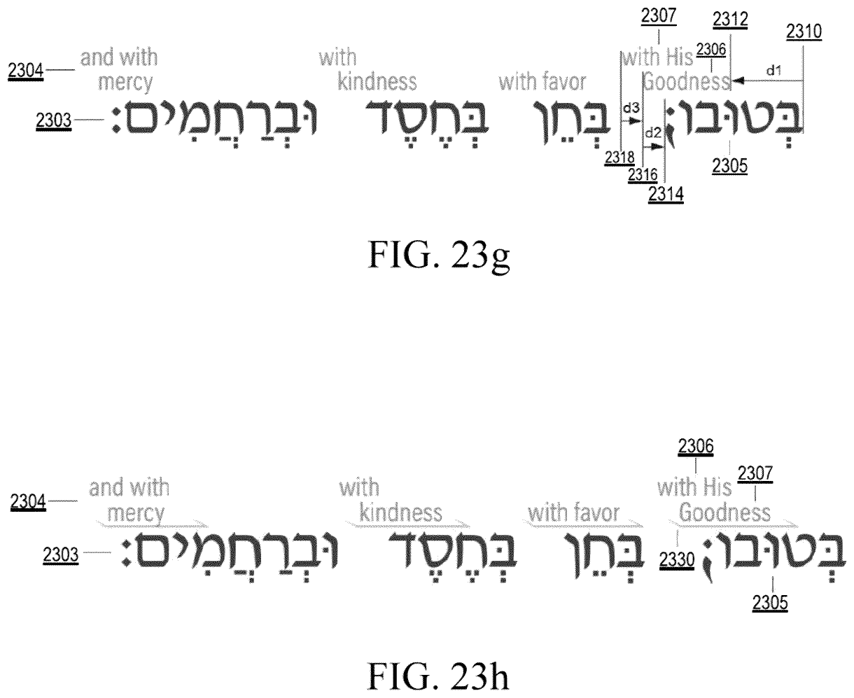

FIGS. 23a-23b show a series of exemplary display schemes/formats 2300A-2300B of a primary text string 2303 and a secondary text string 2304 where secondary text segments are offset from their corresponding primary text segments, according to an embodiment. Such offset therefore is indicative of a visual demarcation that enables pair of substrings to be visually demarcated from each other through different and respective correspondence areas.

FIG. 23a shows a comparative-text display format (CTDF) 2300A that can employ a related text layout 2302A. The text layout 2302A for the CTDF 2300A can include arranging the primary and secondary text segments such that 1) secondary text segments 2306 are one of above and below their corresponding primary text segments 2305 and 2) secondary text segments 2306 are offset relative to their corresponding primary text segment 2305 such that rightmost point 412 of each secondary text segment is to the left of the rightmost point 2310 of each corresponding primary text segment by at least distance d1 and the leftmost point 2316 of each secondary text segment is to the left of the leftmost point 2314 of each corresponding primary text segments by at least distance d2, where d1 and d2 may be any distance greater than zero. Alternatively, d1 may be any distance greater than zero and d2 may be a width of at least a syllable of the secondary text segment 2306.

This CTDF 2300A can be used where the primary text has a right-to left directionality like with Hebrew. In contrast to the prior art, if one attempted to study the Hebrew of FIG. 23a by reading from right to left, he or she would encounter a Hebrew text segment 2305 before the English text segment 2306. Such text arrangements introduce texts one at a time, and in an order which allows a student to read a foreign text segment before deciding whether or not to reference the corresponding native language text segment for a better understanding.

FIG. 23b shows a comparative-text display format (CTDF) 2300B that can employ a related text layout 2302B. The text layout 2302B for the CTDF 2300B can include arranging the primary and secondary text segments such that 1) secondary text segments 2306 are one of above and below their corresponding primary text segments 2305 and 2) secondary text segments 2306 are offset relative to their corresponding primary text segment 2305 such that rightmost point 2312 of each secondary text segment is to the right of the rightmost point 2310 of each corresponding primary text segment by at least distance d1 and the leftmost point 2316 of each secondary text segment is to the right of the leftmost point 2314 of each corresponding primary text segments by at least distance d2, where d1 and d2 are greater than zero. Alternatively, d1 may be greater than zero and d2 may be a width of at least a syllable of the secondary text segment 2306.

This CTDF 2300B can be used where the primary text has a left-to-right directionality like with English. The benefits of CTDF 2300B are similar to those of CTDF 2300A. It should be appreciated that the primary text segments in the primary text string 2303 may be further distinguished from the secondary text segments in the secondary text string 2304 by modifying the text strings. For example, by creating a size discrepancy between the primary and secondary text strings (e.g., the text of primary text string 2303 is larger than the text of secondary text string 404 in FIG. 23c), by modifying the fonts of the primary and/or secondary text strings (e.g., the text of the primary text string 2303 is bolded in FIG. 23c and the text of the secondary text string 404 is italicized in FIG. 23d), by modifying the color and/or pattern of the primary and/or secondary text strings (e.g., the color of the text of the secondary text string 2304 is grey in FIG. 23c), or by increasing the spacing in between the primary and secondary text strings (e.g., the secondary text string 404 is further away from the primary text string 2303 in FIG. 23f than it is in FIG. 23c).

FIGS. 23g-23h show a series of display schemes/formats of a primary text string 2303 and a secondary text string 2304 where secondary text segments are offset from each other and their corresponding primary text segments, according to an embodiment.

FIG. 23g shows a comparative-text display format (CTDF) that can employ a related text layout. The text layout for the CTDF can include arranging the primary and secondary text segments such that 1) secondary text segments 2306 are one of above and below each other and their corresponding primary text segments 2305, 2) secondary text segments 2306 that are immediately adjacent to their primary text segments 2305 (e.g., no other secondary text segments in between the secondary text segment and the primary text segment) are offset relative to their corresponding primary text segment 2305 such that rightmost point 2312 of each secondary text segment is to the left of the rightmost point 2310 of each corresponding primary text segment by at least distance d1, the leftmost point 2316 of each secondary text segment is to the left of the leftmost point 2314 of each corresponding primary text segments by at least distance d2, where d1 and d2 may be any distance greater than zero, and 3) secondary text segments 2307 that are immediately adjacent to other secondary text segments 2307 (e.g., not adjacent to a primary text segment 2305) are offset relative to the other secondary text segments 2306 such that the leftmost point 2318 of each secondary text segment 2307 is to the left of the leftmost point 2314 of each other secondary text segment 2306 by at least distance d3. Alternatively, d1 may be any distance greater than zero and d2 may be a width of at least a syllable of the secondary text segment 2306. Alternatively, d3 may be a width of at least a syllable of the secondary text segment 2307. Alternatively, the direction of the offsets must match the directionality of the associated text strings as will be later discussed.

This CTDF can be used where the width of the secondary text string 2304 far exceeds the width of the primary text string 2303, requiring several secondary text segments 2306 2307 to be presented for each primary text segment 2305. In contrast to the prior art, if one attempted to study the Hebrew of FIG. 23a by reading from right to left, he or she would encounter a Hebrew text segment 2305 before the English text segment 2306. Such text arrangements introduce texts one at a time, and in an order which allows a student to read a foreign text segment before deciding whether or not to reference the corresponding native language text segment for a better understanding.

FIG. 23h shows a comparative-text display format (CTDF) that can employ a related text layout. The text layout 2302H for the CTDF 2300H is similar to the text layout 2302G for the CTDF 2300G but further includes shading or shadows 2330 to further distinguish a primary text segment 2305 from secondary text segments 2306 2307.

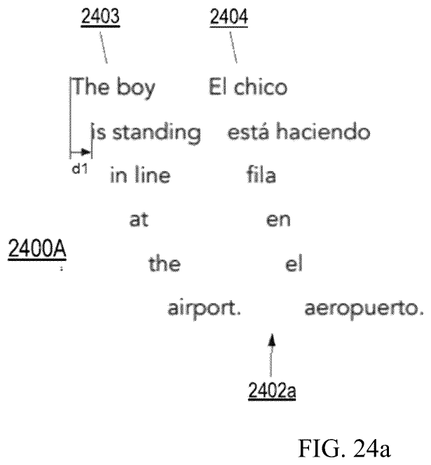

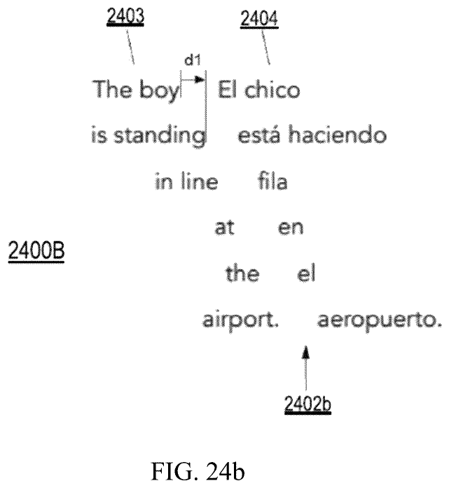

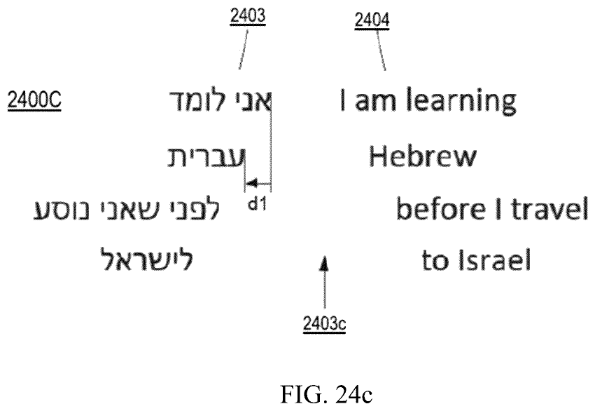

FIGS. 24a-24c show a series of display schemes/formats 2400A-2400C of a primary text string 2403 and a secondary text string 2404 where primary text segments and secondary text segments are presented side-by-side parallel to one another, using an offset progression between adjacent lines, according to an embodiment.

FIG. 24a shows a comparative-text display format (CTDF) 2400A that can employ a related text layout 2402A. The text layout 2402A for the CTDF 2400A can include arranging the primary and secondary text segments such that 1) the primary text segments are arranged in a column and the secondary text segments are placed one of right and left of their corresponding primary text segments and 2) each text segment is offset from its immediately previous text segment by a distance d1, where d1 may be greater than zero. Alternatively, d1 may be a width of at least a syllable of a text segment. Offsetting the respective front ends of each text segment may cause the primary text string 2403 and the secondary text string 2404 to be front aligned such as in FIG. 24a. Alternatively, offsetting the respective back ends of the primary text segments and the respective front ends of the secondary text segments may cause the primary text string 2403 and the secondary text string 2404 to be internally aligned such as in FIG. 24b.

The CTDF 2400A and the CTDF 2400B can be used where the primary and secondary texts have a left to right directionality like with English and Spanish. Such text arrangements introduce text segments one at a time in a manner which reduces visual and mental fatigue.

FIG. 24c shows a comparative-text display format (CTDF) 2400C that can employ a related text layout 2403C. The text layout 2402B for the CTDF 2400B is similar to the text layout 2402A for the CTDF 2400A, but further requires the direction of any offset to match the directionality of the associated text string. Here, Hebrew has a right to left directionality so the Hebrew text segments are offset to the left of immediately previous Hebrew text segments while English has a left to right directionality to the English text segments are offset to the right of immediately previous English text segments.

This CTDF 2400C can be used for primary and secondary texts of any directionality. The benefits of CTDF 2400C are similar to those of CTDF 2400A and CTDF 2400B, but further include an indication of the directionality of a text string based on the offset direction from one text segment to the next.

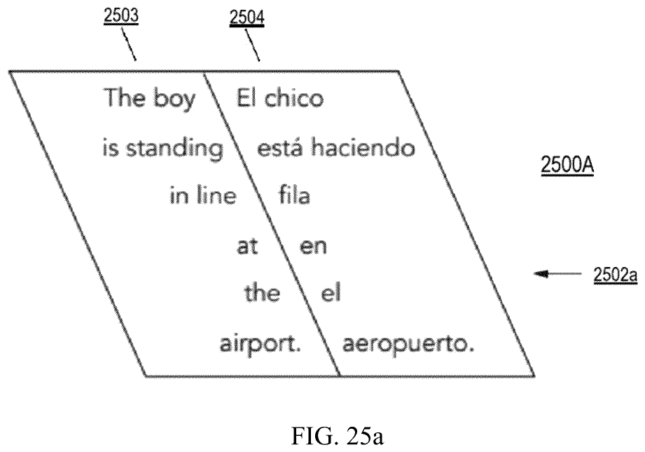

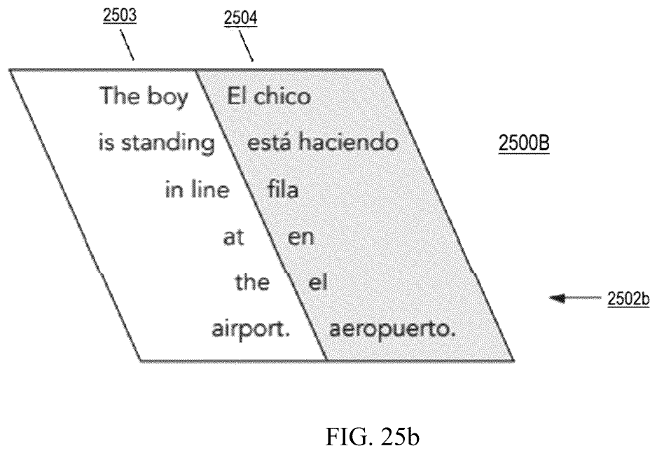

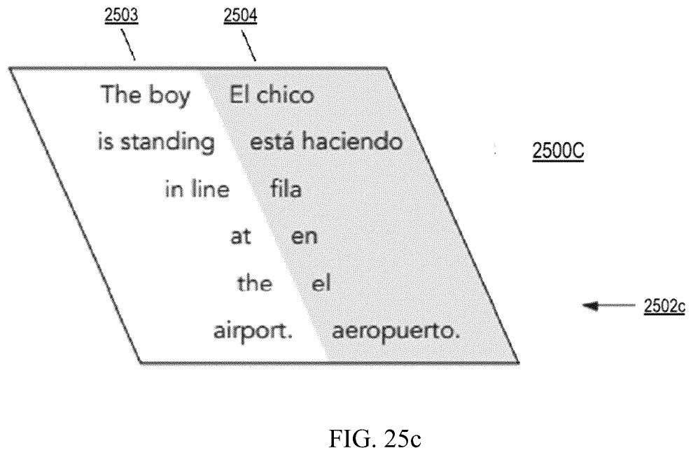

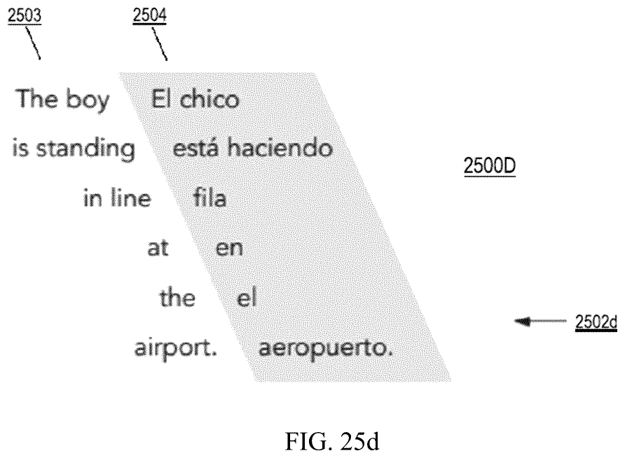

FIGS. 25a-25d show a series of display schemes/formats 2500A-2500D of a primary text string 2503 and a secondary text string 2504 where primary text segments and secondary text segments are presented side-by-side parallel to one another, using an offset progression between adjacent lines, further aligned using a parallelogram format, according to an embodiment.

FIG. 25a shows a comparative-text display format (CTDF) 2500A that can employ a related text layout 2502A. The text layout 2502A, like the text layout 2502B, for the CTDF 2500A can include arranging the primary and secondary text segments such that 1) their respective offsets are internally aligned and 2) a bisected parallelogram further distinguishes the primary text string 2503 and the secondary text string 2504. Although the primary text segments 2503 and the secondary text segments 2504 are shown to be internally aligned, they can instead be, for example, front-end or back-end aligned and still employ the bisected parallelogram of this embodiment.

FIG. 25b shows a comparative-text display format (CTDF) 2500B that can employ a related text layout 2502B. The text layout 2502B, like the text layout 2502A, for the CTDF 2500B can include arranging the primary and secondary text segments such that 1) their respective offsets are internally aligned and 2) a bisected parallelogram, the right-hand portion of which is shaded, further distinguishes the primary text string 2503 and the secondary text string 2504. It is to be understood that the shading may instead be employed relative to the left side of the bisected parallelogram and be within the scope of the present system. Although the primary text segments 2503 and the secondary text segments 2504 are shown to be internally aligned, they can be, for example, front-end or back-end aligned and still otherwise employ the shading and bisected parallelogram aspects of this embodiment.

FIG. 25c shows a comparative-text display format (CTDF) 2500C that can employ a related text layout 2502C. The text layout 2502C, like the text layout 2502B, for the CTDF 2500C can include arranging the primary and secondary text segments such that 1) their respective offsets are internally aligned and 2) an outer parallelogram (e.g., no bisection), the right-hand portion of which is shaded (e.g., encompassing the secondary text string 2504), further distinguishes the primary text string 2503 and the secondary text string 2504. It is to be understood that the shading may instead be employed relative to the left side (e.g., encompassing the primary text string 2503) and be within the scope of the present system. Although the primary text segments 2503 and the secondary text segments 2504 are shown to be internally aligned, they can be, for example, front-end or back-end aligned and still otherwise employ the shading and outer parallelogram aspects of this embodiment.

FIG. 25d shows a comparative-text display format (CTDF) 2500D that can employ a related text layout 2502D. The text layout 2502D, like the text layout 2502B, for the CTDF 2500D can include arranging the primary and secondary text segments such that 1) their respective offsets are internally aligned and 2) parallelogram-shaped shading may instead be employed relative to the left side (e.g., encompassing the primary text string 2503), further distinguishing the primary text string 2503 and the secondary text string 2504. It is to be understood that the parallelogram-shaped shading may instead be employed relative to the right side (e.g., encompassing the secondary text string 2504) and be within the scope of the present system. Although the primary text segments 2503 and the secondary text segments 2504 are shown to be internally aligned, they can be, for example, front-end or back-end aligned and still otherwise employ the parallelogram shaped shading of this embodiment.

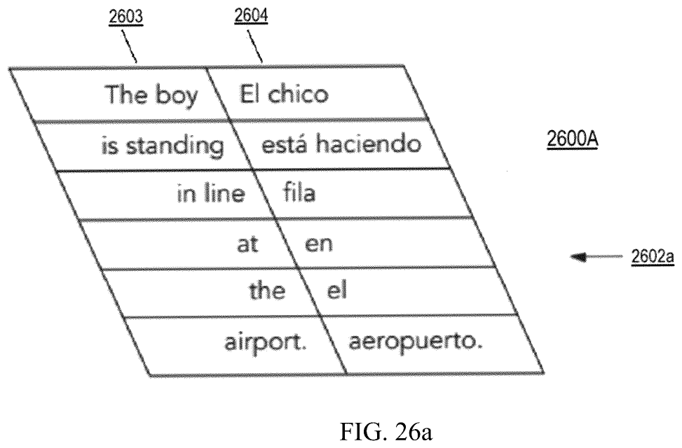

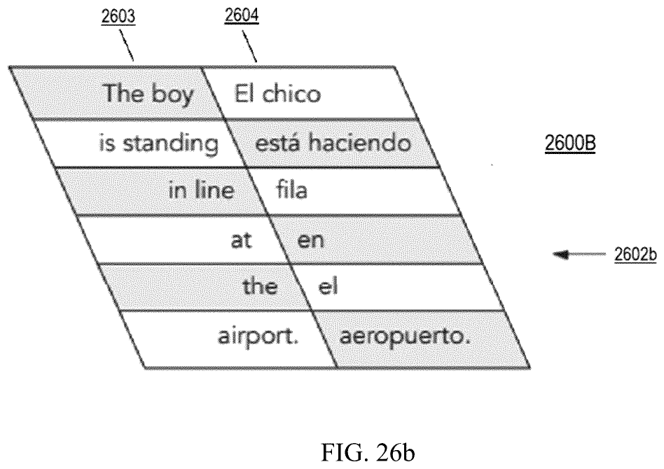

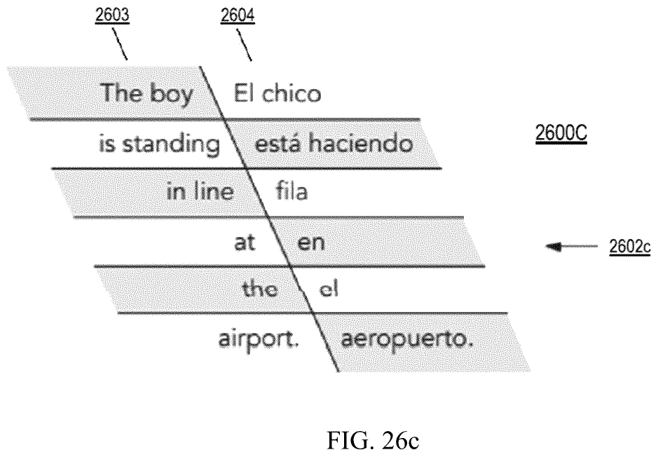

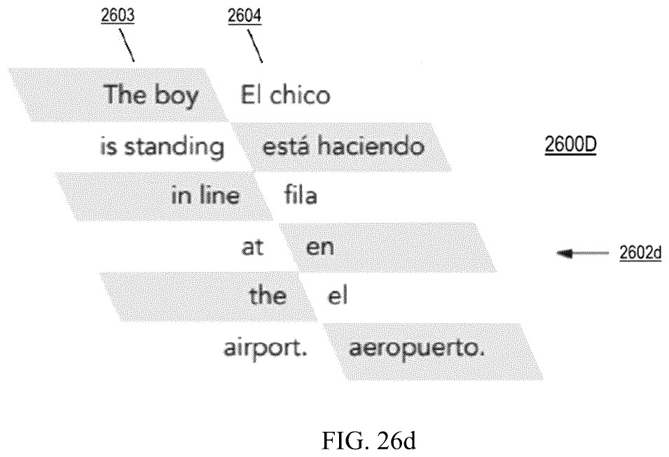

FIGS. 26a-26d show a series of display schemes/formats 2600A-2600D of a primary text string 2603 and a secondary text string 2604 where primary text segments and secondary text segments are presented side by side parallel to one another, using an offset progression between vertically adjacent lines of text, where those groups of text are further aligned as using a parallelogram format, with additional lines or shading relative to FIGS. 25a-25d, according to an embodiment.

FIG. 26a shows a comparative-text display format (CTDF) 2600A that can employ a related text layout 2602A. The text layout 2602A for the CTDF 2600A can include arranging the primary and secondary text segments such that 1) their respective offsets are internally aligned and 2) a bisected parallelogram (i.e., dividing between text on a same horizontal line), along with line-by-line boxing, further distinguishes the primary text string 2603 and the secondary text string 2604 by delineating text segments. Although the primary text segments 2603 and the secondary text segments 2606 are shown to be internally aligned, they can be, for example, front-end or back-end aligned and still otherwise employ the bisected parallelogram and boxing of this embodiment.

FIG. 26b shows a comparative-text display format (CTDF) 2600B that can employ a related text layout 2600B. The text layout 2602B for the CTDF 2600B can include arranging the primary and secondary text segments such that 1) their respective offsets are internally aligned and 2) a bisected parallelogram (i.e., dividing between text on a same horizontal line), along with line-by-line boxing and alternating shading (e.g., shading switching between sides of the bisector proceeding between vertically adjacent text segments), further distinguishing the primary text string 2603 and the secondary text string 2604 by delineating text segments (e.g., creating a “ladder effect”). Although the primary text segments 2603 and the secondary text segments 2604 are shown to be internally aligned, they can be, for example, front-end or back-end aligned and still otherwise employ the bisected parallelogram, boxing, and alternating shading of this embodiment.

FIG. 26c shows a comparative-text display format (CTDF) 2600C that can employ a related text layout 2600C. The text layout 2602c for the CTDF 2600C can include arranging the primary and secondary text segments such that 1) their respective offsets are internally aligned and 2) a bisecting line (i.e., dividing between text on a same horizontal line), along with horizontal lining and alternating shading, further distinguishes the primary text string 2603 and the secondary text string 2605 by delineating text segments (e.g., creating a “ladder effect”). Although the primary text segments 2605 and the secondary text segments 706 are shown to be internally aligned, they can be, for example, front-end or back-end aligned and still otherwise employ the bisecting line, horizontal lining, and alternating shading of this embodiment.

FIG. 26d shows a comparative-text display format (CTDF) 2600D that can employ a related text layout 2602D. The text layout 2602D for the CTDF 2600D can include arranging the primary and secondary text segments such that 1) their respective offsets are internally aligned and 2) alternating shading further distinguishes the primary text string 2603 and the secondary text string 2605 by delineating text segments (e.g., creating a “ladder effect”). Although the primary text segments 2603 and the secondary text segments 2604 are shown to be internally aligned, they can be, for example, front-end or back-end aligned and still otherwise employ the alternating shading of this embodiment. It is to be understood that shading is not limited to an alternating progression, but, for example, can be used in a full-line alternating pattern (e.g., full-line shaded, next line of horizontal text not shaded), if desired.

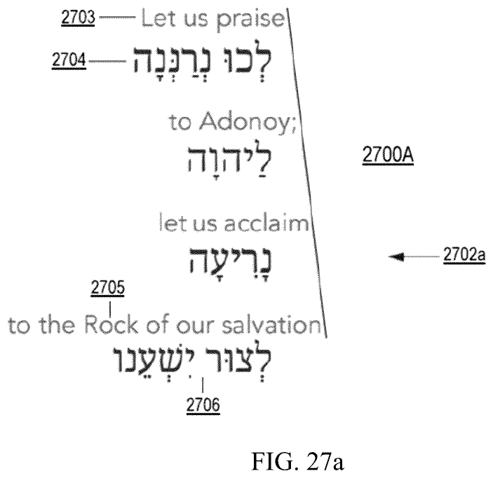

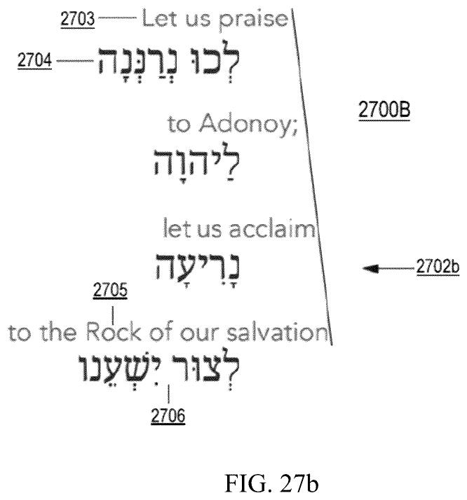

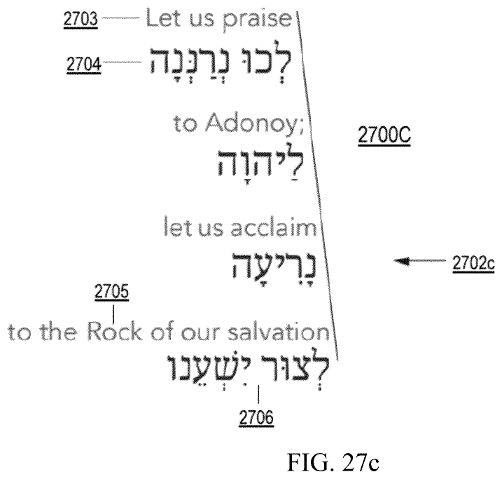

FIGS. 27a-27c show a series of display schemes/formats 2700A-2700C of a primary text string 2703 and a secondary text string 2704 where primary text segments and secondary text segments are arranged in an alternating vertical progression, where at least one of the primary or secondary texts 2703, 2704 incorporates an offset vertical progression.

FIG. 27a shows a comparative-text display format (CTDF) 2700A that can employ a related text layout 2702a. The text layout 2702a for the CTDF 2700A can include arranging the primary text segments 2705 and the secondary text segments 2706 in an alternating vertical progression pattern, where the primary text string 2703 (e.g., in this case, the English text) incorporates an offset vertical progression relative to the back (or right) edge of each of its primary text segments 2705, and the secondary text string 2704 (e.g., in this case, the Hebrew text) is vertically aligned relative to the back or right end of each of its secondary text segments 2706. In the embodiment shown, the primary text segments 2705 are moved or offset by one space for each succeeding line of English text, but it is to be understood that another offset may be chosen.

FIG. 27b shows a comparative-text display format (CTDF) 2700B that can employ a related text layout 2702B. The text layout 2702B for the CTDF 2700B is similar to the text layout 2702A for the CTDF 2700A but further includes a placement of secondary text segments 2706 further inset from their corresponding primary text segments 2705, further distinguishing the primary and secondary text strings.

FIG. 27c shows a comparative-text display format (CTDF) 2700C that can employ a related text layout 2702C. The text layout 2702C for the CTDF 2700C can include arranging the primary text segments 2705 and the secondary text segments 2706 in an alternating vertical progression pattern, where both the primary text string 2703 (e.g., in this case, the English text) and the secondary text string 2704 (e.g., in this case, the Hebrew text) incorporates an offset vertical progression relative to the back (or right) edge of each of its text segments. In the embodiment shown, the text segments are moved or offset by one space for each succeeding line of text, progressing in a downward fashion. In the illustrated text layout 2702C, the offset is shown to be one space or letter, but it is to be understood that another offset may be chosen. The right/backside alignment lines are provided in FIGS. 27a-27c to help accentuate the use of text alignment in those embodiments. Those alignment lines shown respectively in FIGS. 27a-27c may or may not be included as part of the printed/displayed text layouts 2702A-2702C.

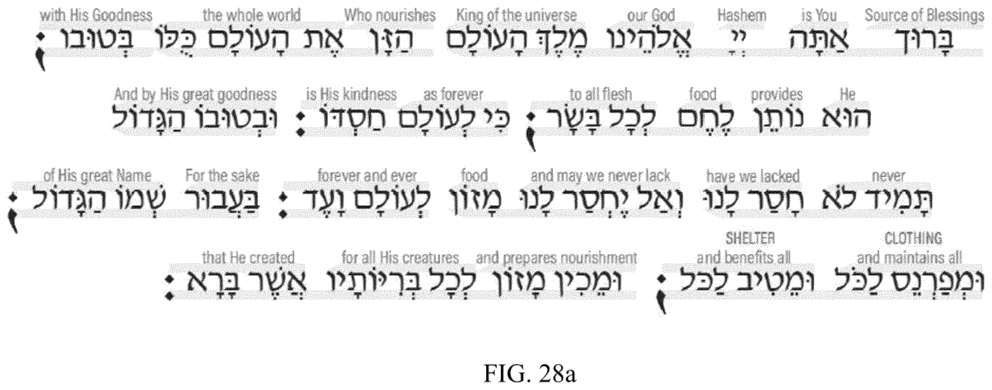

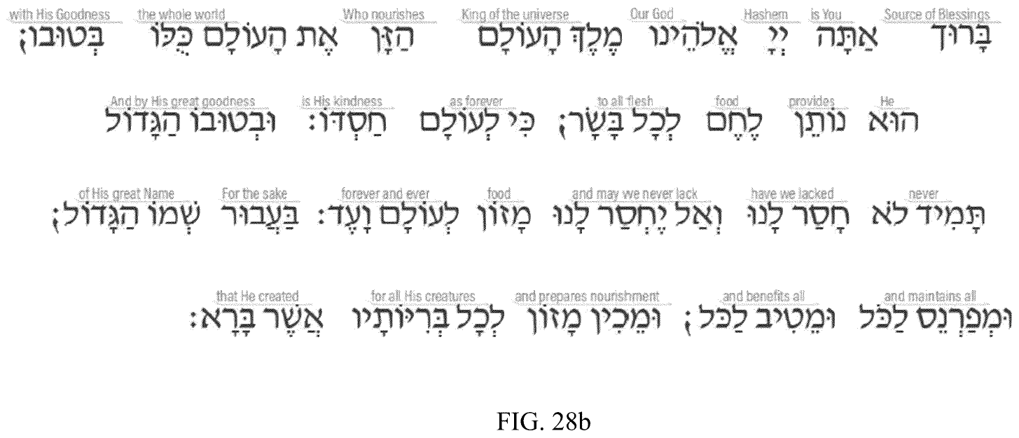

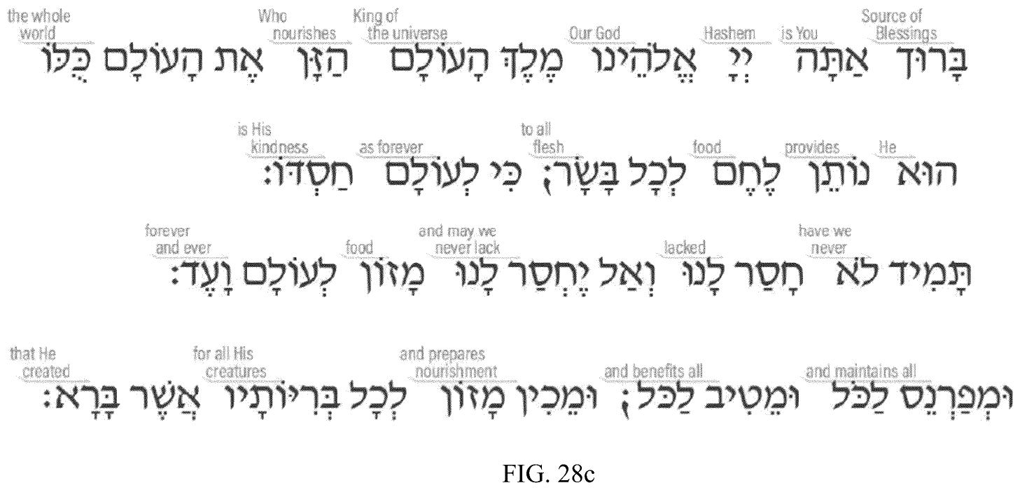

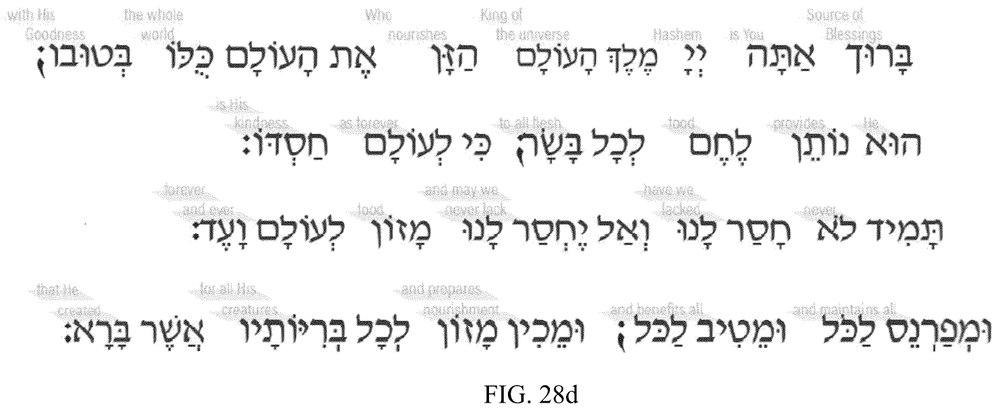

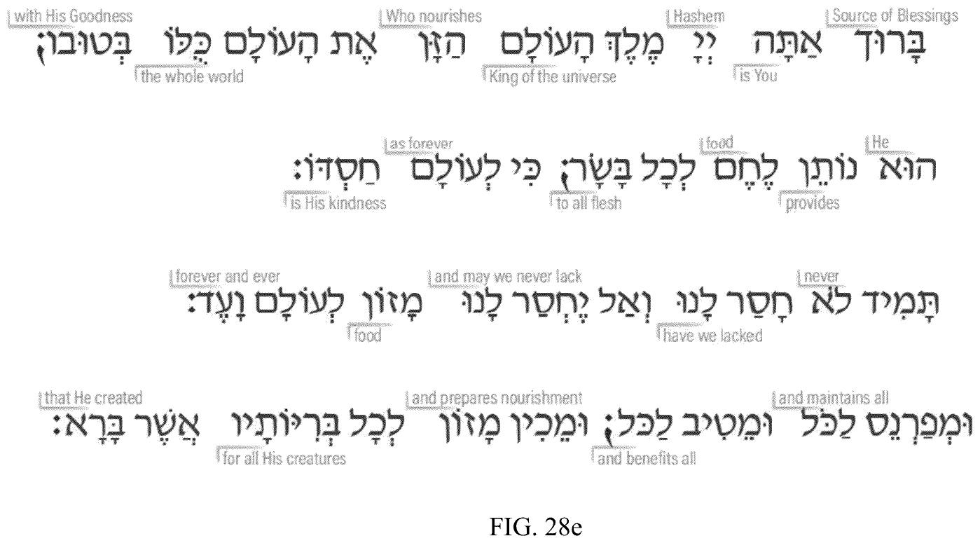

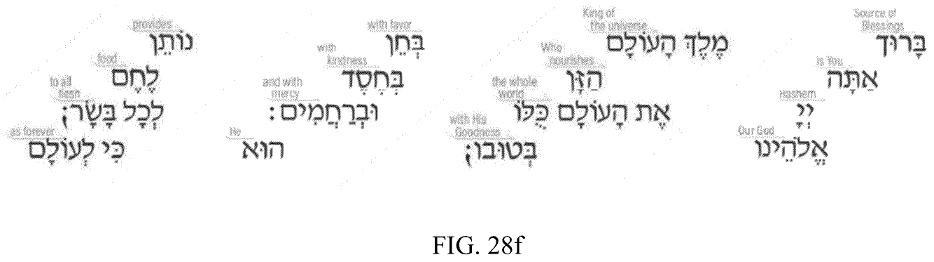

FIGS. 28a-28f show various CTDFs of a Hebrew text string comprised of Hebrew text segments and a corresponding English text string comprised of English text segments. Line 1 of FIG. 28b shows a CTDF with an uneven spacing in between adjacent Hebrew substrings and an uneven spacing in between adjacent English substrings, harming the flow of the text from one substring pair to the next. In contrast, line 3 of FIG. 28b shows a CTDF with an improved spacing in between adjacent Hebrew substring and an improved spacing in between adjacent English substrings, improving the flow of the text from one substring pair to the next. In an embodiment, the calculation module 318 generates an improved spacing schematic for the primary substrings and/or the secondary substrings. The placement module 320 then places the primary substrings and/or the secondary substrings according to improved spacing schematic. In an embodiment, the calculation module 318 generates the improved spacing schematic by 1) determining the total spacing in between the primary substrings and/or the secondary substrings, 2) determining the total number of spaces in between the primary substrings and/or the secondary substrings, and 3) calculating the average spacing in between the primary substrings and/or the secondary substrings, and 4) generating an improved spacing schematic where the primary substrings and/or the secondary substrings are spaced apart by the average spacing. Alternatively, the calculation module generates the improved spacing schematic using any formula or method that improves the flow of the text from one substring pair to the next when the primary substrings and/or the secondary substrings are placed according to the improved spacing schematic.

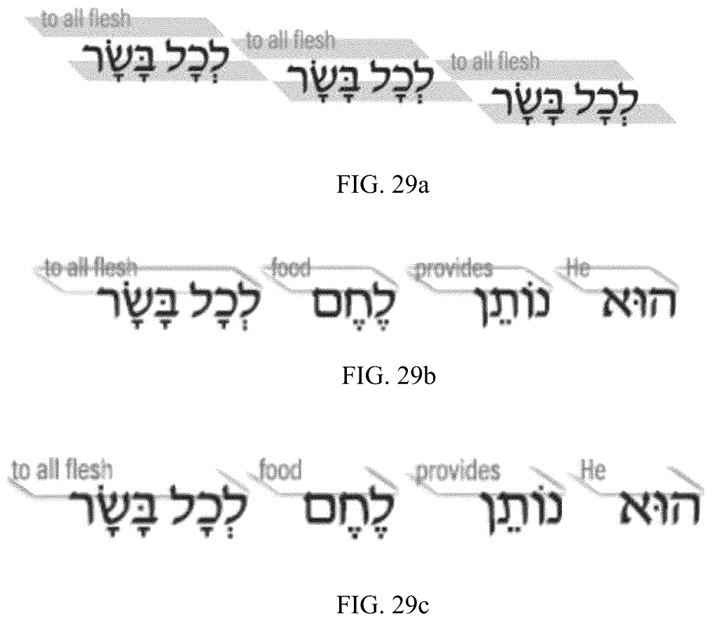

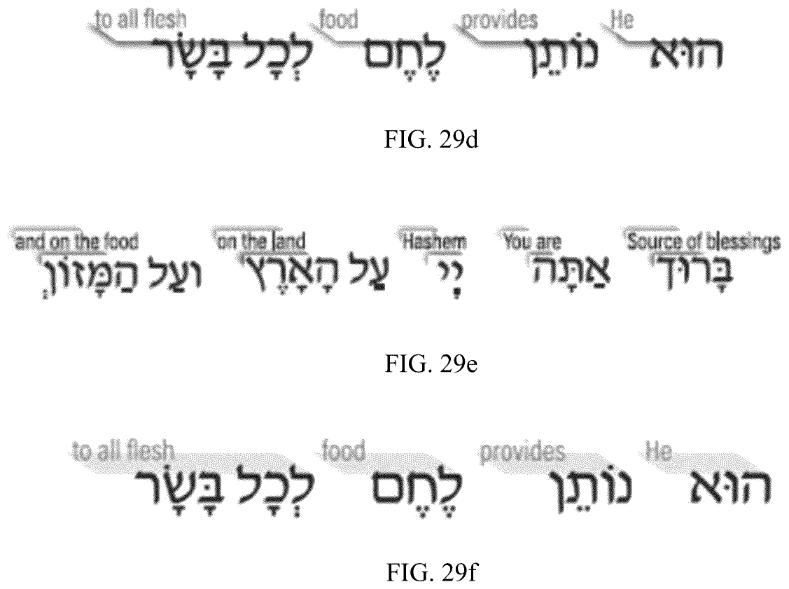

FIGS. 29a-29f show various CTDFs of a Hebrew text string comprised of Hebrew text segments and a corresponding English text string comprised of English text segments.

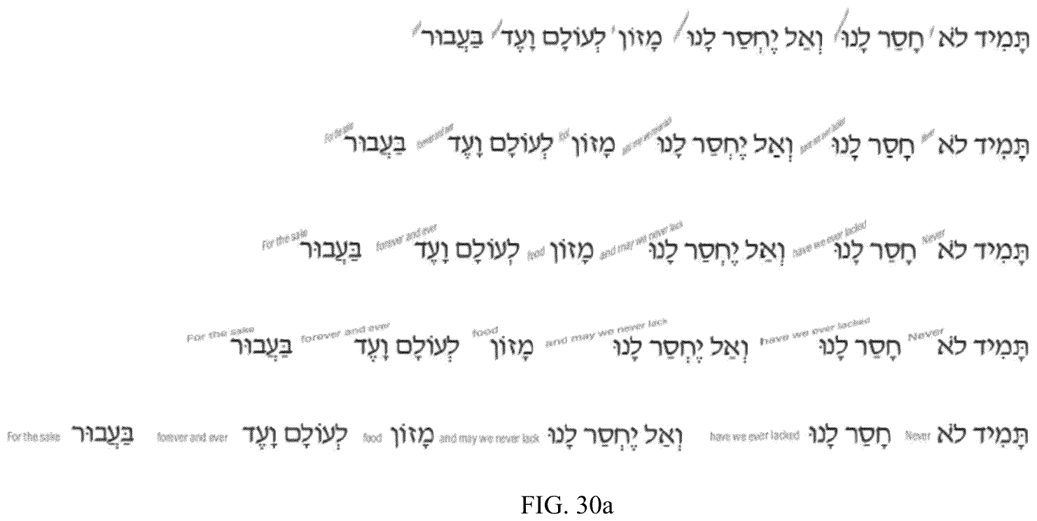

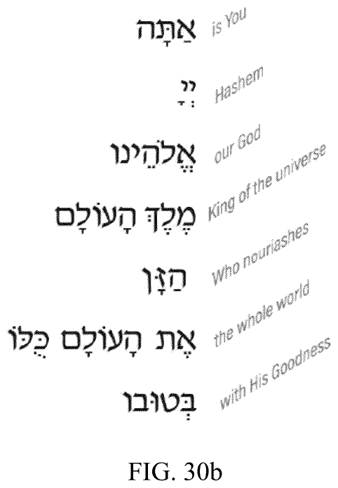

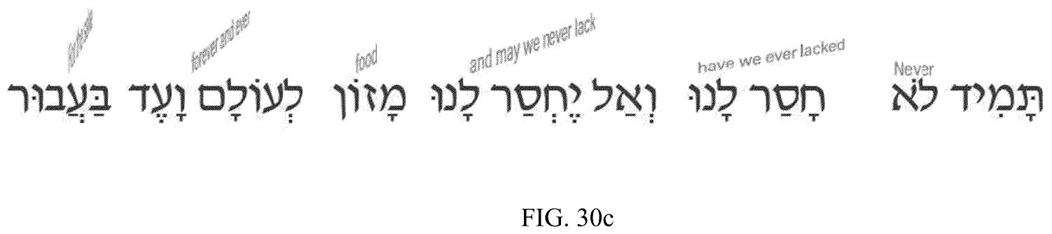

FIG. 30a shows a gradual deemphasis of secondary text segments in each consecutive iteration, starting from the bottom and moving upwards.

FIG. 30b shows a CTDF of a Hebrew text string comprised of Hebrew text segments and a corresponding English text string comprised of English text segments.

FIG. 30c shows a gradual deemphasis of secondary text segments for each pairing of corresponding primary and secondary text segments, starting from the right and moving left.

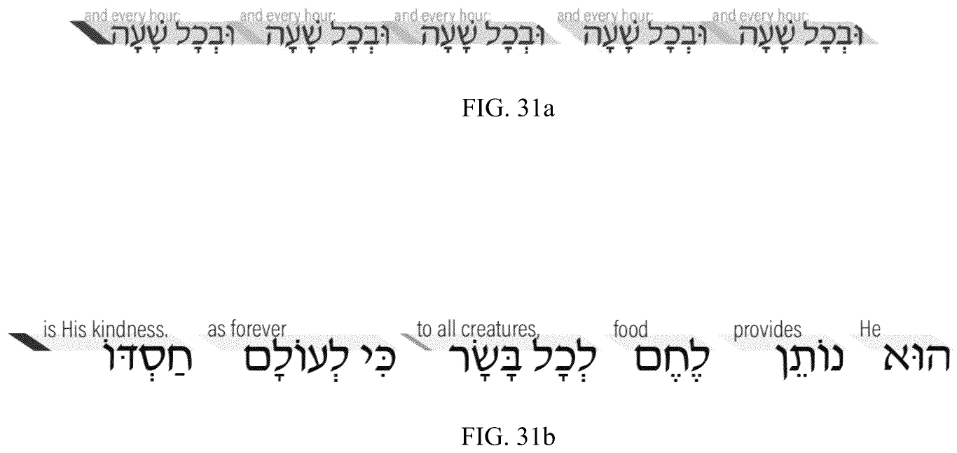

FIGS. 31a-31b show various CTDFs of a Hebrew text string comprised of Hebrew text segments and a corresponding English text string comprised of English text segments.

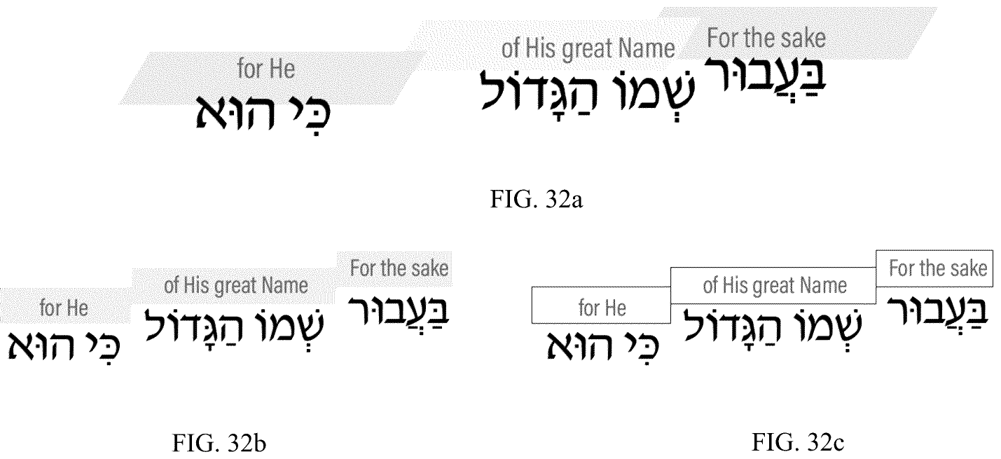

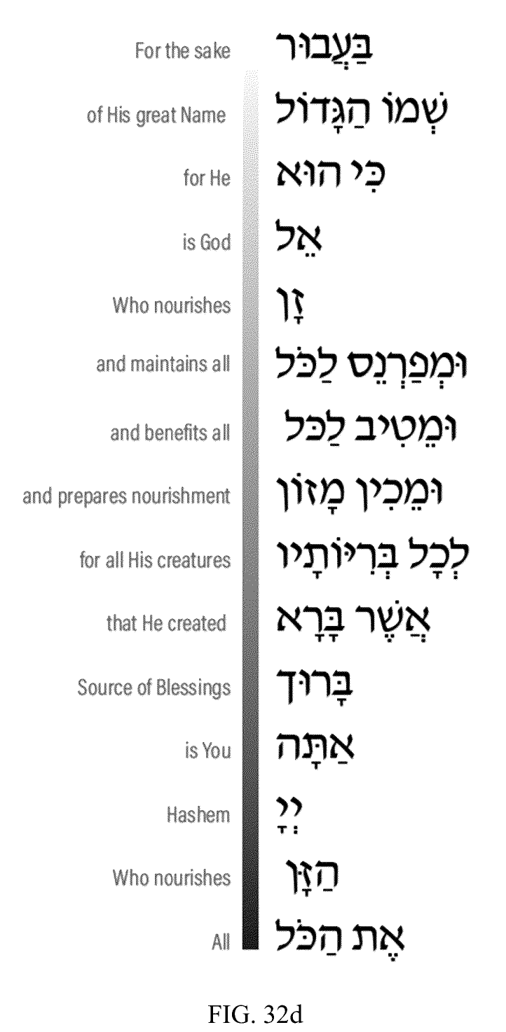

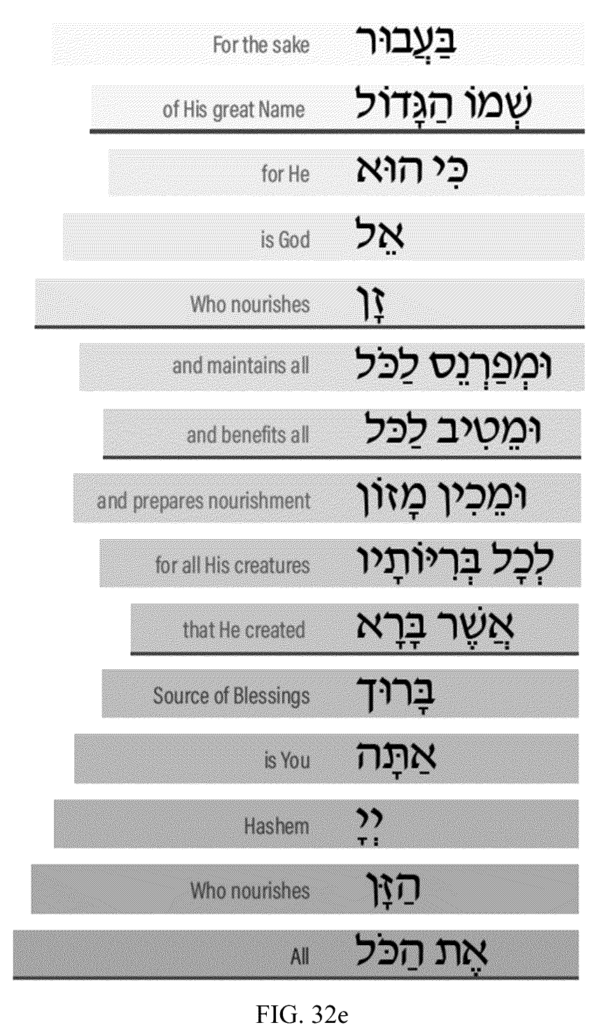

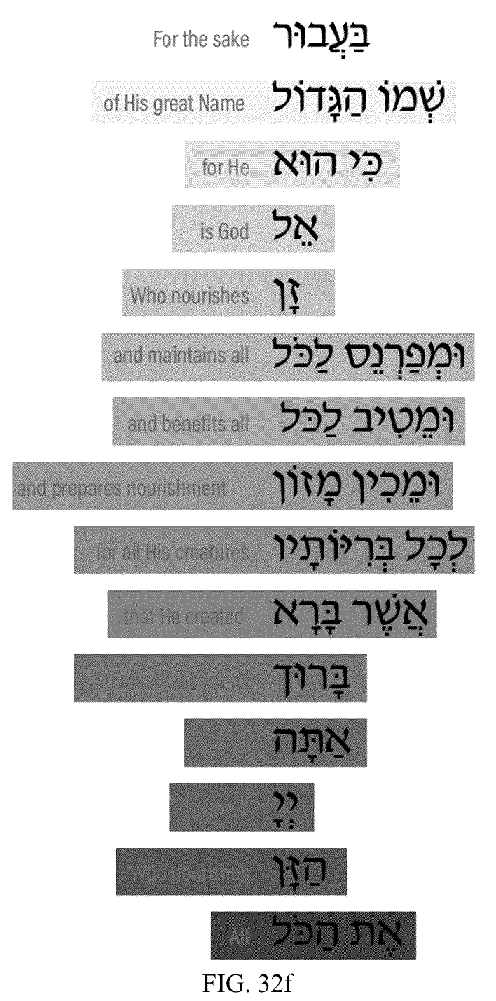

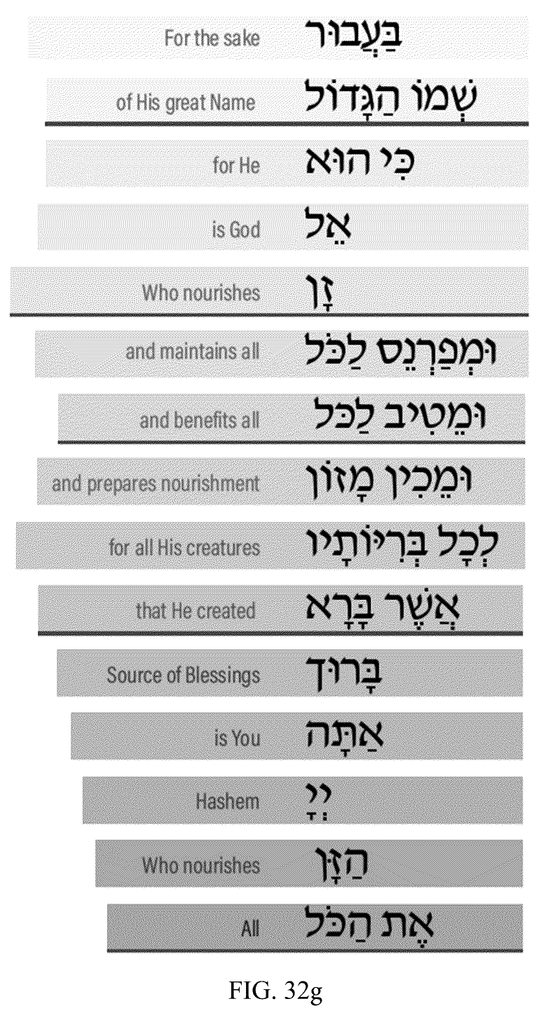

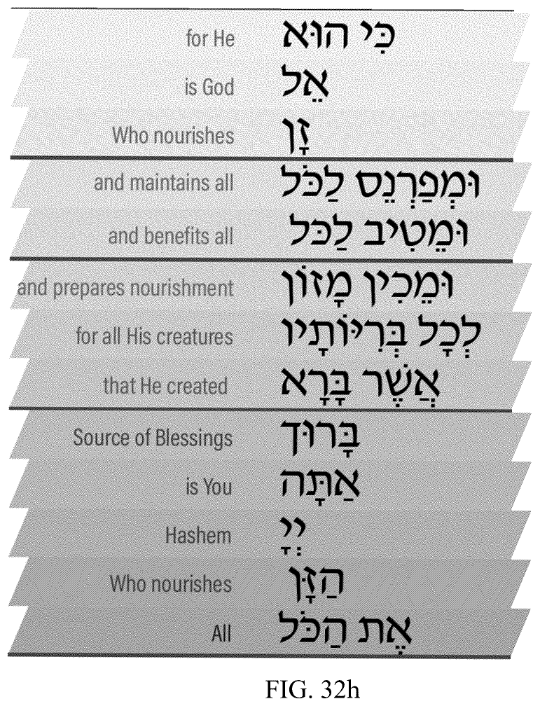

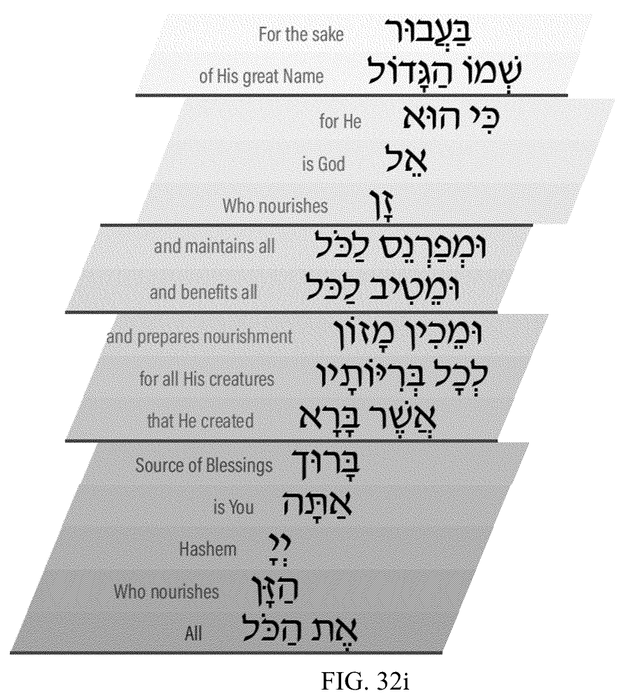

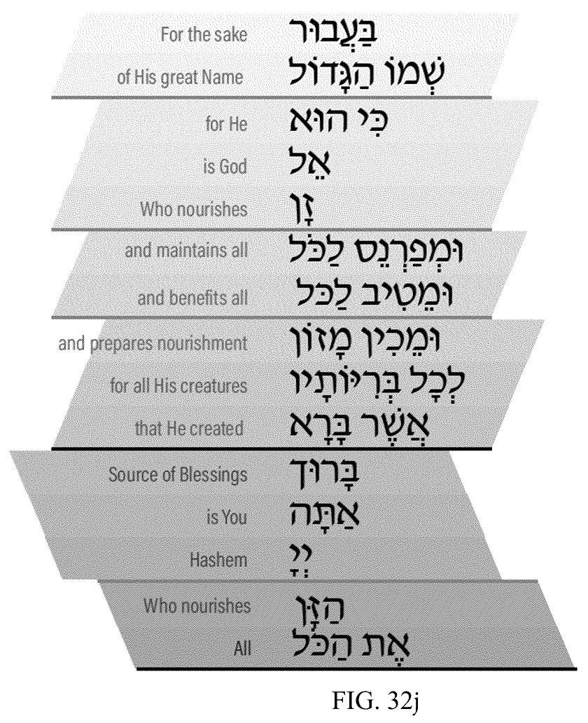

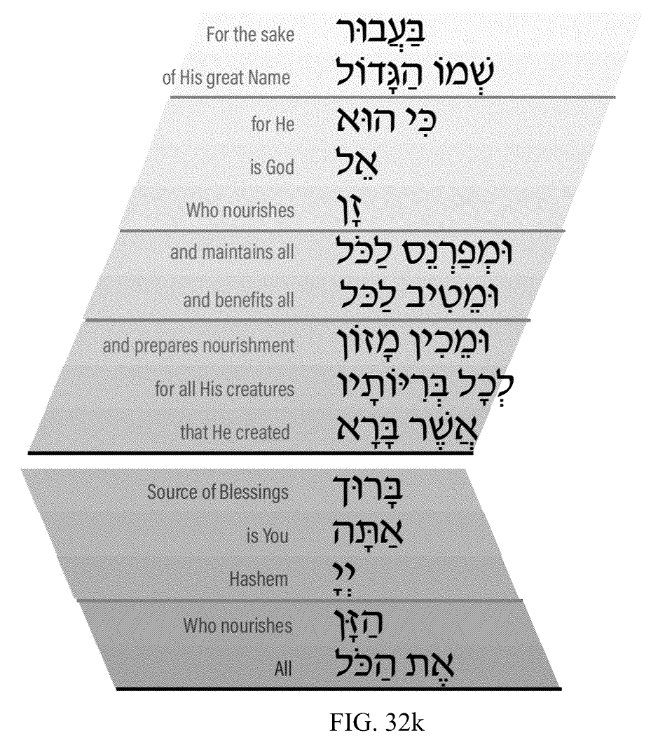

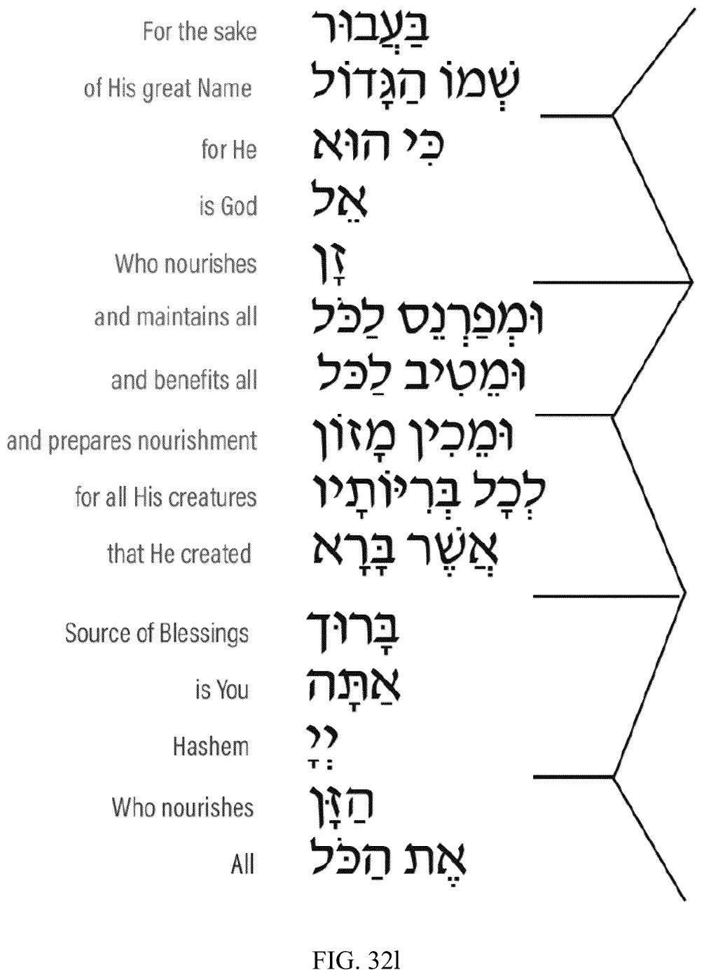

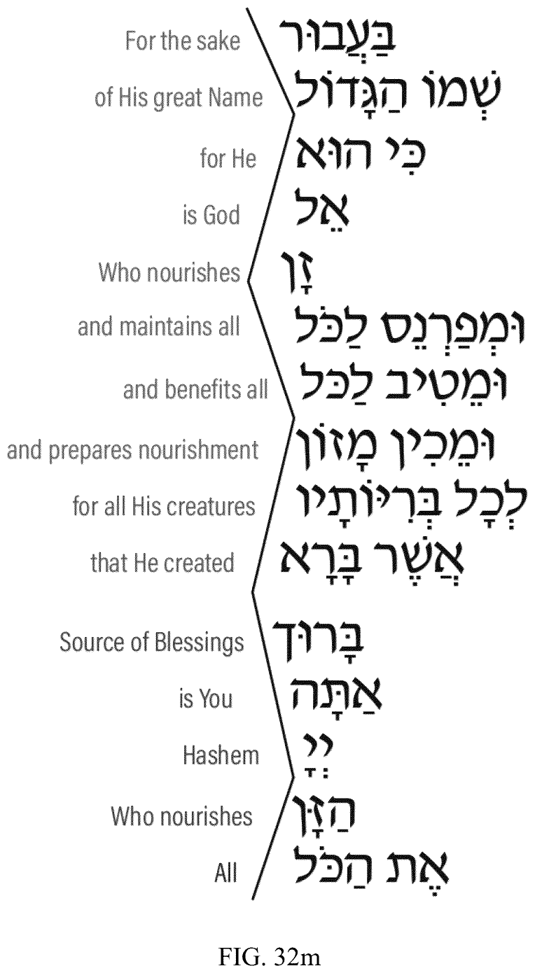

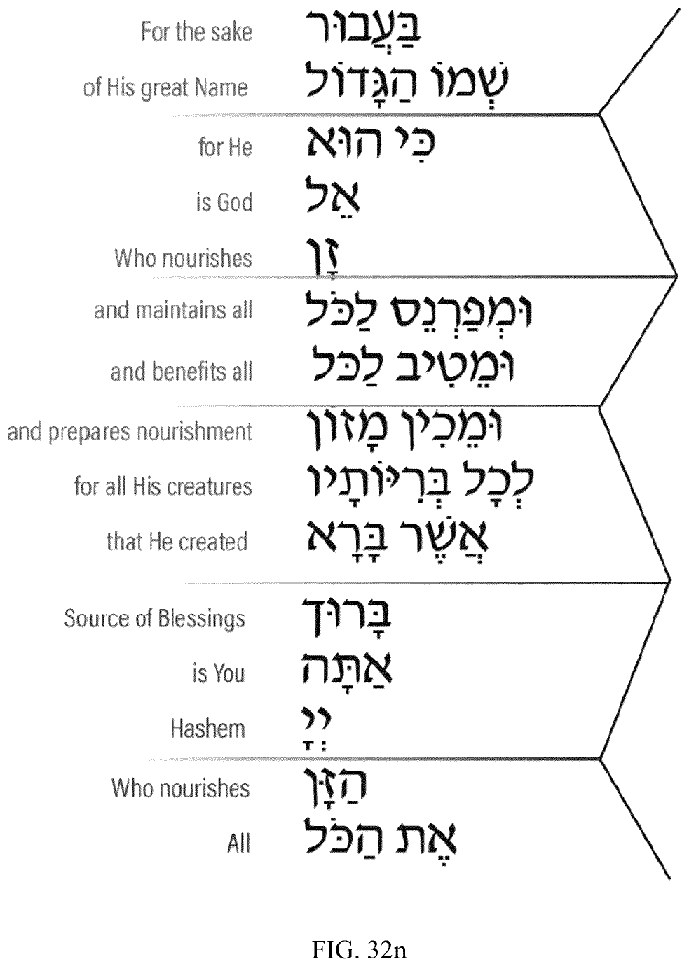

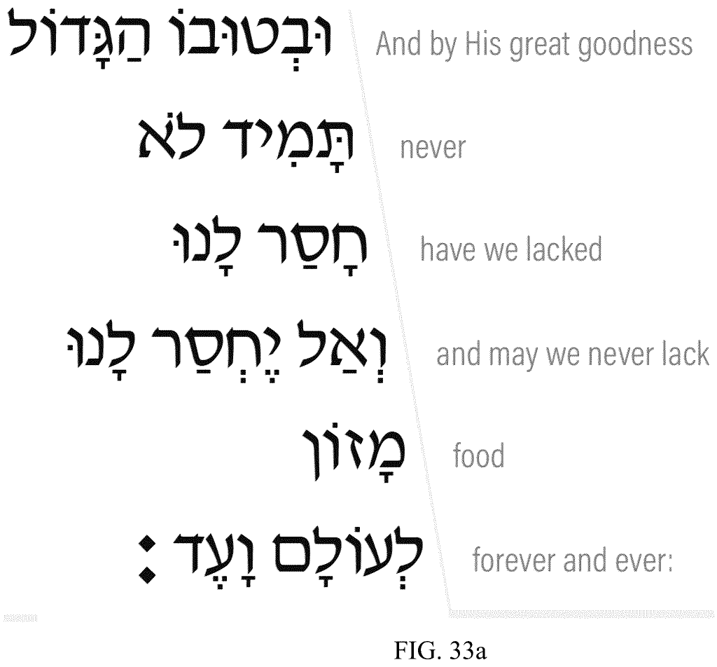

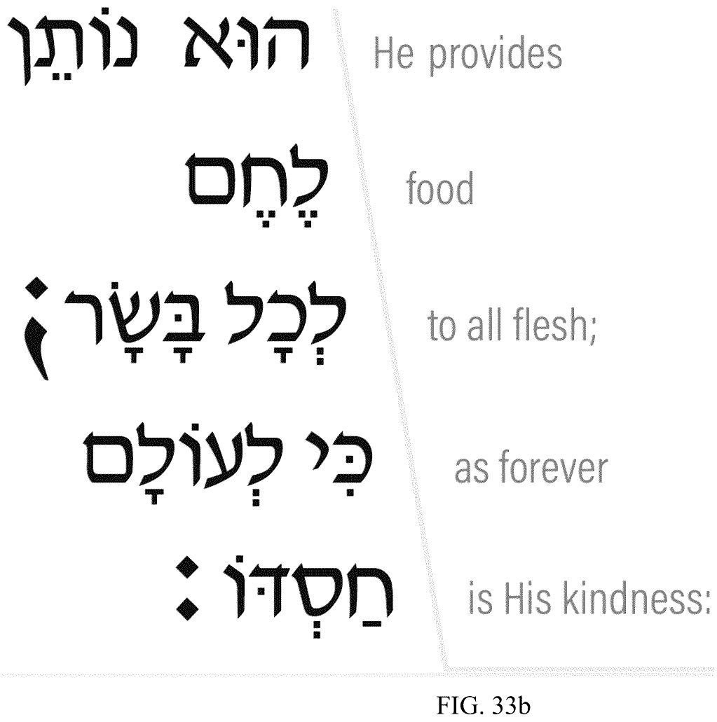

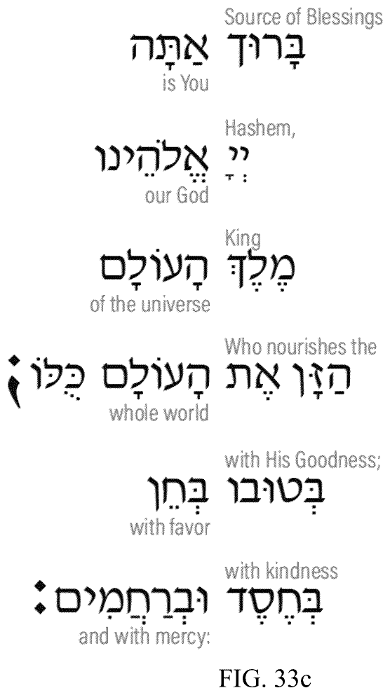

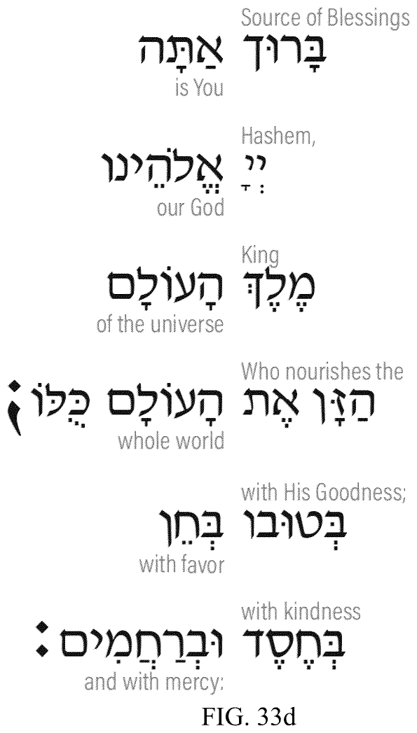

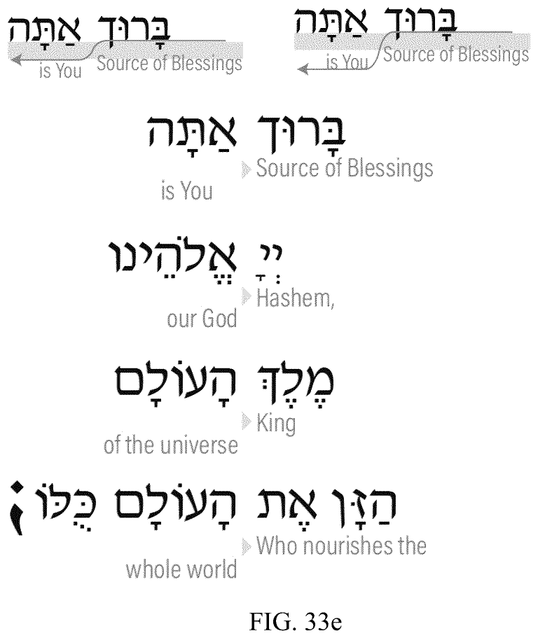

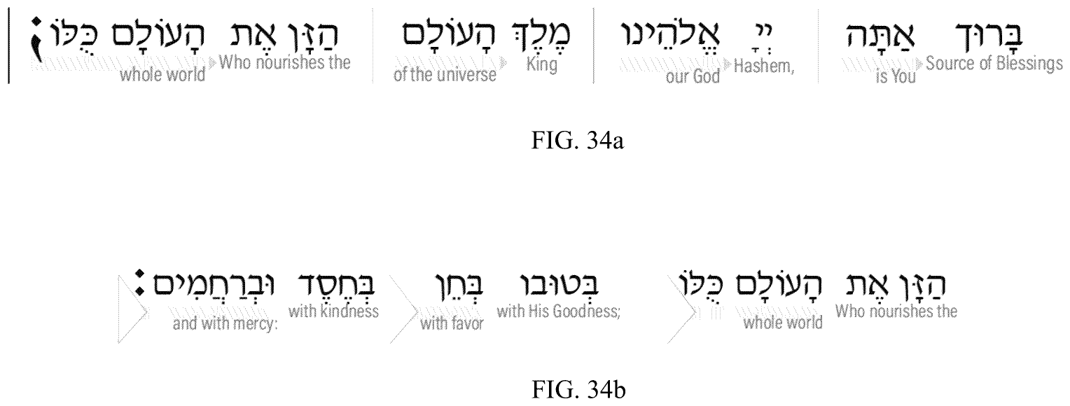

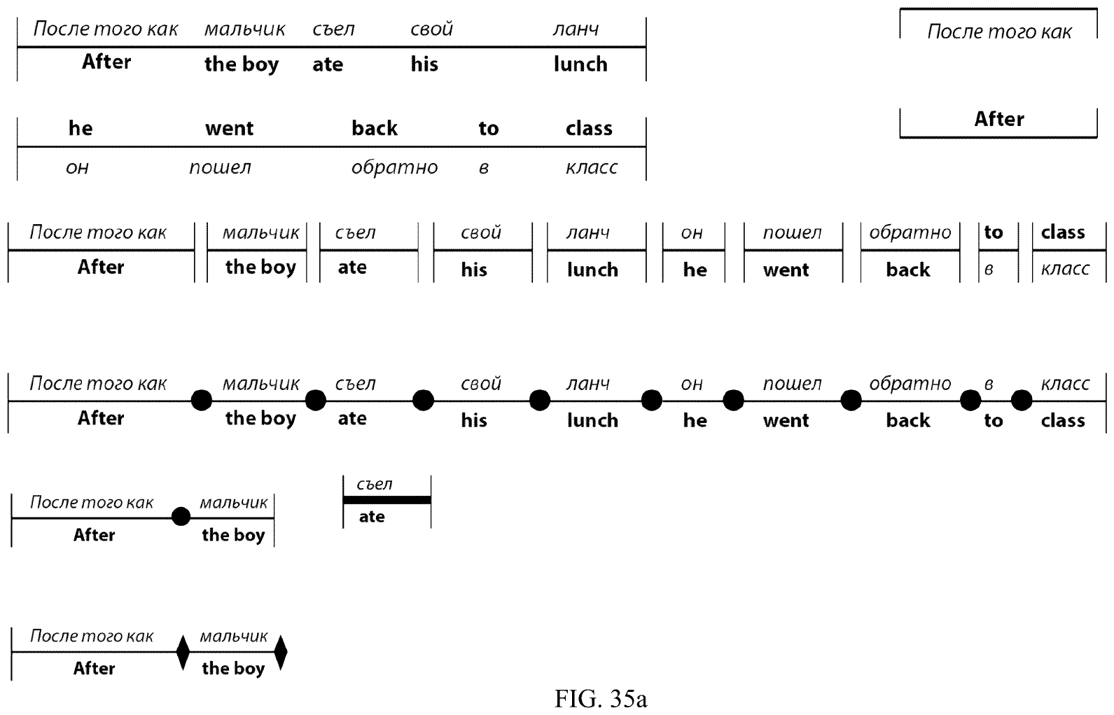

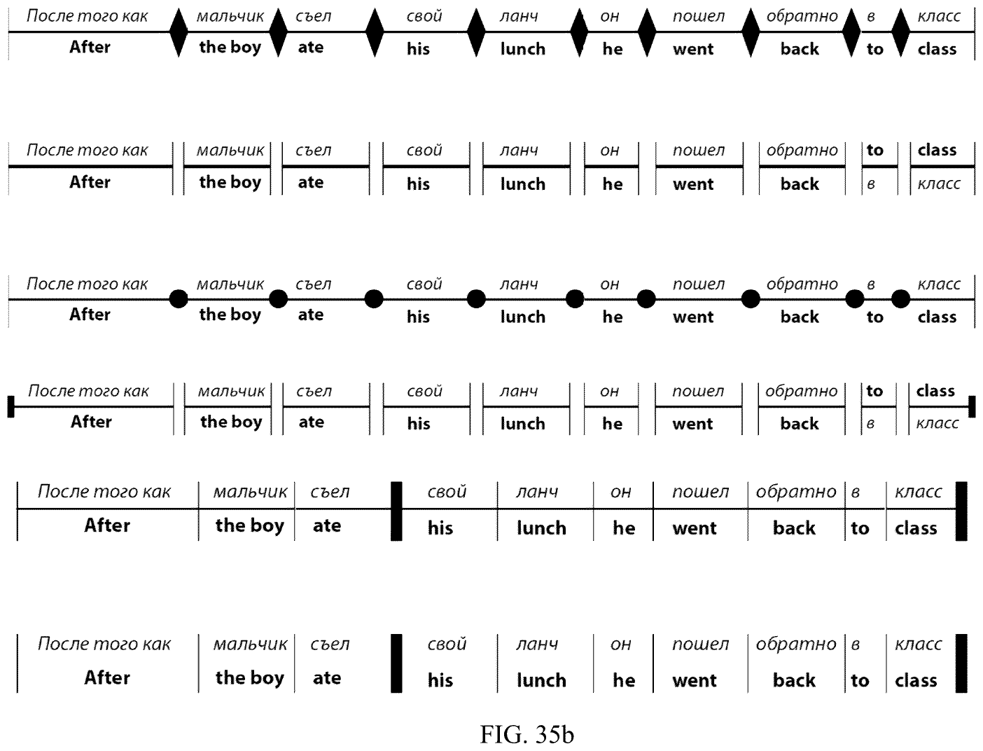

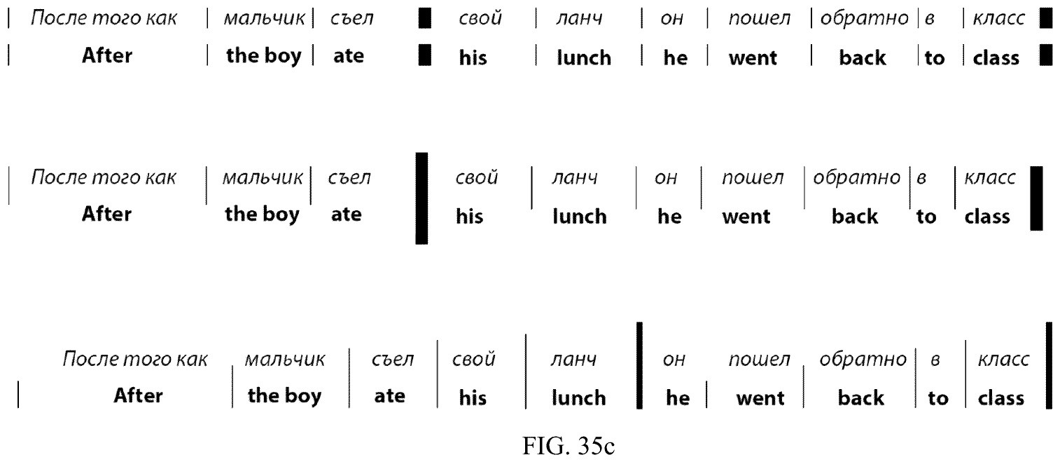

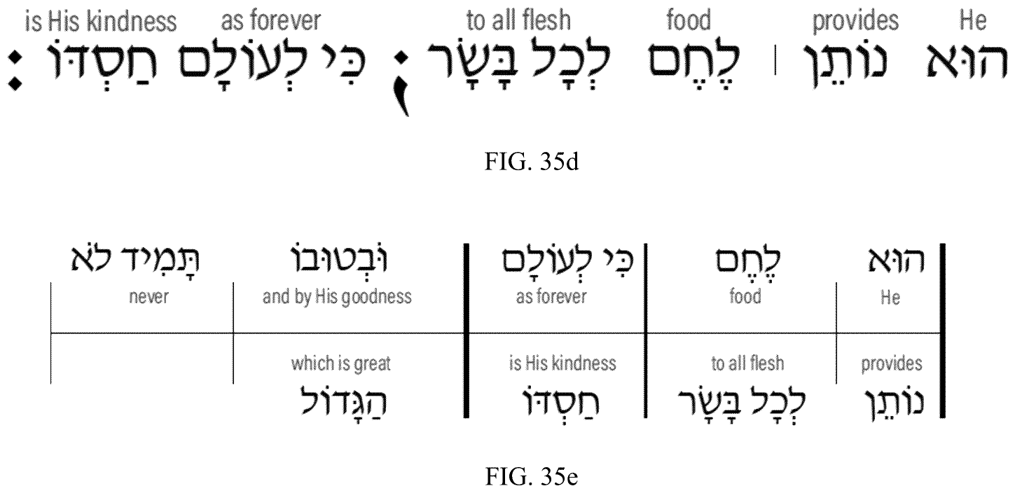

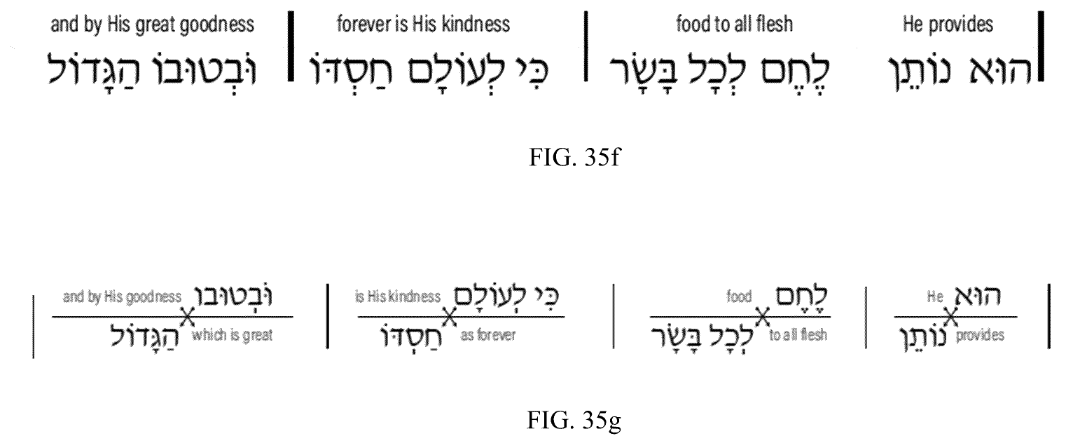

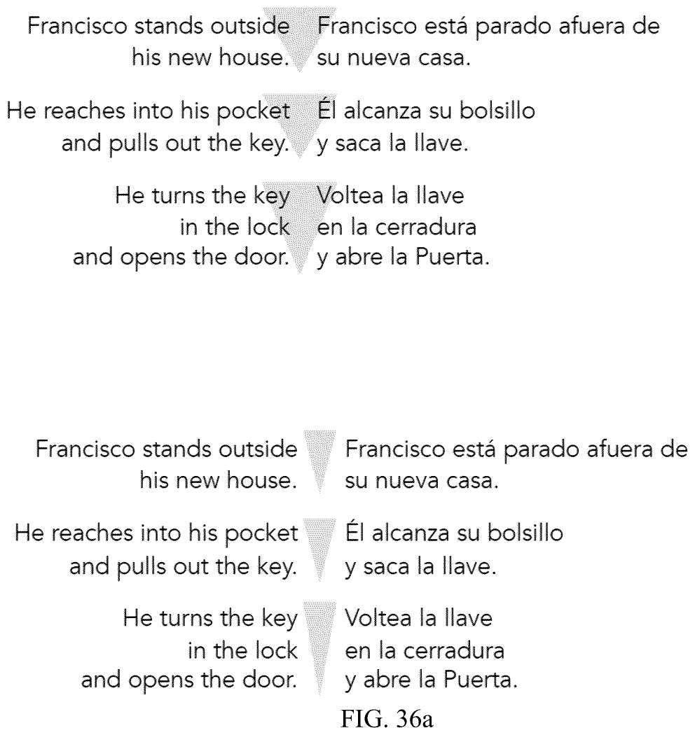

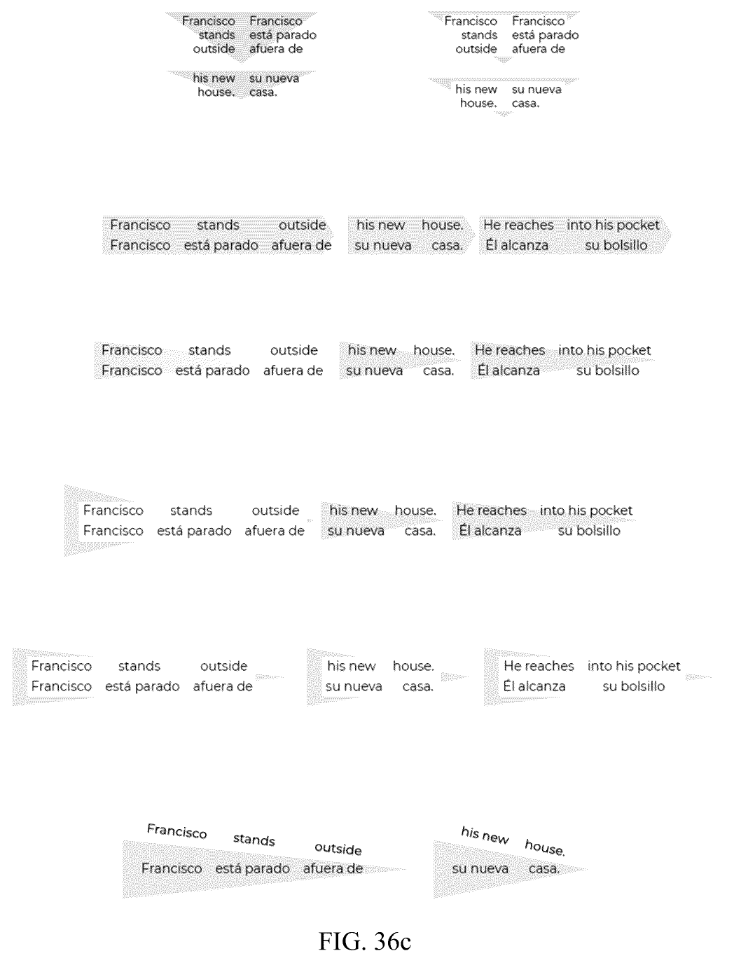

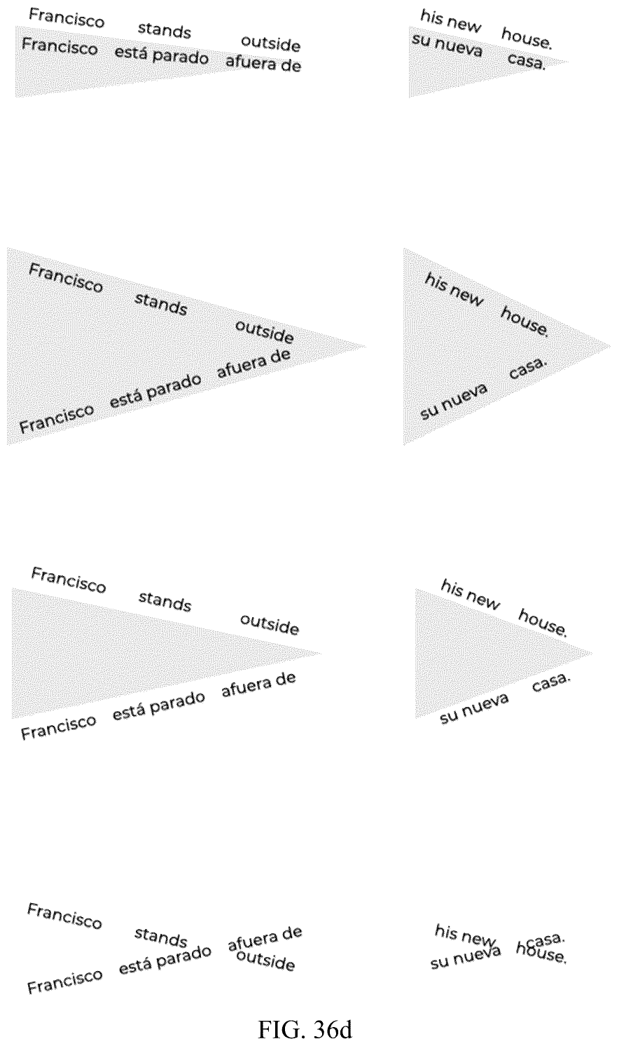

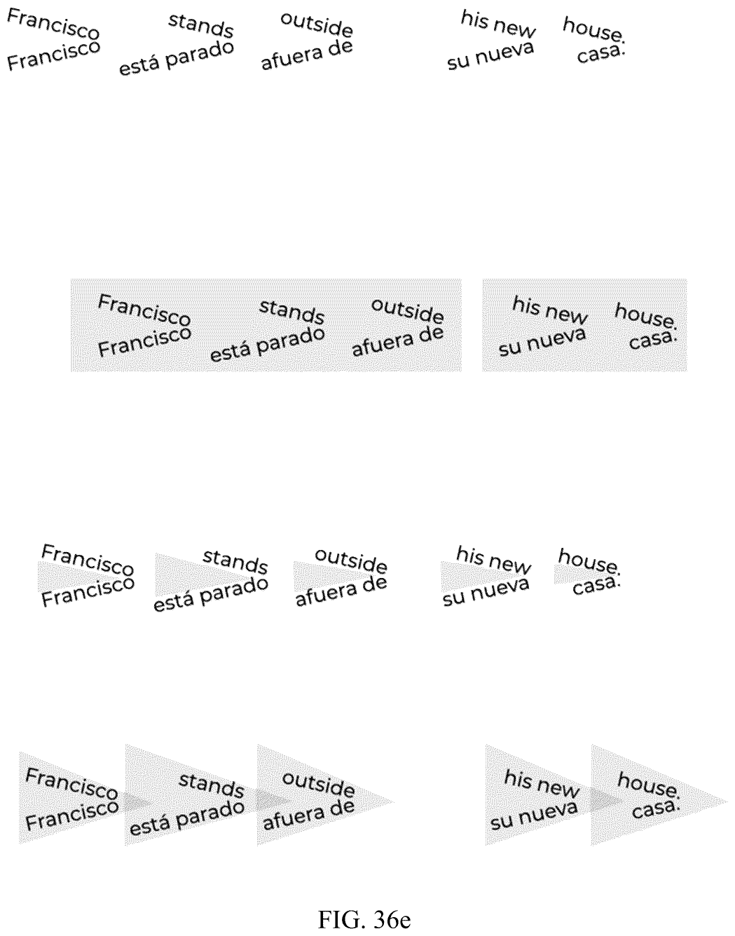

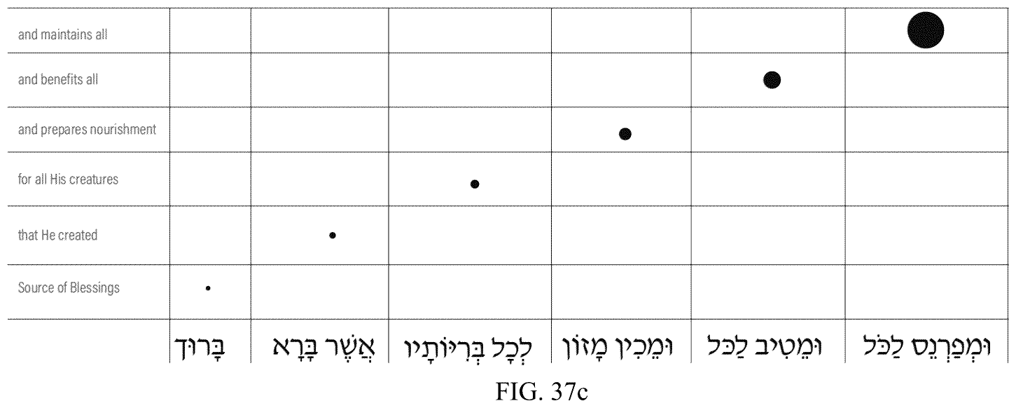

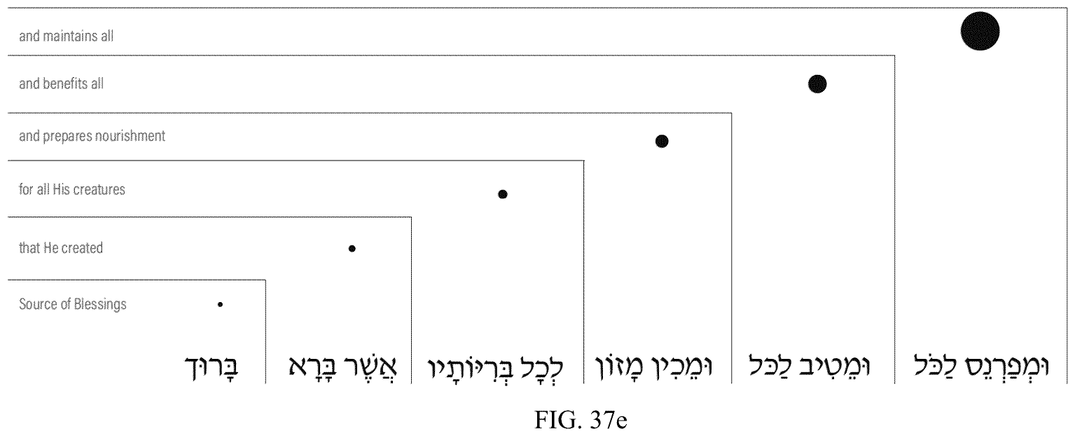

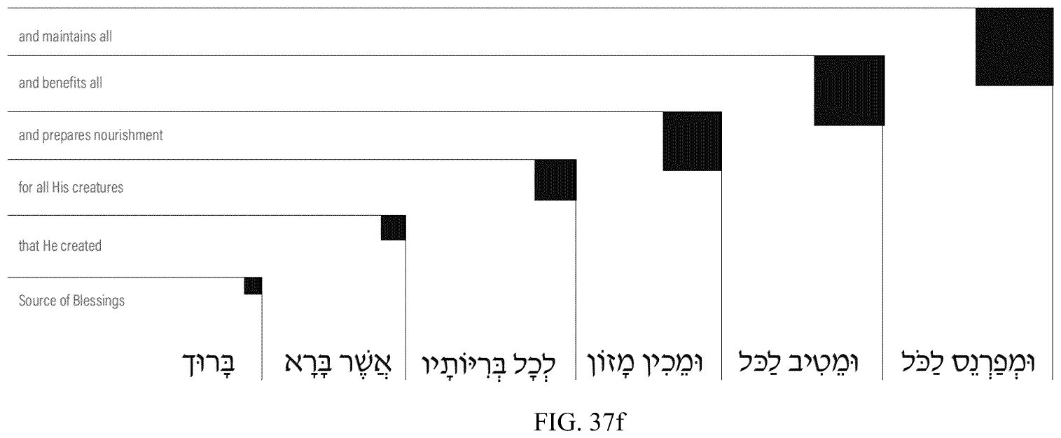

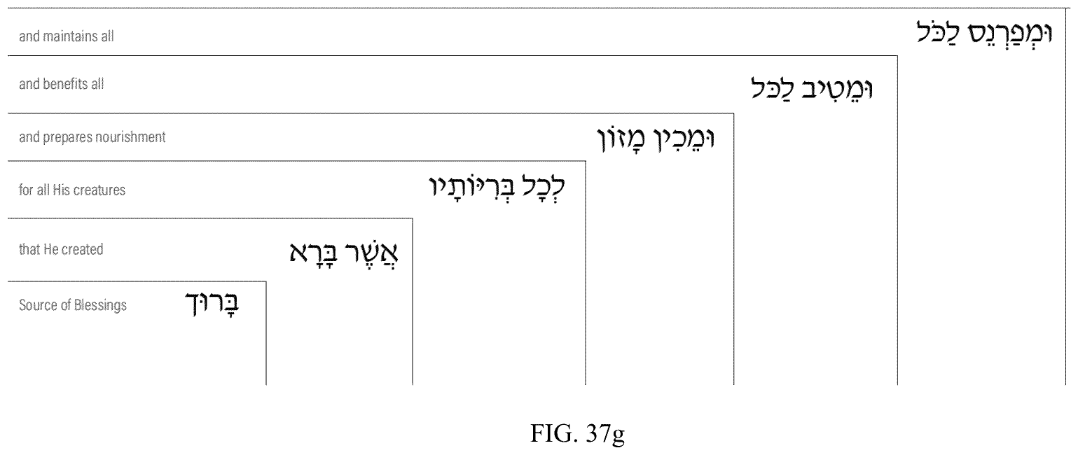

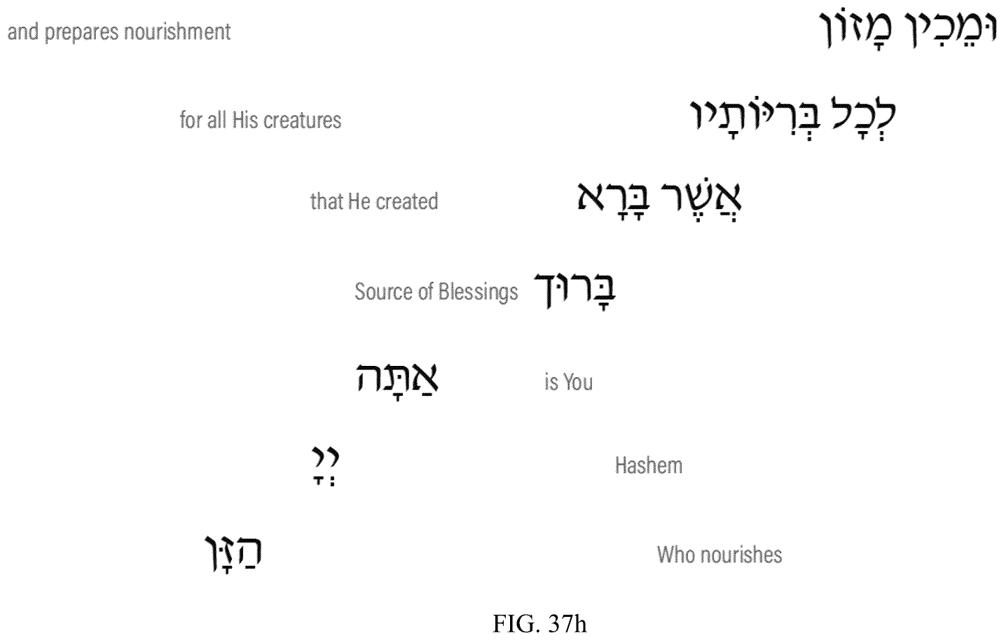

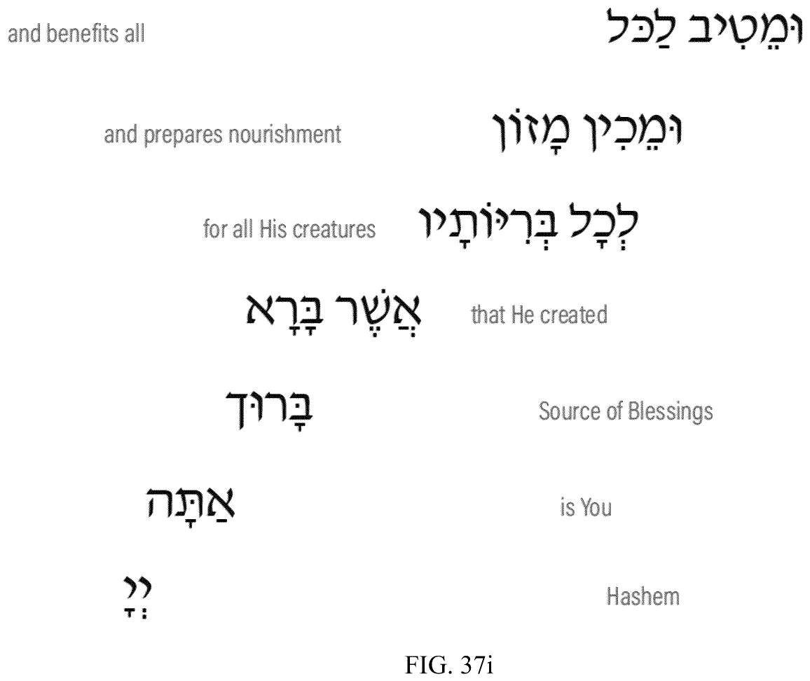

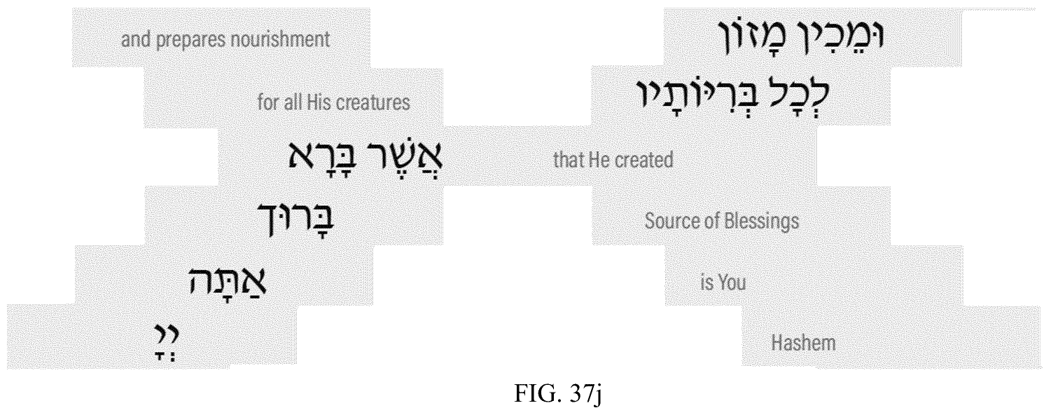

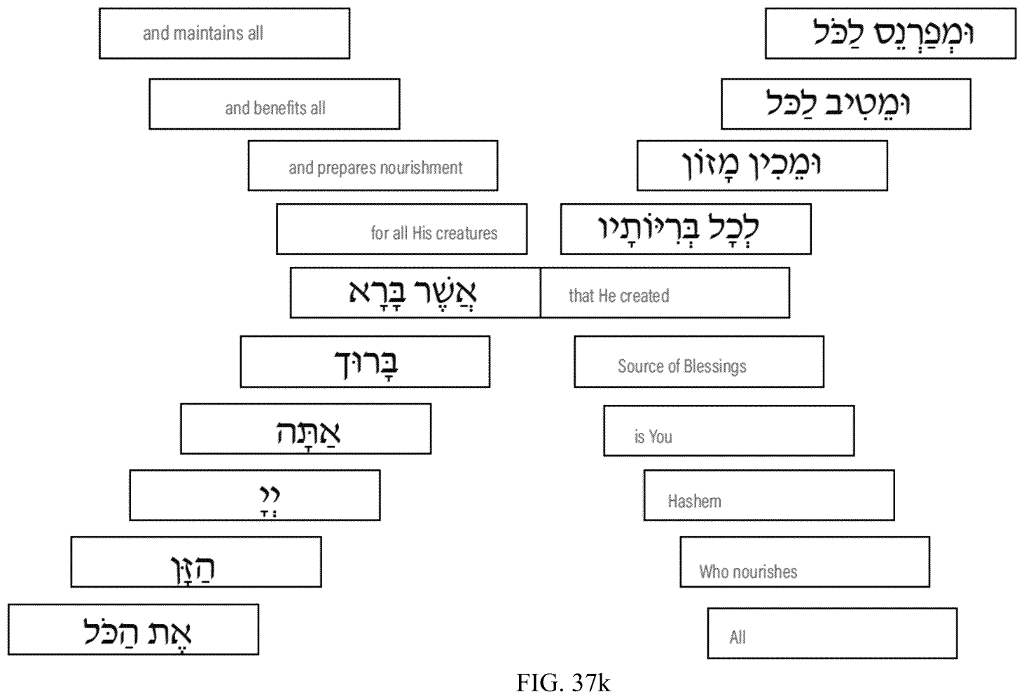

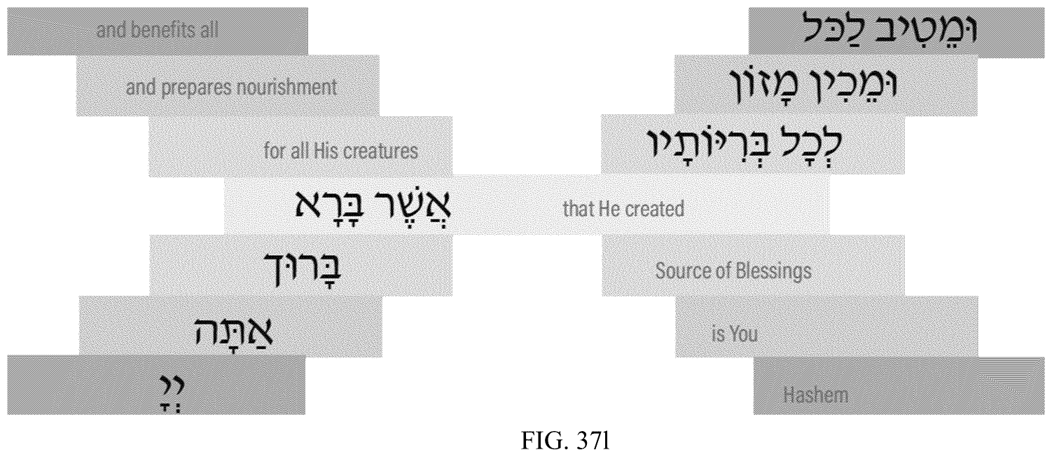

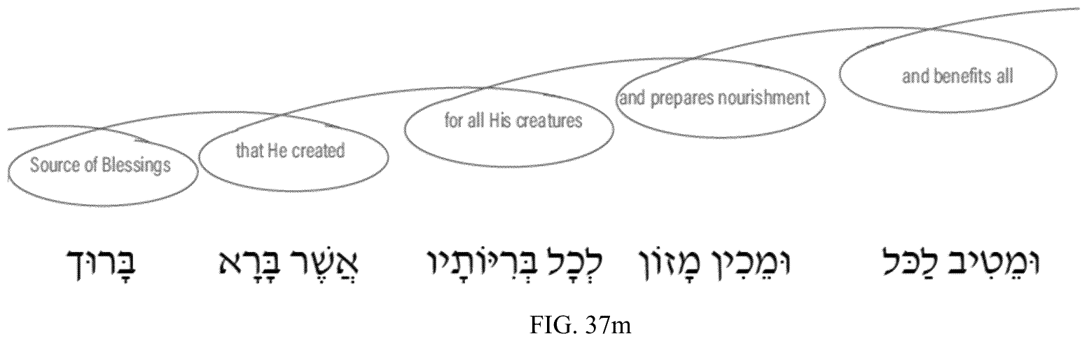

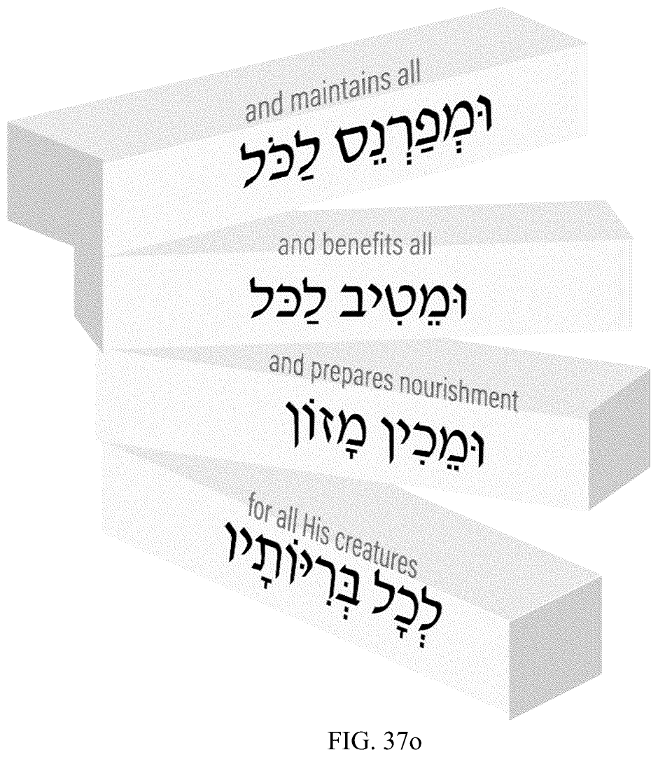

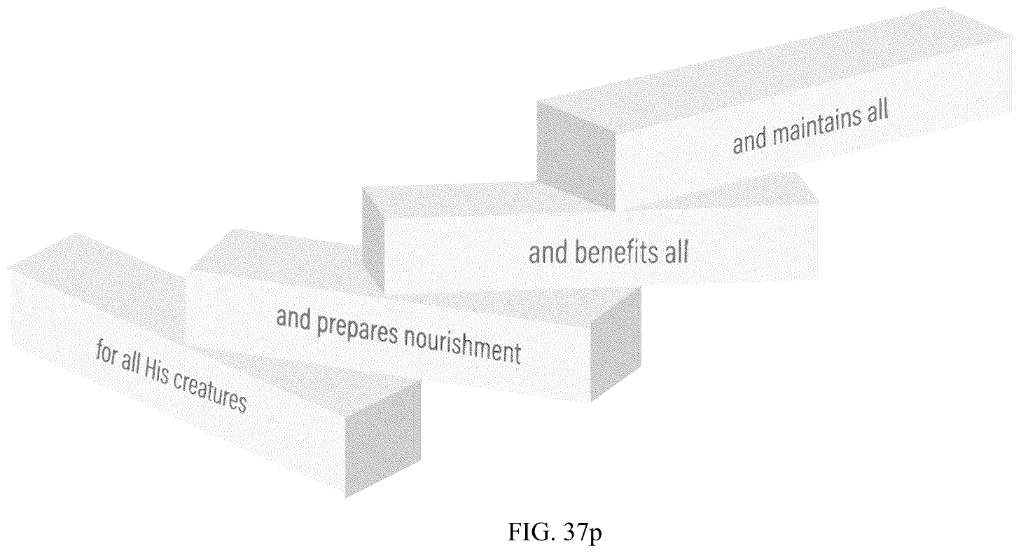

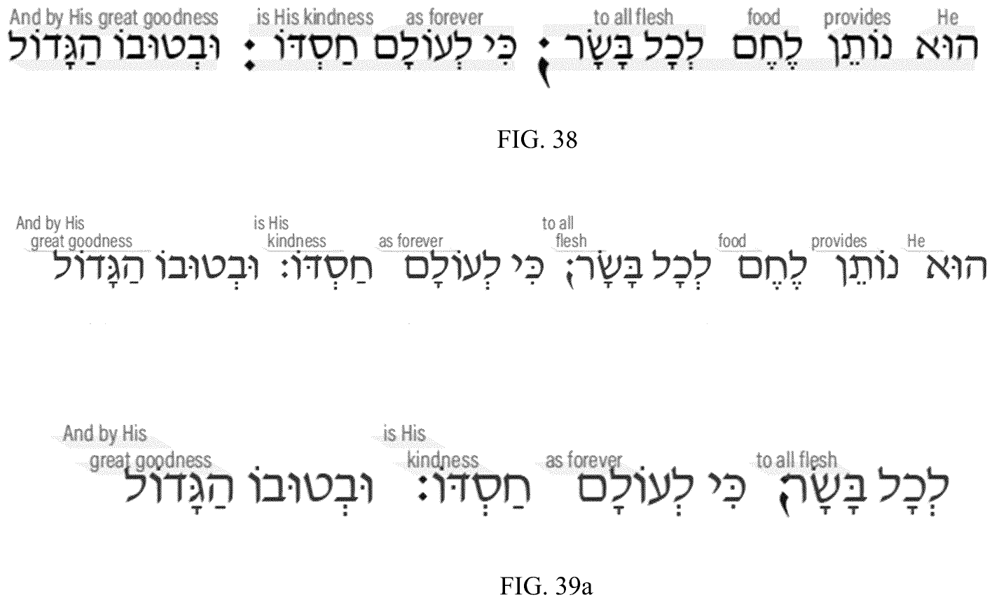

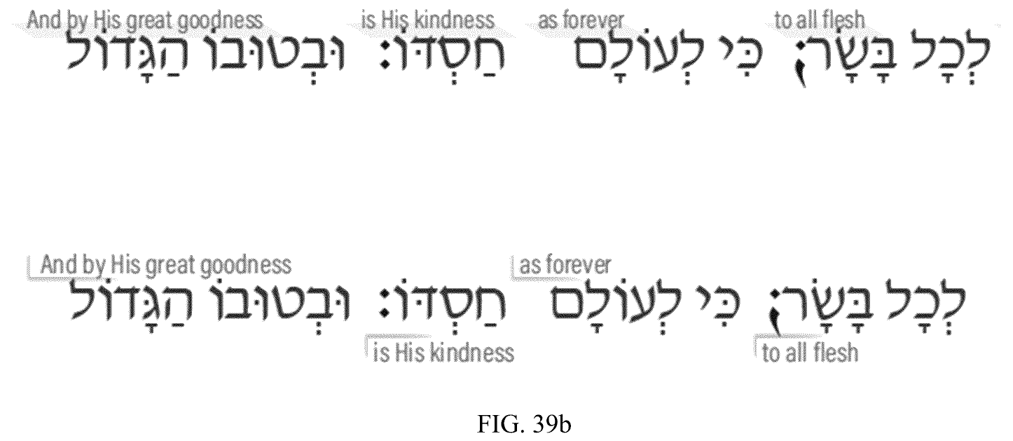

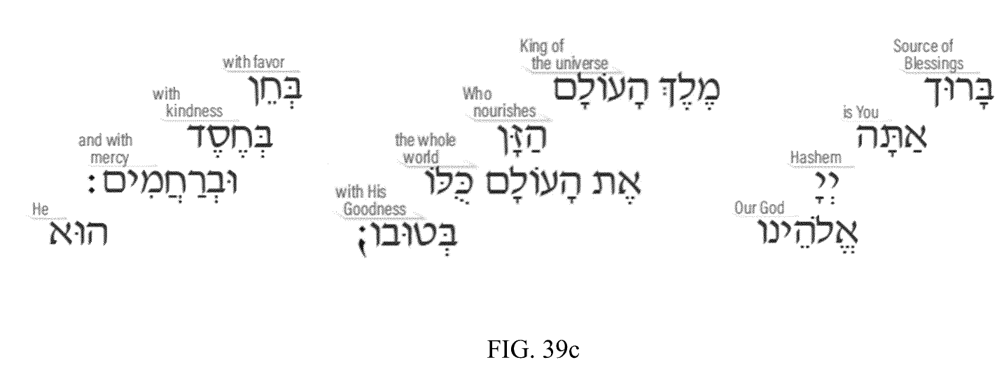

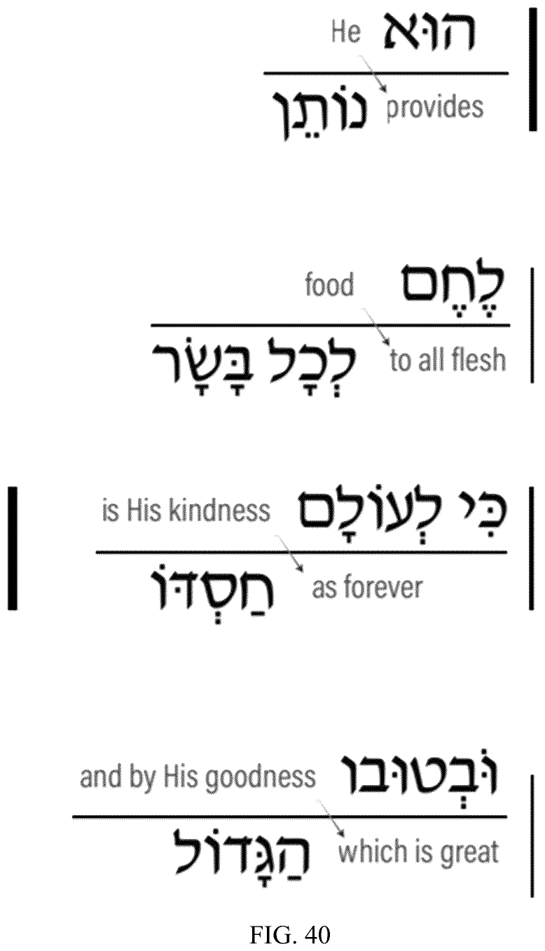

FIGS. 32-40 show further exemplary representations indicating how visual demarcations can be configured between and/or with respect to the pair of substrings in an exemplary and non-limiting aspect of the present invention.

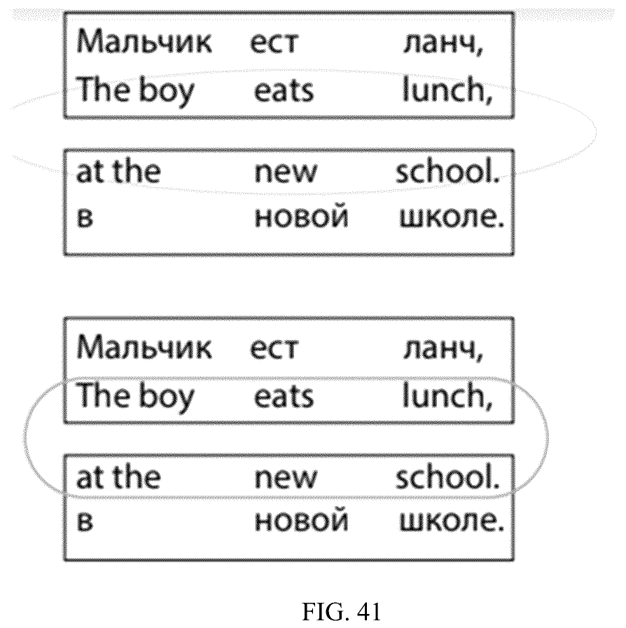

FIG. 41 shows a display scheme having the primary substrings displayed across two vertically adjacent lines. The corresponding secondary substrings are positioned external relative to their corresponding primary substrings. First visual demarcations (e.g., the light grey ovals) surround or interact with the primary substrings, indicating that the primary substrings belong to a single primary string. Second visual demarcations (e.g., the grey rectangles) surround or interact with substring pairs, indicating a correspondence between the secondary substrings and their corresponding primary substrings. This display scheme is advantageous for comparative text displays having a small width (e.g., such as smartphone displays). The primary and secondary text strings can be displayed in two parts where the first and second visual demarcations indicate the required associations and correspondences.

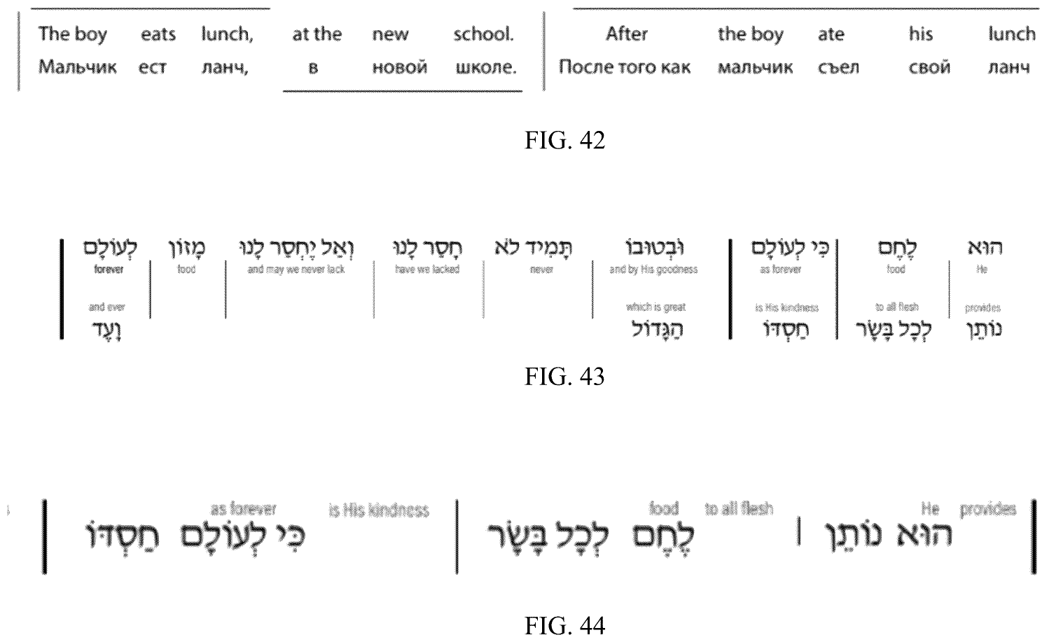

FIG. 42 shows yet another exemplary representation of visual demarcation, wherein the demarcation allows both languages to be read in their correct direction, even though opposite. Hebrew is read right to left and English is read here left to right (assisted by the arrow).

FIG. 43 shows another exemplary representation of visual demarcations wherein the representation forms non-disturbed sentences in vertical format.

FIG. 44 shows another exemplary representation of visual demarcation wherein in each translated short phrase (separated by vertical lines), the English is written normally from left to right and the Hebrew is written normally (right to left). This is why only the first word in each language overlaps as the true translation and the second word of both are left empty, since they go in opposite directions.

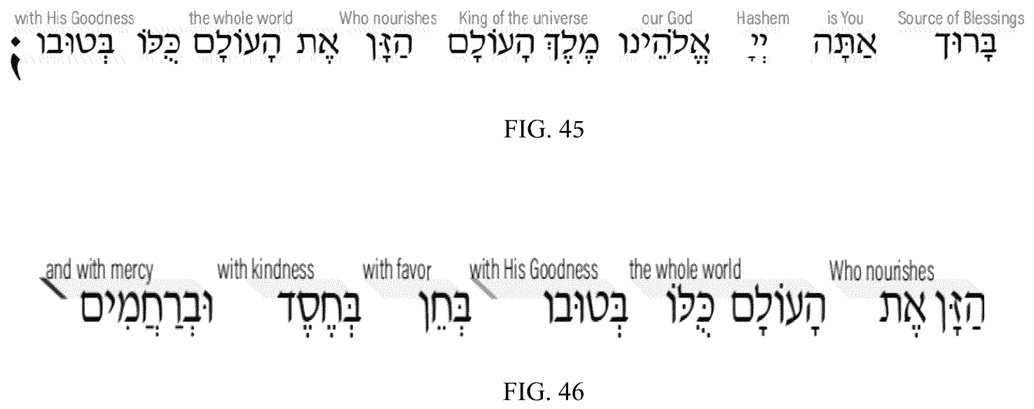

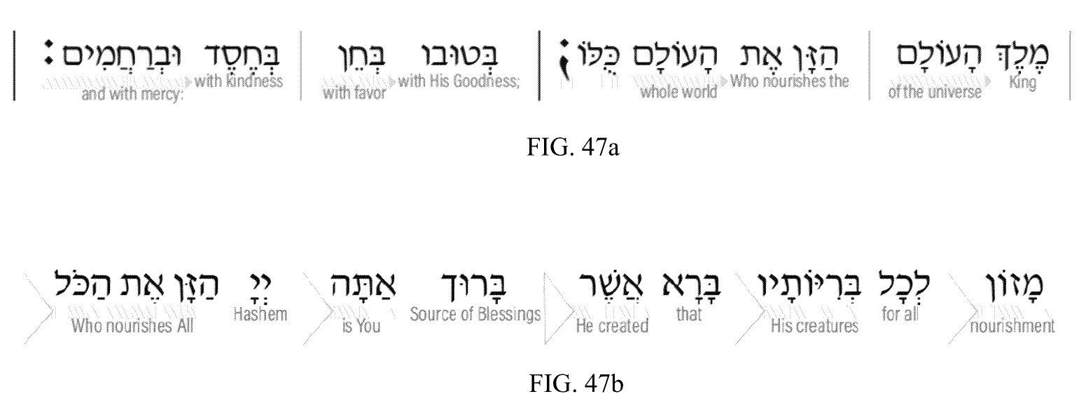

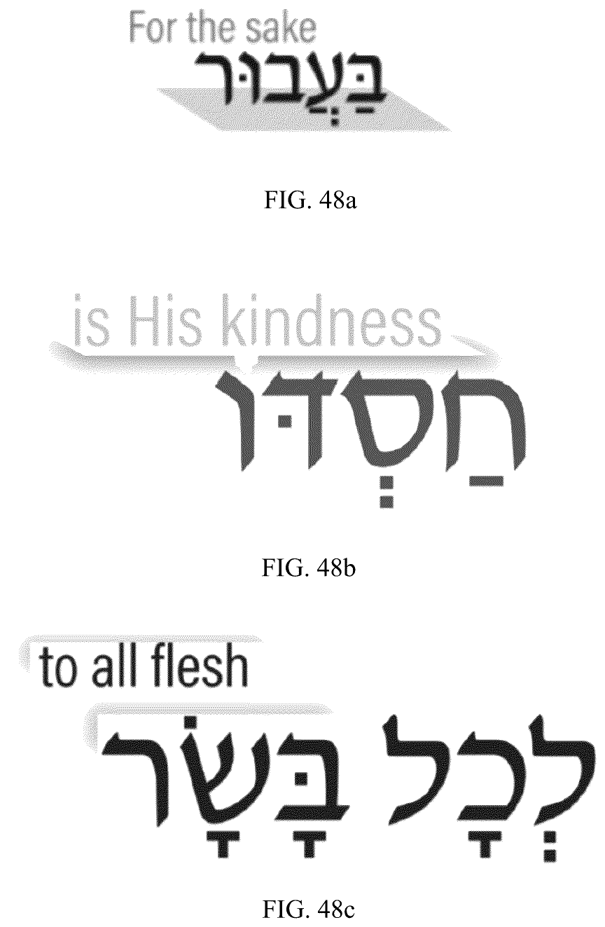

FIGS. 45-48 show further visual demarcations between and/or with respect to the substring pairs in an exemplary and non-limiting aspect of the present invention.

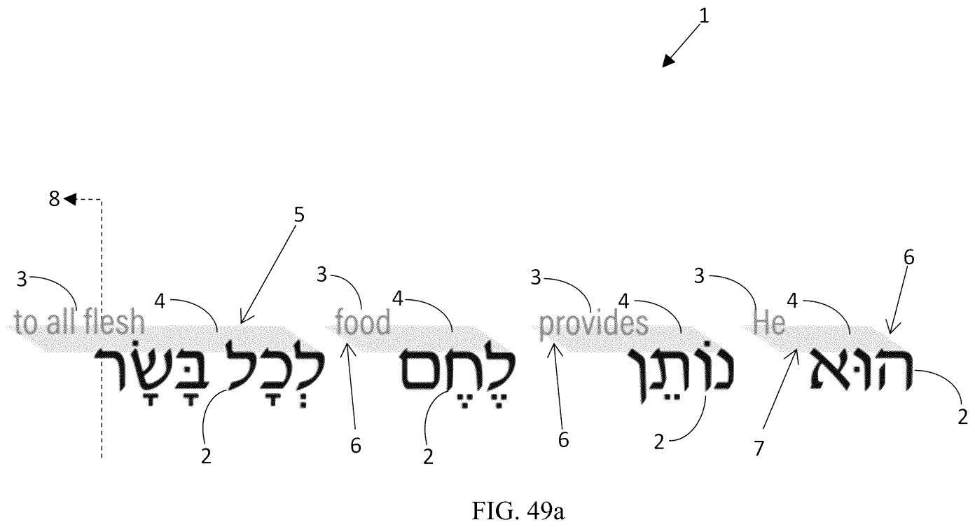

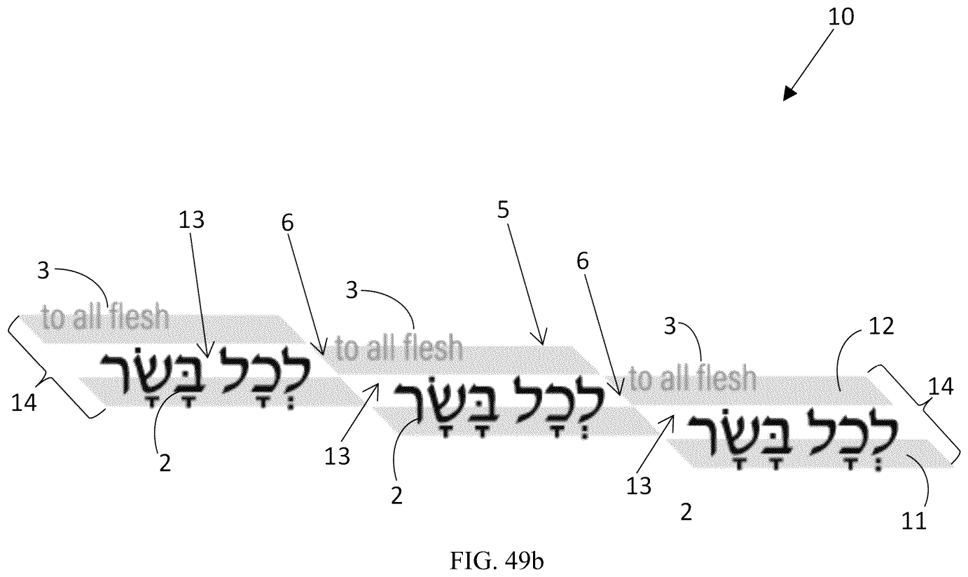

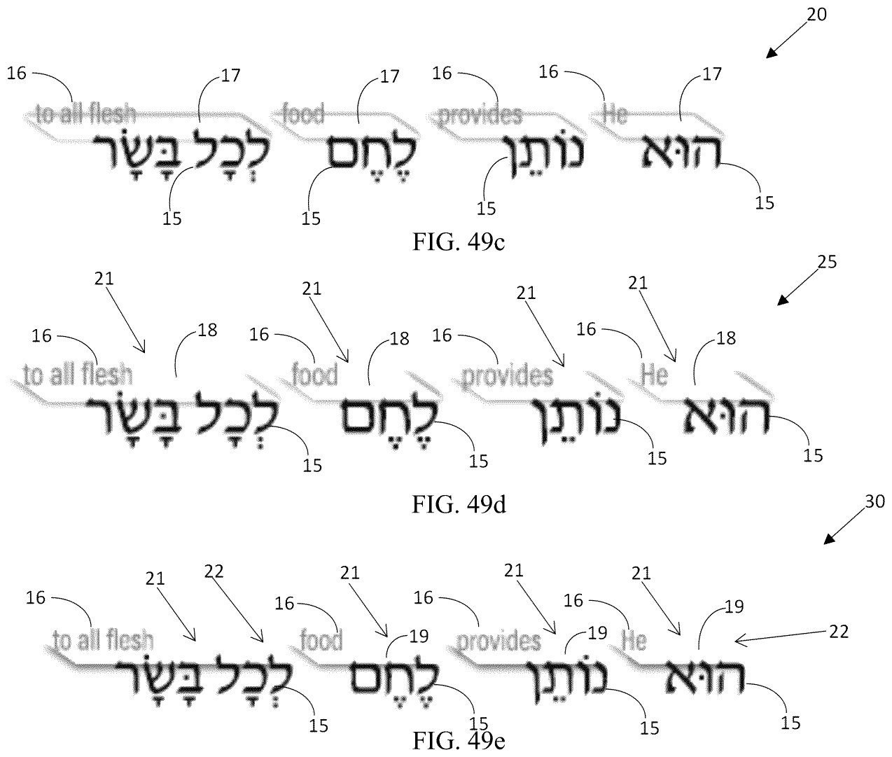

FIG. 49a is a display scheme 1 for a primary text 2 and secondary text 3, according to an embodiment. Diagonal edges 6 and 7 of shaded oblique-parallelogram 4, act as perspective lines that when viewed together with secondary text 3, causes oblique-parallelogram 4 to appear as a shelf in space supporting secondary text 3. The apparent shelf creates a mental demarcation between primary text 2 and secondary text 3 thereby removing visual congestion found in typical linear translations. Secondary text 3 is implemented in a color lighter than the font color of primary text 2 to further reduce reading interference enabling the reader to view the translation text 2 only if he desires. The color and shading of the secondary text 3 and parallelogram 4 are user configurable.

Edge 7 of parallelogram 4 is in abutment with the primary text 2, in a certain embodiment. The abutment advantageously reduces visual clutter by abutting parallelogram 4 with the glyphs of primary text 2.

As shown, secondary text 3 is horizontally offset in the reading direction of primary text 2. The offset advantageously helps delay reading of secondary text 3 until reading of primary text 2 is complete. The reading delay helps minimize mental overload also common in traditional linear translations whose text alignment urges reading of both a foreign text and its translation simultaneously. In a certain embodiment, the extent of secondary text offset is at least one as at least one syllable. The offset is measured from the end of the primary text relative to the reading direction. In a certain embodiment, the extent of horizontal offset is a configurable parameter set by a user. When the display scheme is deployed for languages in which both languages are read in the same direction, from left to right for example, the offset is implemented on the right edge of primary text 2.

In an embodiment, a direction of horizontal offset is consistent between the secondary substring and its corresponding primary substring. For example, each of the secondary substrings are horizontally offset to the right of their corresponding primary substrings or each of the secondary substrings are horizontally offset to the left of their corresponding primary substrings.

FIG. 49b is a display scheme employing a series of staggered, composite oblique-parallelograms 14. Each composite oblique-parallelograms 14 includes a shaded front-parallelogram 11 and a shaded back-parallelogram 12 separated by an intermediary, unshaded parallelogram 13. As shown, primary text 2 is disposed within shaded front-parallelogram 11 and secondary text 3 is disposed in shaded back-parallelogram 12. As noted above, the diagonal edges causes a 3D impression to emerge in which each of the texts appears to sitting on separate shelves in space.

Composite oblique-parallelograms 14 are progressively offset such that a first shaded back-parallelogram 12 is alignment with intermediary, unshaded parallelogram 13 of an adjacent composite oblique-parallelograms 14. The progressive parallelogram offset creates the impression that the that series is either fading into the depth of the page of coming out of the page.

FIGS. 49c-49e are display schemes analogous to that of FIG. 49a except that the oblique-parallelogram is formed from two or more shadow-outlined edges whereas the body of the oblique-parallelogram is white, according to an embodiment. As shown, oblique-parallelogram 17 of FIG. 49c is formed from four shadow-outlined edges. Oblique-parallelogram 18 of FIG. 49d is formed from three shadow-outlined edges where edge 21 is unshaded. Oblique-parallelogram 19 of FIG. 49e is formed from two shadow-outlined edges where edges 21 and 22 are both unshaded. As shown, even two shaded edges are sufficient to create the perspective effect.

FIG. 49c is a display scheme of primary and secondary texts demarcated by an oblique-parallelogram formed by four-edge shadow-outline, according to an embodiment.

FIG. 49d is a display scheme of primary and secondary texts demarcated by an oblique-parallelogram formed by four-edge shadow-outline, according to an embodiment.

FIG. 49e is a display scheme of primary and secondary texts demarcated by an oblique-parallelogram formed by two-edge shadow-outline, according to an embodiment.

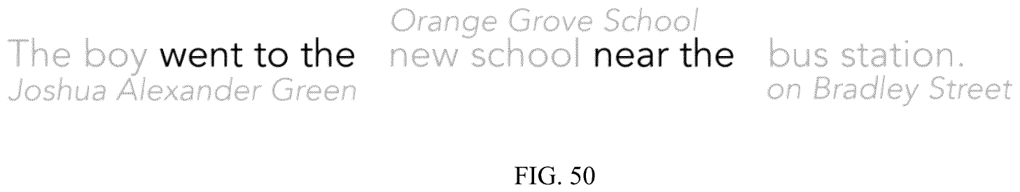

FIG. 50 shows a display scheme having secondary substrings of “Joshua Alexander Green,” “Orange Grove School,” and “on Bradley Street,” alternating above and below their corresponding primary substrings of “The boy went to the,” “new school near the,” and “bus station.” Corresponding words within a substring pair are displayed having similar attributes. For example, “Orange Grove School” and “new school” are both a lighter shade, indicating a correspondence.

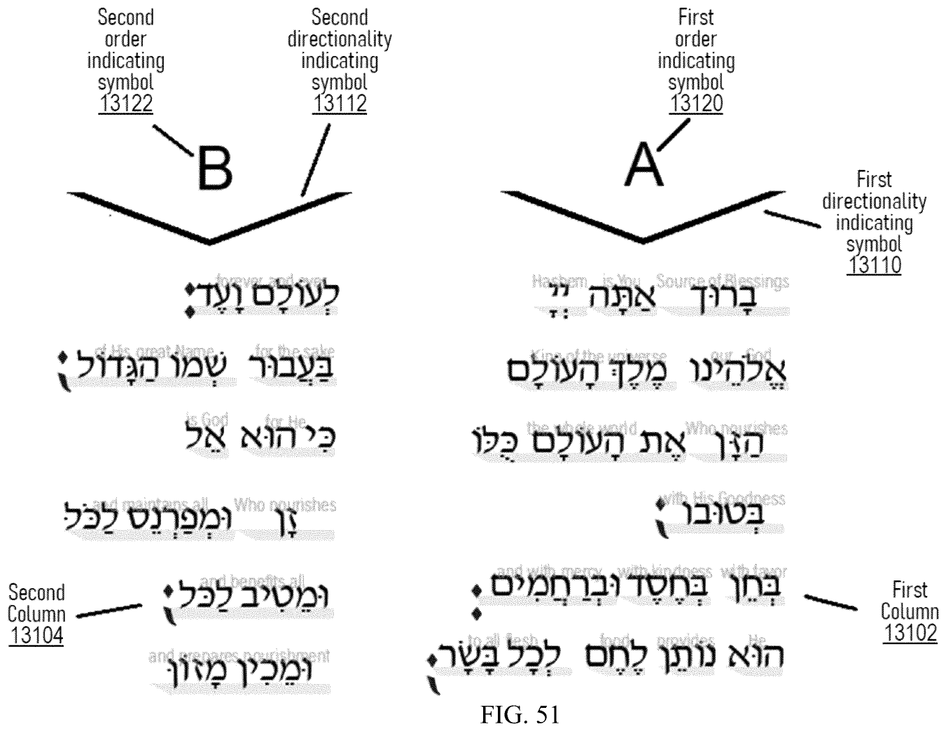

Reference is now made to FIG. 51 in which two columns of vertically adjacent substring pairs are displayed in accordance with a preferred embodiment of the present invention. Shown is a first column 13102 of vertically adjacent substring pairs placed to the right of a second column 13104 of vertically adjacent substring pairs. There is a first directionality indicating symbol 13110, the first arrow, above the first column 13102 and a second directionality indicating symbol 13112, the second arrow, above the second column 13112. There is a first order indicating symbol 13120, the letter “A,” above the first directionality indicating symbol 13110 and a second order indicating symbol 13122, the letter “B,” above the second directionality indicating symbol 13112.

In an alternative display of that depicted in FIG. 51, the directionality indicating symbols may be any shape that indicates to the reader which direction a column of substring pairs should be read in. Each directionality indicating symbol should preferably be placed near the starting point of its corresponding column of text.

In an alternative display of that depicted in FIG. 51, the order indicating symbols may be any set of symbols that progress in a logical order. For example, the number “1” may be used for the first column of text to be read and the number “2” may be used for the second column of text to be read. Each directionality indicating symbol should preferably be placed near a directionality indicating symbol and/or near the starting point of its corresponding column of text.

In an alternative display of that depicted in FIG. 51, the use of directionality indicating symbols and order indicating symbols is applied to rows of horizontally adjacent substring pairs.

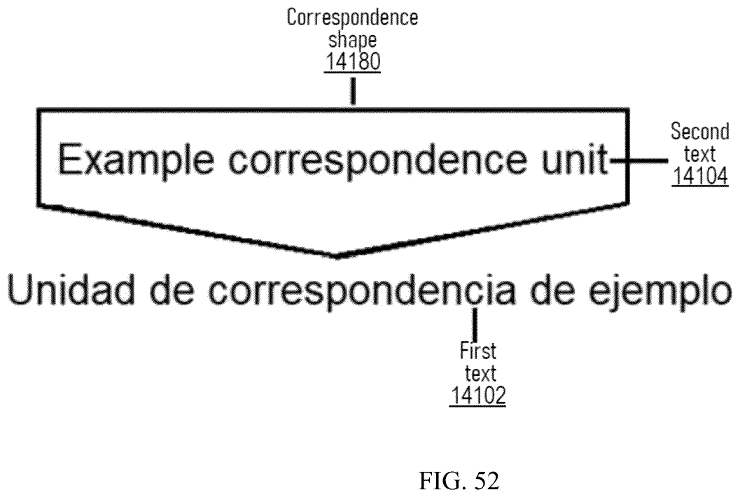

Reference is now made to FIG. 52 in which a first text and a second text are displayed in accordance with another preferred embodiment of the present invention. Shown is a second text 14104, the English native language chunk “Example correspondence unit” inside of a correspondence shape 14180, the shield, which is placed above a first text 14102, the Spanish foreign chunk “Unidad de correspondencia de ejemplo.”

In an alternative embodiment of that depicted in FIG. 52, the correspondence shape may be positioned in between a first text and a second text, where the first text is not inside of the correspondence shape.

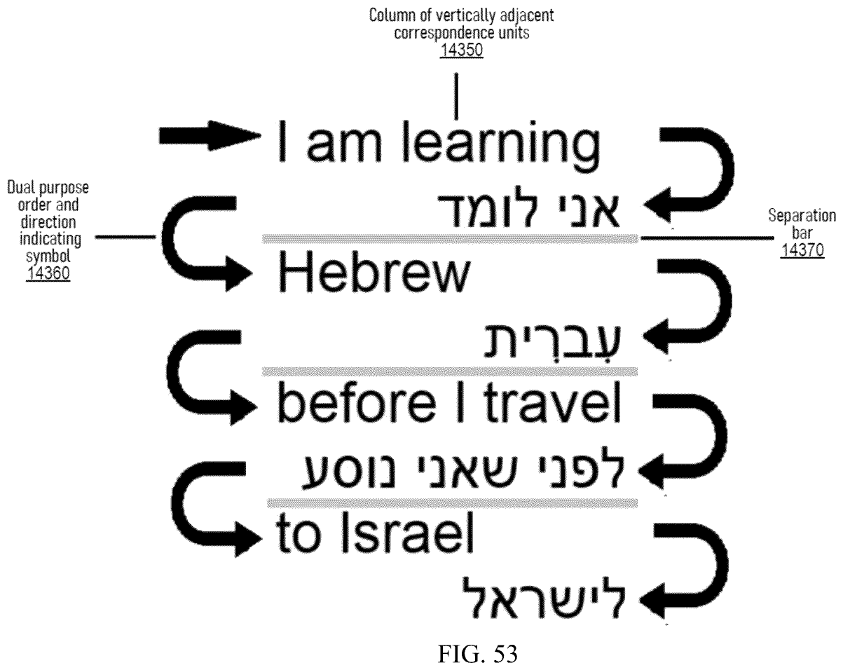

Reference is now made to FIG. 53 in which a column of vertically adjacent correspondence units 14350 is displayed in accordance with another preferred embodiment of the present invention. Each substring pair is comprised of an English native language substring and a Hebrew foreign substring. There are dual purpose order and direction indicating symbols 14360, the arrows, placed around the column. There may also be separation bars 14370 placed in between vertically adjacent correspondence units.

In an alternative embodiment of the arrangement depicted in FIG. 53, the order indicating symbols may be half arrows and any other order indicating shapes.

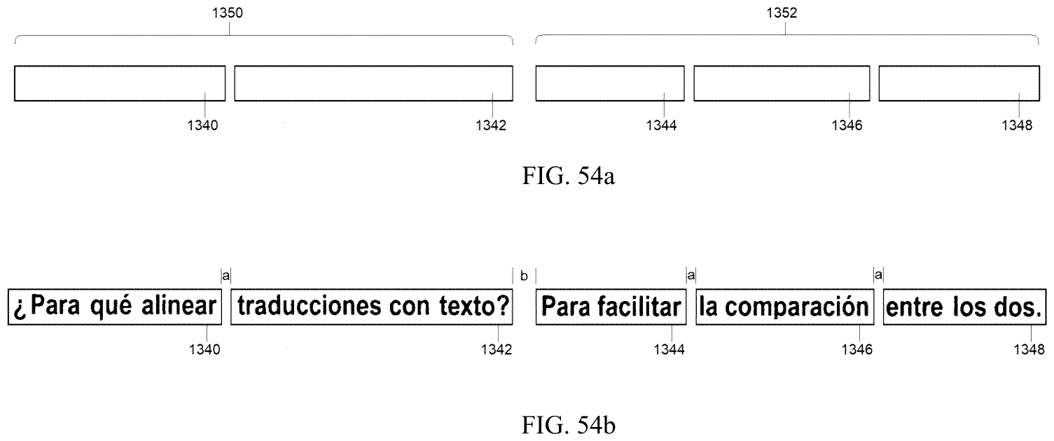

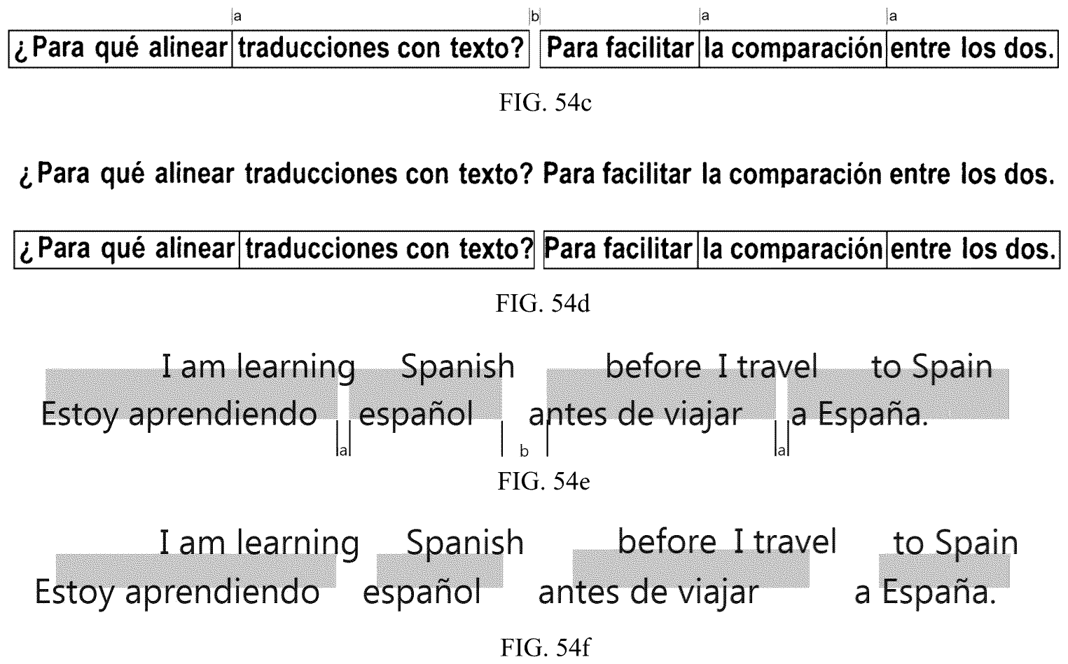

FIG. 54a shows two sets of demarcations in which first set of demarcations 1350 is comprised of the related first 1340 and second 1342 demarcations while the second set of demarcations 1352 is comprised of the related third 1344, fourth 1346, and fifth 1348 demarcations. Related demarcations are discrete such that, when placed proximate to a text string, a reader can differentiate one demarcation from adjacent demarcations of the same set. Here, the demarcations are hollow enclosing structures.

FIG. 54b shows a demarcated Spanish text string, according to an embodiment. The demarcations, due to their discrete nature, define substructures of the text string. Here, the substructures are phrases of “¿Para qué alinear” “traducciones con texto?” “Para facilitar” “la comparación” and “entre los dos.” Related demarcations are spaced equidistant from each other by a first distance ‘a’ and unrelated demarcations (e.g., adjacent demarcations from different sets) are spaced equidistant from each other by a second distance ‘b’, where the first distance is not equal to the second distance. The demarcations, due to differences in spacing between adjacent related demarcations and adjacent unrelated demarcations, define substructures of the text string.

For example, here, there is a consistent spacing of distance ‘a’ in between adjacent related demarcations and a larger consistent spacing of distance ‘b’ in between adjacent unrelated demarcations. The spacing of distance ‘b’ clearly defines the sentences (a type of text string superstructure) of “¿Para qué alinear” “traducciones con texto?” and “Para facilitar” “la comparación” and “entre los dos.” FIG. 54c shows an alternative embodiment of FIG. 54b in which distance ‘a’ is zero.

FIG. 54d shows a Spanish text string (top) and a demarcated Spanish text string (bottom). The Spanish text string has been demarcated according to the demarcation spacing of FIG. 54c but without any changes to the position of the words in the Spanish text string.

Thus, a preferred method of using sets of demarcations to define substructures and superstructures of a text string requires each demarcation to 1) be discrete and 2) have a first consistent spacing in between related demarcations and 3) have a second consistent spacing in between unrelated demarcations.

FIG. 54e shows English substrings of “I am learning”, “Spanish”, “before I travel”, and “to Spain” horizontally offset to the right of their corresponding Spanish substrings of “Estoy aprendiendo”, “español”, “antes de viajar” and “a España”. Each substring pair is demarcated with a light grey rectangle. There is a first spacing ‘a’ in between adjacent demarcations corresponding to the primary substrings belonging to the same structural unit (e.g., Here, the Spanish substrings of “Estoy aprendiendo” and “español” are part of a same structural unit. Their corresponding demarcations are separated by a first spacing ‘a’). There is a second spacing ‘b’ in between adjacent demarcations corresponding to the secondary substring belonging to a different structural unit (e.g., Here, the Spanish substrings of “español” and “antes de viajar” are part of different structural units. Their corresponding demarcations are separated by a second spacing ‘b’). Preferably, ‘b’ is wider than ‘a’. Alternatively, a width of the first spacing ‘a’ is not equal to a width of the second spacing ‘b’. Such a spacing between demarcations defines substructures and superstructures of substring pairs. No matter how far the English is horizontally offset, there is a consistent break between demarcations that reinforces the correspondence between substrings. Furthermore, a small spacing creates an illusion of closeness among adjacent demarcated substring pairs.

FIG. 54f shows English substrings of “I am learning”, “Spanish”, “before I travel”, and “to Spain” horizontally offset to the right of their corresponding Spanish substrings of “Estoy aprendiendo”, “español”, “antes de viajar” and “a España”. Each substring pair is demarcated with a light grey rectangle. The rightmost point of each demarcation is in between rightmost points of the substrings comprising the corresponding substring pair. Likewise, the leftmost point of each demarcation is in between leftmost point of the substrings comprising the corresponding substring pair.

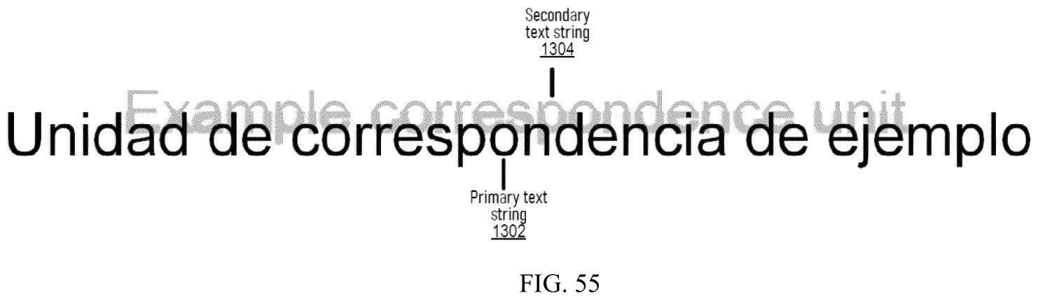

FIG. 55 shows a primary text string 1302 and a corresponding secondary text string 1304. The bottom portion of the secondary text string 1304 is thicker than the top portion of the secondary text string 1304. The increasing thickness in the direction of the primary text string 1302 indicates a correspondence between the primary text string 1302 and the secondary text string 1304.

For embodiments having two or more text strings or two or more substrings, alternating text attributes such as alternating colors, fonts, sizes, or styles may be used for every other text string or substring, serving to further distinguish adjacent text strings or substrings.

For embodiments where a text string interferes with another text string, one or more demarcations can be placed such that the demarcations cover up the interference, either partially or entirely, reducing the interference. The one or more demarcations may be sized to cover only the interference. When placed over the interference, the demarcations may cause the interference to appear deemphasized.

In some embodiments, the primary text string and/or the secondary text string may be italicized, or otherwise manipulated, in such a way that indicates the reading directionality of the text string.

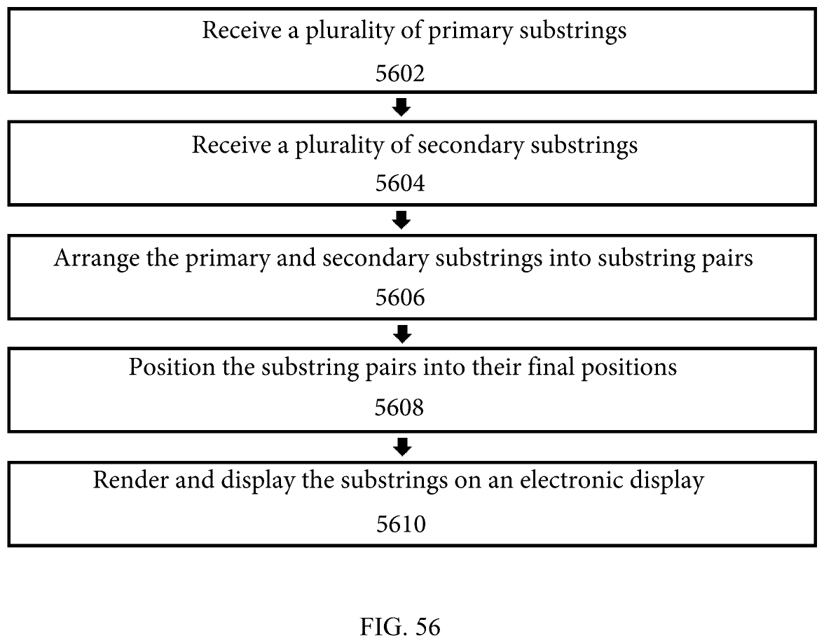

FIG. 56 is a flowchart showing steps of an exemplary method 400 for the display of a primary text string comprised of primary substrings and a secondary text string comprised of secondary substrings. The method may begin at step 5602.

At step 5602, a primary text string composed of primary substrings is received.

According to an embodiment, the primary text string is received when a user inputs the primary text string using an input device. The user may manually indicate the substrings that make up the text string. Alternatively, a native language processing engine can identify substrings within a text string. For instance, exemplary rules can be based on punctuation, where periods indicate the start of a new text string and commas indicate the start of a new substring within that text string.

According to another embodiment, the primary text string is received when the digital character recognition module (314) scans the content of an electronic display to identify a primary text string. The entirety of the content may be scanned. Alternatively, a user may select a portion of the content to be scanned. Data (identity) and metadata (position, typeface, font, etc.) of each character in the primary text string may be saved to primary text string data. Identified substrings may be received as an automatic output from a native language processing service.

According to yet another embodiment, the primary text string is received when the parsing module (316) parses HTML content and associated CSS files. The entirety of the HTML content and associated CSS files may be parsed. Alternatively, a user may select a portion of the HTML content and associated CSS files to be parsed. The parsing module parses the tags of the HTML content to identify characters in a primary text string as well as associated Cascading Style Sheet (CSS) files to identify associated character metadata. Data (identity) and metadata (position, typeface, font, size, etc) of each character in the primary text string may be saved to primary text string data. A native language processing engine can identify substrings within a string.

In an embodiment, each of the primary substrings preferably contains six or fewer words, more preferably five or fewer words, even more preferably four or fewer words, and most preferably three or fewer words.

In an embodiment, most of the primary substrings preferably contains six or fewer words, more preferably five or fewer words, even more preferably four or fewer words, and most preferably three or fewer words.

At step 5604, a secondary text string composed of secondary substrings is received. Each of the secondary substrings may uniquely correspond to one of the primary substrings. For example, each of the secondary substrings may be a translation of its corresponding primary substring. In an aspect, the secondary text string may either be machine-generated directly based on the primary text string or can be generated manually or through manual intervention. As mentioned above, the primary and secondary text strings need not necessarily be translations of each other, but can be associated in any other way, for instance the primary text string can be “One Two Three” and the secondary text string can be “1 2 3”. Alternatively, the primary and secondary text strings can both the graphical symbols/representations or can be any combination of the above.

According to an embodiment, the secondary text string is received when a user inputs the secondary string using an input device. The user may manually indicate the substrings that make up the text string. Alternatively, a native language processing engine can identify substrings within a string. For instance, exemplary rules can be based on punctuation, where periods indicate the start of a new text string and commas indicate the start of a new substring within that text string.

According to another embodiment, the secondary text string is received when the digital character recognition module (314) scans the content of an electronic display to identify a secondary text string. The entirety of the content may be scanned. Alternatively, a user may select a portion of the content to be scanned. Data (identity) and metadata (position, typeface, font, etc.) of each character in the secondary text string may be saved to secondary text string data. Identified substrings may be received as an automatic output from a native language processing service.

According to yet another embodiment, the secondary text string is received when the parsing module (316) parses HTML content and associated CSS files. The entirety of the HTML content and associated CSS files may be parsed. Alternatively, a user may select a portion of the HTML content and associated CSS files to be parsed. The parsing module parses the tags of the HTML content to identify characters in a secondary text string as well as associated Cascading Style Sheet (CSS) files to identify associated character metadata. Metadata (identity, position, typeface, font, size, etc) of each character in the secondary text string may be saved to secondary text string data. Identified substrings may be received as an automatic output from a native language processing service.

Alternatively, a native language processing service (e.g., a native language processing engine) can automatically output identified substrings within a text string. For instance, exemplary rules can be based on, for example, grammar (e.g., a sentence must start with an uppercase character (e.g. Noun, I, We, He, etc.), followed by lowercase characters), (there must be spaces between words and the sentence must end with a period), or (after a word, two continuous spaces are not allowed, and two continuous upper case characters are not allowed).

Alternatively, text strings can be divided into an array of substrings, and a computed implemented function can return a temporary array of the substrings. The function can be used in calculation statements wherever an array can be used, wherein a first operand can be the string to be split which can be alphanumeric, graphic, or UCS-2. The second operand can be the list of characters that indicate the end of each substring, can have same type and CCSID as the first operand. If it is not specified, the function can default to splitting at blanks. If the length of the second operand is greater than 1, any of the characters in the second operand indicate the end of each substring.

Another exemplary implementation to automatically find/form substrings from a text string can be based on rules associated with parts of speech including nouns, pronouns, verbs, adjectives, adverbs, prepositions, conjunctions, and interjections. Breaking a sentence down into its parts of speech requires knowledge of the word's meaning and how it relates to other words in the sentence. In an implementation, the substring formation can be based on identification of verbs, followed by identification of adverbs, followed by nouns, pronouns, and adjectives, followed by propositions and conjunctions and interjections, and then logically groping them together in parts based on defined set of rules.

In an embodiment, each of the secondary substrings preferably contains six or fewer words, more preferably five or fewer words, even more preferably four or fewer words, and most preferably three or fewer words.

In an embodiment, most of the secondary substrings preferably contains six or fewer words, more preferably five or fewer words, even more preferably four or fewer words, and most preferably three or fewer words.

According to an embodiment, secondary substrings are received when they are identified having a correspondence to the primary substrings. For example, the system parses through a substring database and identifies a first secondary substring corresponding to the first primary substring, a second secondary substring corresponding to the second primary substring, and a third secondary substring corresponding to the third primary substring.

At step 5606, the placement module 320 arranges the primary substrings and the secondary substrings into substring pairs.

According to an embodiment, the placement module 320 places each of the secondary substrings adjacent to its corresponding primary substring, creating substring pairs such that each of the secondary substrings is horizontally offset from its corresponding primary substring.

In a preferred embodiment, each of the secondary substrings are vertically indented from their corresponding primary substrings. Alternatively, each of the secondary substrings are vertically offset from their corresponding primary substrings.

In an embodiment, the secondary substrings are vertically offset above or below their corresponding primary substring.

In an embodiment, the secondary substrings are vertically offset no more than half a line away from their corresponding primary substring, where one line is the distance between the baseline of a primary substring in a first line and the baseline of another primary substring in a second line.

In an embodiment, the secondary substrings are vertically offset no more than one line away from their corresponding primary substring, where one line is the distance between the baseline of a primary substring in a first line and the baseline of another primary substring in a second line.

In an embodiment, the secondary substrings are vertically offset no more than two lines away from their corresponding primary substring, where two lines is the distance between the baseline of a primary substring in a first line and the baseline of another primary substring in a third line.

In an embodiment, each of the secondary substrings is horizontally offset from its corresponding primary substring by at least the first two characters of the corresponding primary substring.

In an embodiment, each of the secondary substrings is horizontally offset from its corresponding primary substring by at least two average character widths of the characters comprising the corresponding primary substring.

In an embodiment, each of the secondary substrings is horizontally offset from its corresponding primary substring by at least the first syllable of the corresponding primary substring.

In an embodiment, the top substring in each substring pair is in English. Alternatively, the bottom substring in each substring pair is in English. Yet alternatively, the top substring in each substring pair is not in English. Yet alternatively, the bottom substring in each substring pair is in Hebrew.

At step 5608, the placement module 320 positions the substring pairs into their final positions.

According to an embodiment, the placement module 320 places each of the primary and secondary substring pairs such that, when each of the secondary substrings is not vertically indented from its corresponding primary substring, a given primary substring, less the first primary substring, is horizontally indented from an immediately previous primary substring or a given secondary substring, less the first secondary substring, is horizontally indented from an immediately previous secondary substring.

Alternatively, the placement module 320 places each of the primary and secondary substring pairs such that, when each of the secondary substrings is not vertically indented from its corresponding primary substring, a given primary substring, less the first primary substring, is horizontally offset from an immediately previous primary substring or a given secondary substring, less the first secondary substring, is horizontally offset from an immediately previous secondary substring.

Alternatively, the placement module 320 places each of the primary and secondary substring pairs such that, when each of the secondary substrings is not vertically offset from its corresponding primary substring, a given primary substring, less the first primary substring, is horizontally indented from an immediately previous primary substring or a given secondary substring, less the first secondary substring, is horizontally indented from an immediately previous secondary substring.

Alternatively, the placement module 320 places each of the primary and secondary substring pairs such that, when each of the secondary substrings is not vertically offset from its corresponding primary substring, a given primary substring, less the first primary substring, is horizontally offset from an immediately previous primary substring or a given secondary substring, less the first secondary substring, is horizontally offset from an immediately previous secondary substring.

Alternatively, the placement module places each of the primary and secondary substrings according to a preferred or predetermined “layout” or “formatting.” For example, the primary and secondary substrings are arranged according to a preferred alignment, spacing, line spacing, and overall text structure within a document or display screen. Layout helps in organizing the text to make it more readable and visually appealing.

In an embodiment, there are at least five substring pairs and each of the substring pairs are arranged vertically.

In an embodiment, there are at least five substring pairs and each of the substring pairs, less the first substring pair, are vertically indented from the immediately previous substring pair.

In an embodiment, there are at least five substring pairs and each of the substring pairs, less the first substring pair, are vertically offset from the immediately previous substring pair.

At step 5610, the substring pairs are rendered, by the renderer 324, and displayed on an electronic display.

In a preferred embodiment, the system is further configured to monitor for update conditions where the electronic display is updated in real time when an update condition is met. Update conditions can be monitored by polling: The system periodically checks the state of relevant variables, sensors, or data sources to see if a condition has been met. Although simple, this method can be inefficient as it may consume resources by checking repeatedly; Event-driven Programming: In this approach, an event loop waits for events or triggers from user input, sensors, timers, or other sources. When an event that requires an update is detected, the display can be refreshed. This is often used in graphical user interfaces (GUIs) and embedded systems; Interrupts: An interrupt-driven system can update the display based on external or internal signals that are handled by interrupt service routines (ISRs). For instance, an external sensor might send a signal when a certain threshold is reached, prompting an immediate display update; Observer Pattern (Software Design Pattern): In this pattern, the display is an observer that listens for changes in the subject. When the subject's state changes (e.g., data values), it notifies all observers to update accordingly; Timers: Scheduled tasks can be executed periodically using timers, which may prompt the display to update regularly even if no other events are detected; State Change Detection: Some systems keep track of previous states and only update the display when a significant change is detected; or any combination thereof.

Update conditions include, but are not limited to, a change in the appearance of one of the primary substrings (e.g., someone changed a color of one of the primary substrings), a change in the appearance of one of the secondary substrings (e.g., someone changed a font of one of the secondary substrings), a change in the placement of one of the primary substrings (e.g., someone spaces apart the primary substrings), and a change in the placement of one of the secondary substrings (e.g., someone moves the first secondary substrings down by an inch). Update conditions can further include any conditions that would require the electronic display to be updated in order to reflect a new desired appearance.

Alternatively, the electronic display is updated when an update condition is met and the user has approved the update. For example, a user increases the font size of the primary substrings (e.g., selects a larger size for the first primary substring). The computing device prompts the user if he wants the electronic display to be updated to reflect the increased font size (e.g., a new window opens asking the user if he or she wants to continue). The user responds affirmatively and the electronic display is updated (e.g., the user clicks continue on the new window).

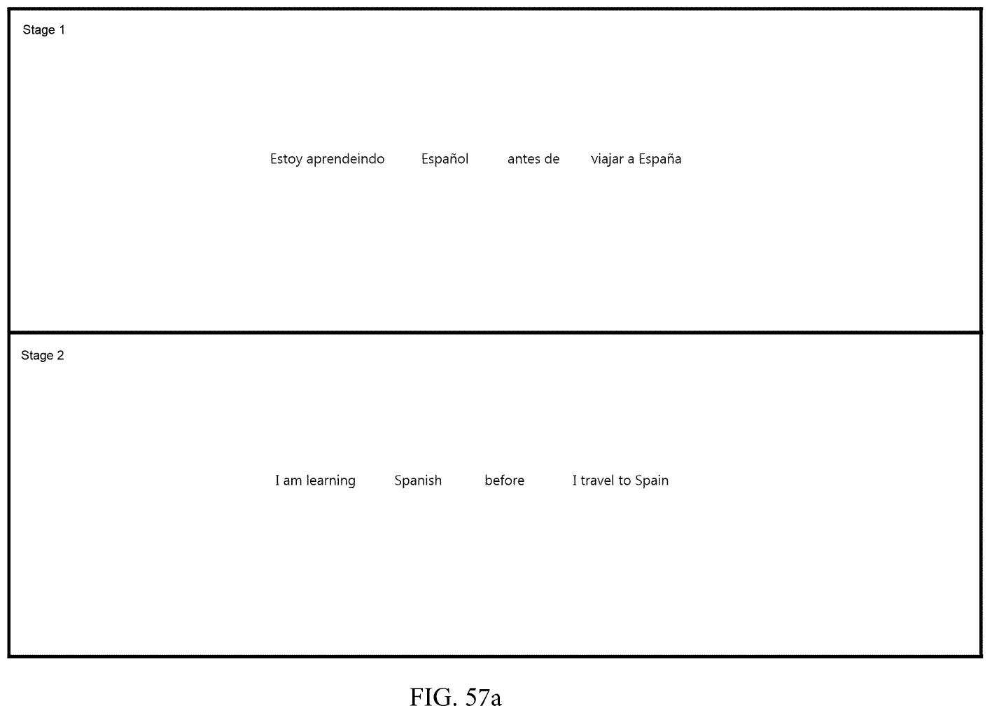

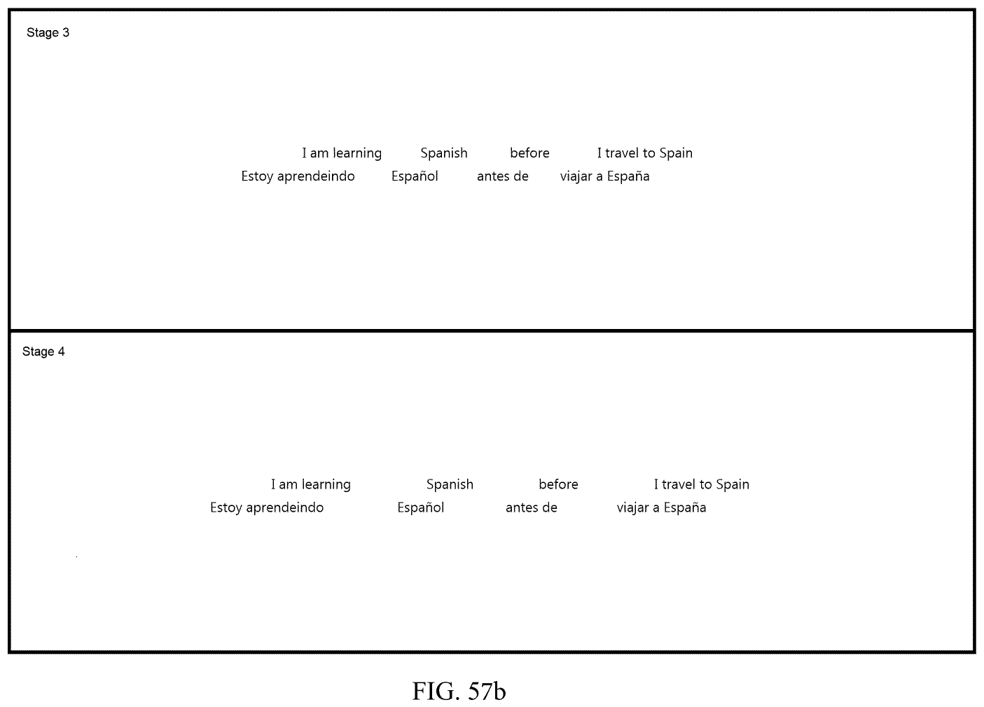

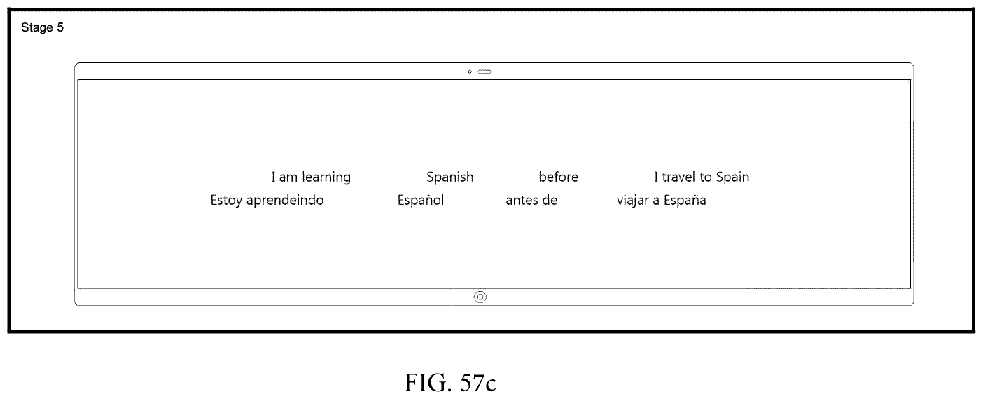

FIGS. 57a-57e show the steps of the method of FIG. 56, as applied to a computing device, according to an embodiment.

In Stage 1, Spanish primary substrings of “Estoy aprendeindo”, “Español”, “antes de”, and “viajar a España” are received from user keyboard inputs.

In Stage 2, English secondary substrings of “I am learning”, “Spanish”, “before”, and “I travel to Spain” are received when the translation module generates them as a direct translation of the Spanish primary substrings.

In Stage 3, the Spanish primary substrings and the English secondary substrings are arranged into substring pairs. Here, the English secondary substrings are vertically offset above their corresponding Spanish secondary and horizontally offset to the right of their corresponding Spanish secondary substrings.

In stage 4, the substring pairs are positioned into their final positions. Here, a spacing in between the substring pairs is increased.

In stage 5, the substring pairs are rendered and displayed. Here, the substrings pairs are displayed on the electronic display of a tablet.

The system embodies a significant advance over existing systems that cannot display two text strings in a manner that delineates adjacent substring pairs. Additional desired visual effects may be achieved through the use of specific demarcations, demarcation placements, and substring modifications, as described below.

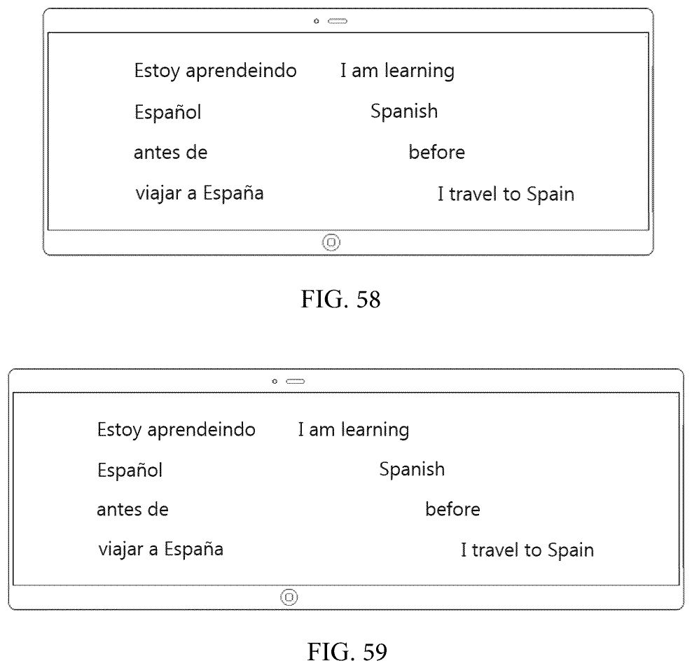

FIG. 58 shows an alternative electronic display. Here, the English secondary substrings are directly to the right of their corresponding Spanish primary substrings. The Spanish primary substrings are vertically stacked and each of the English primary substrings, less the first English primary substring, is indented to the right of the previous English primary substring.

FIG. 59 shows an alternative electronic display. Here, the English secondary substrings are directly to the right of their corresponding Spanish primary substrings. The Spanish primary substrings are vertically stacked and each of the English primary substrings, less the first English primary substring, is horizontally offset to the right of the previous English primary substring.

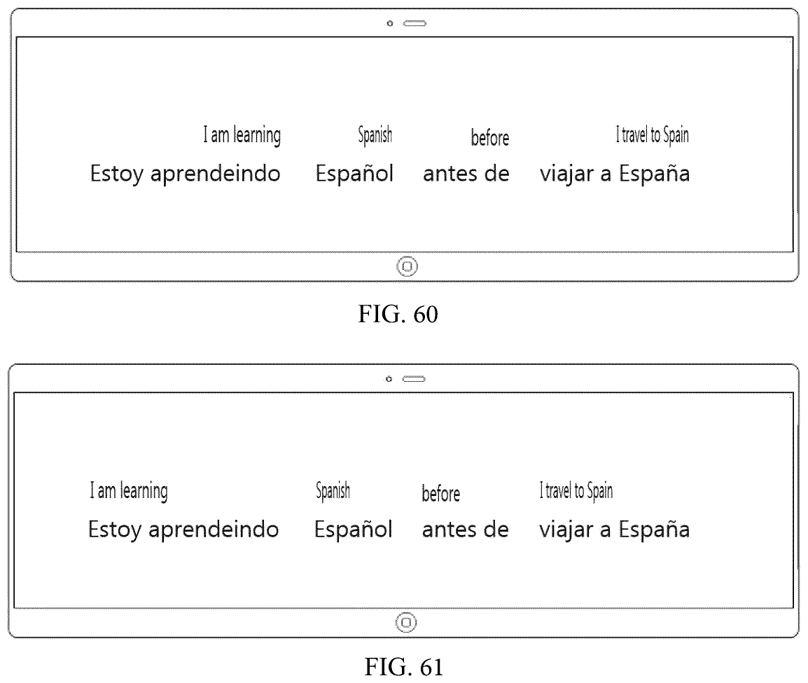

FIG. 60 shows an alternative electronic display. Here, the English secondary substrings are placed above their corresponding Spanish primary substrings such that a rightmost point of each of the English secondary substrings is at or to the left of the rightmost point of its corresponding Spanish primary substring and a leftmost point of each of the English secondary substrings is at or to the right of the center point of its corresponding Spanish primary substring.

FIG. 61 shows an alternative electronic display. Here, the English secondary substrings are placed above their corresponding Spanish primary substrings such that a leftmost point of each of the English secondary substrings is at or to the right of the leftmost point of its corresponding Spanish primary substring and a rightmost point of each of the secondary English substrings is at or to the left of the center point of its corresponding Spanish primary substring. Alternatively, the English secondary substrings are placed above their corresponding Spanish primary substrings such that the majority of the width a given secondary substring horizontally overlaps a left half of its corresponding primary substring. Alternatively, the English secondary substrings are placed above their corresponding Spanish primary substrings such that at least two thirds of the width a given secondary substring horizontally overlaps a left half of its corresponding primary substring. Alternatively, when the reading direction of the primary text string is right to left, the secondary substring can be placed above their corresponding primary substrings such that the majority of the width a given secondary substring horizontally overlaps a right half of its corresponding primary substring. Alternatively, when the reading direction of the primary text string is right to left, the secondary substring can be placed above their corresponding primary substrings such that at least two thirds of the width a given secondary substring horizontally overlaps a right half of its corresponding primary substring.

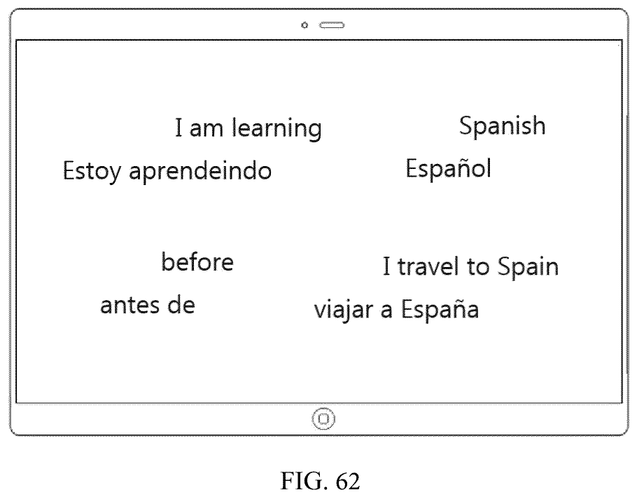

FIG. 62 shows an alternative electronic display. Here, there are at least four substring pairs, where the first two substrings are displayed on the first line and the next two substrings are displayed on the second line. Alternatively, there can be at least nine substring pairs, where at least three substrings are displayed on a first line, at least three substring pairs are displayed on a second line, and at least three substring pairs are displayed on a third line.

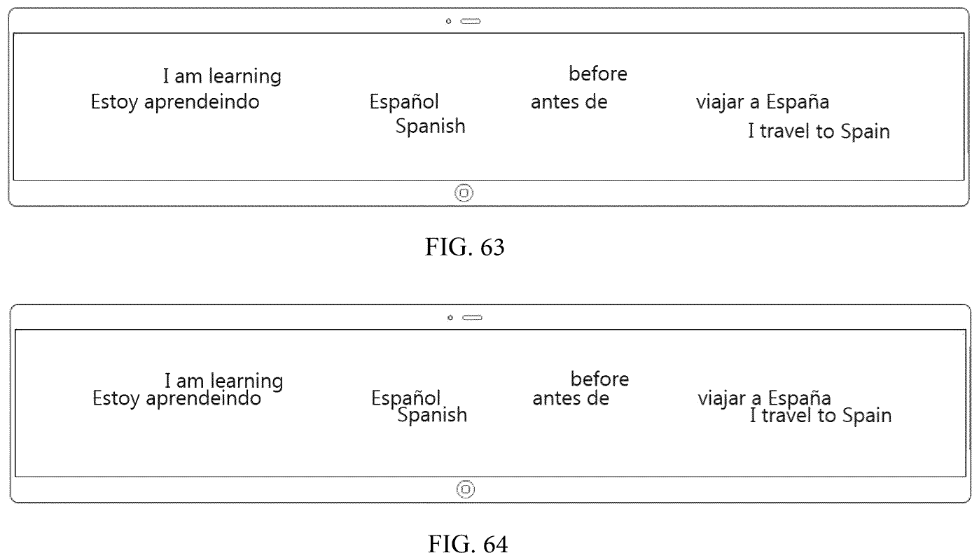

FIG. 63 shows an alternative electronic display. Here, the position of the English secondary substrings alternate from above to below their corresponding Spanish primary substrings from substring pair to substring pair.

FIG. 64 shows an alternative electronic display. Here, for English secondary substrings positioned above their corresponding Spanish primary substring, a descender line of the English secondary substring is below the ascender line of its corresponding Spanish primary substring and for English secondary substrings positioned below their corresponding Spanish primary substrings, an ascender line of the English secondary substring is above the descender line of the corresponding Spanish primary substring.

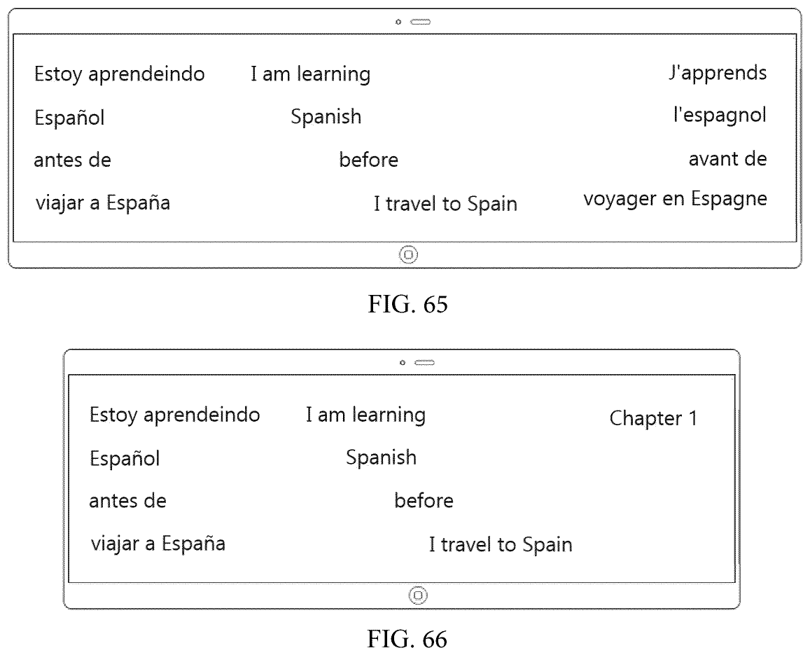

According to an embodiment, when substring pairs are displayed on the electronic display, other text related to the substring pairs is not displayed on the electronic display. For example, in the display of FIG. 65, a French translation of the English/Spanish substring pairs is displayed next to the English/Spanish substring pairs, distracting the reader by diverting their focus.

According to an embodiment, when a given line on the electronic display contains at least one of the primary or secondary substrings, the given line does not contain textual content that is not part of the primary or secondary text string. For example, in FIG. 66, the first line contains the Spanish primary substring “Estoy aprendeindo”, the English secondary substring “I am learning”, and the text “Chapter 1”. The text “Chapter 1” distracts the reader from the primary or secondary substrings in the same line.

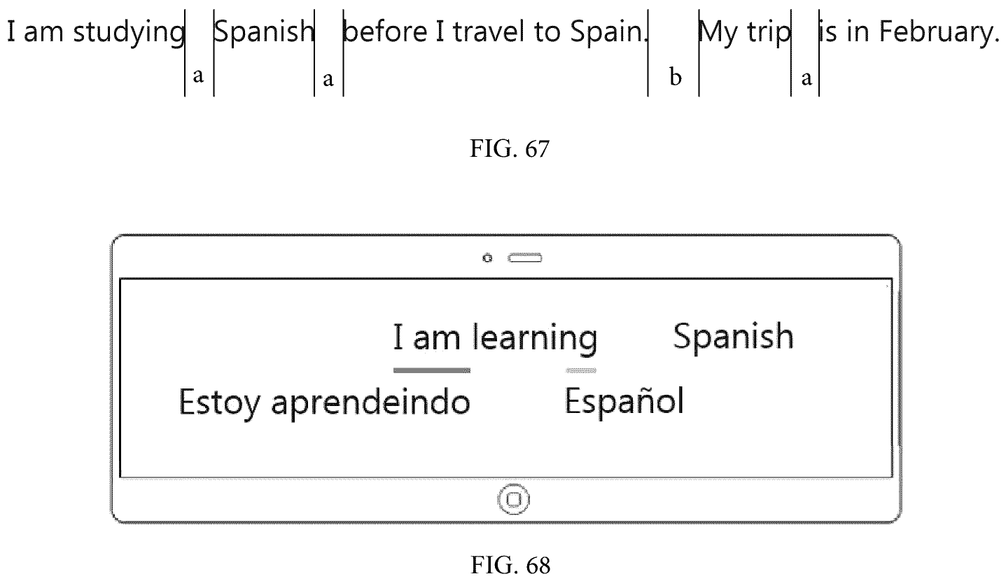

FIG. 67 shows a text string of “I am studying Spanish before I travel to Spain. My trip is in February.” divided into substrings of “I am studying”, “Spanish”, “before I travel to Spain.”, “My trip”, and “is in February.” The superstructures of the text string are the sentences of “I am studying Spanish before I travel to Spain.” and “My trip is in February.” The substructures of the text string are the phrases of “I am studying”, “Spanish”, “before I travel to Spain.”, “My trip”, and “is in February.” Here, there is a consistent spacing having a width ‘a’ in between adjacent substrings belonging to the same superstructure and a consistent spacing having a width ‘b’ in between adjacent substrings belonging to different superstructures. Preferably the spacing in between adjacent substrings belonging to different superstructures is greater than a spacing in between adjacent substrings belonging to the same superstructures such that spacing having a width ‘b’ clearly defines the start of a new superstructures (sentence) while spacing having a width ‘a’ clearly defines the start of a new substructure (phrase) within the same superstructure (sentence). The width of a spacing can be measured as the horizontal distance between the rightmost point of an immediately left substring and the leftmost point of an immediately right substring.

In another embodiment, the width of ‘a’ and ‘b’ are two different greater than zero values. Alternatively, the width of ‘a’ is zero while the width of ‘b’ is greater than zero.

In another embodiment, the width of ‘a’ is equal to the width of ‘b’. Instead, a visual demarcation placed in between adjacent substrings belonging to different superstructures defines the start of a new substructure. Said spacing can be used with any of the display schemes in this disclosure (e.g., between primary substrings, between secondary substrings, between substring pairs).

FIG. 68 shows an alternative electronic display. Here, one of the English secondary substrings (“I am learning”) horizontally overlaps its corresponding Spanish primary substring (“Estoy aprendiendo”) and the Spanish primary substring of an adjacent substring pair (“Espanol”) such that the width of the horizontal overlap between “I am learning” and “Estoy aprendiendo”, demarcated with a dark grey line, is greater than the width of the horizontal overlap between “I am learning” and “Espanol”, demarcated with a light grey line. As there is more horizontal overlap between “I am learning” and “Estoy aprendiendo” than between “I am learning” and “Espanol”, the reader can identify that the secondary substring “I am learning” corresponds to the primary substring “Estoy aprendiendo” instead of to the primary substring “Espanol”. This display scheme advantageously allows substring pairs to be displayed closer together without confusing the reader.

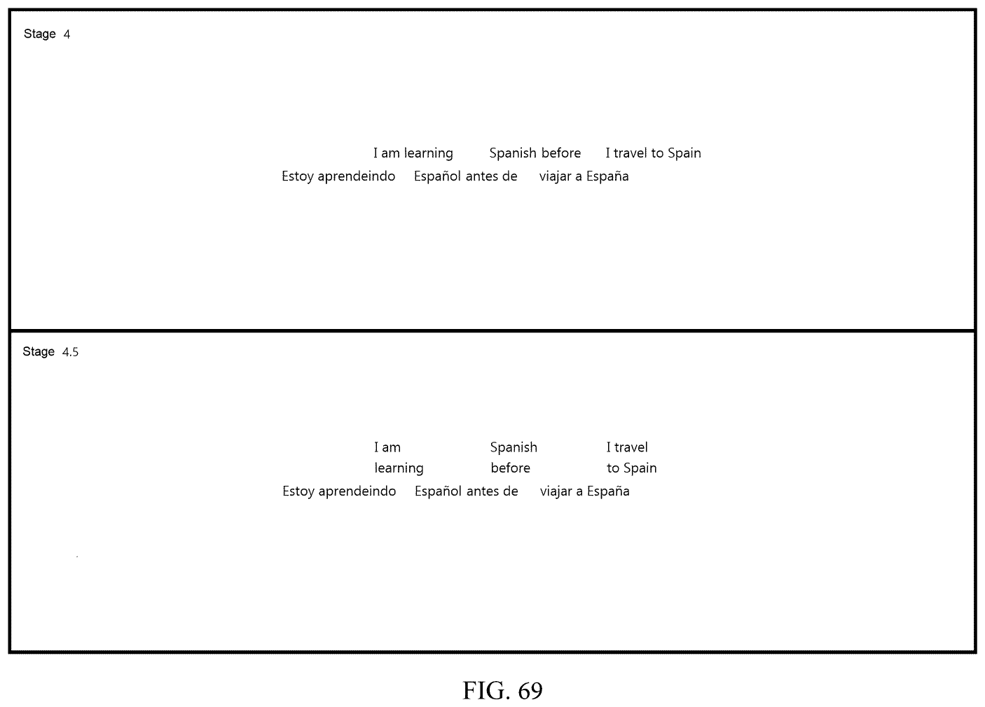

FIG. 69 shows an optional step in the method of FIG. 56. After the placement module 320 places the substring pairs into their final positions, the calculation module determines the width of any horizontal overlap between each of the secondary substrings and any adjacent primary substrings. When a given secondary substring is positioned such that the horizontal overlap between the given secondary substring and its corresponding primary substring is greater than a the horizontal overlap between the given secondary substring and an adjacent primary substring belonging to an adjacent substring pair, the system divides the given secondary substring among two lines. For example, in stage 4, the horizontal overlap between the secondary substring “I am learning” and the primary substring “Espanol antes de” is greater than the horizontal overlap between the secondary substring “I am learning” and its corresponding primary substring of “Estoy aprendeindo”. Likewise, the horizontal overlap between the secondary substring “Spanish before” and the primary substring “viajar a Espana” is greater than the horizontal overlap between the secondary substring “Spanish before” and its corresponding primary substring of “Espanol antes de”. As shown in stage 4.5, the system automatically divides “I am learning” and “Spanish before” among two lines such that the horizontal overlap between the secondary substrings and their corresponding primary substrings is greater than a the horizontal overlap between the secondary substrings and their adjacent primary substrings belonging to adjacent substring pairs. Alternatively, the system can reduce the width of “I am learning” and “Spanish before” by automatically selecting a smaller font for “I am learning” and “Spanish before” or by reducing the actual width of these secondary substrings.

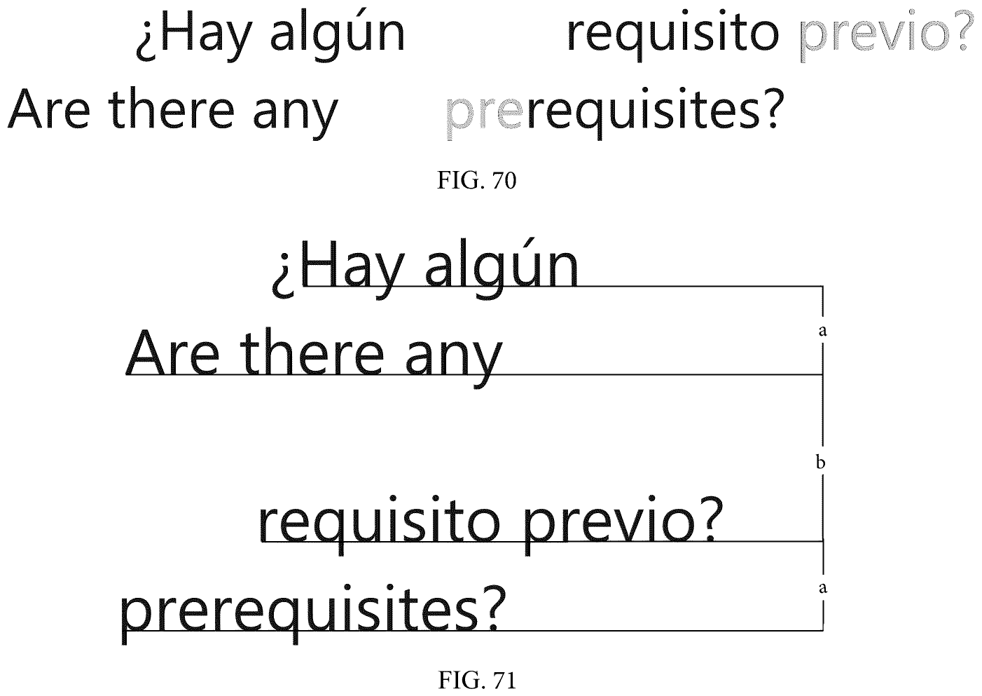

Distinguishing a portion of a secondary substring from the remainder of the secondary substring and distinguishing a portion of the corresponding primary substring hints a connection between the distinguished portions. For example, in FIG. 70, the “previo” portion of the secondary substring “requisite previo” and the “pre” portion of the primary substring “prerequisite” are deemphasized through shading. A reader would understand that the Spanish prefix of “previo” corresponds to the the English prefix of “pre”. Other forms of distinguishment can include appearance changes (e.g., to the color, font size, font), position changes (e.g., moving the distinguished portion up or down by a few pixels; moving the distinguished portion to a different line), and effects (e.g., the distinguished portion flashes).

When substring pairs are arranged vertically, for a given first substring pair in a first line and a given second substring pair in a second line, the second line being the line immediately below the first line: a first vertical distance in between the baseline of a topmost substring in the first given substring pair and the baseline of a bottommost substring in the given first substring pair is less than a second vertical distance in between a baseline of the bottommost substring in the given first substring pair and the baseline of the topmost substring in the given second substring pair. Such display schemes hint at which substrings belong to which substring pair. For example, in FIG. 71, the distance ‘a’ between the baseline of the secondary substring “¿ Hay algún” and the baseline of its primary substring “Are there any” is less than the distance ‘b’ between the baseline of the primary substring “Are there any” and the secondary substring of the immediately below substring pair “requisito previo?”

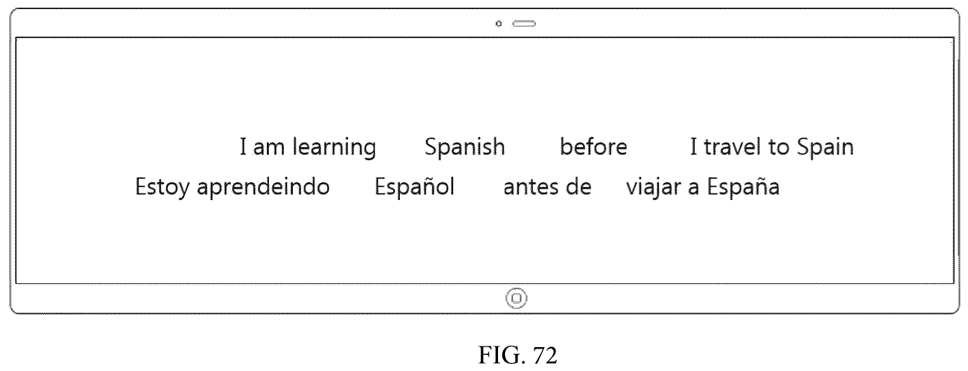

When substring pairs are arranged horizontally, as shown in FIG. 72, when a given substring pair has an immediately right substring pair, the immediately right substring pair is positioned such that a horizontal distance in between the rightmost point of the given substring pair and the leftmost point of the immediately right substring pair is zero. Alternatively, when a given substring pair has an immediately left substring pair, the immediately left substring pair is positioned such that a horizontal distance in between the leftmost point of the given substring pair and the rightmost point of the immediately left substring pair is zero.

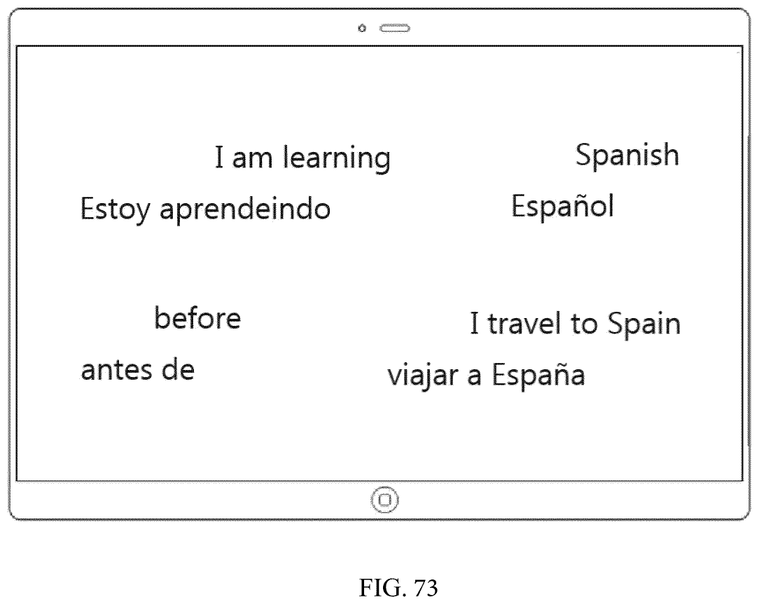

FIG. 73 shows an alternative electronic display. Here, there leftmost substring in each line is left aligned (e.g., the leftmost point of the leftmost substring in each line sits on a vertical line) and right rightmost substring in each pair is right aligned (e.g., the rightmost point of the rightmost substring in each line sits on a vertical line).

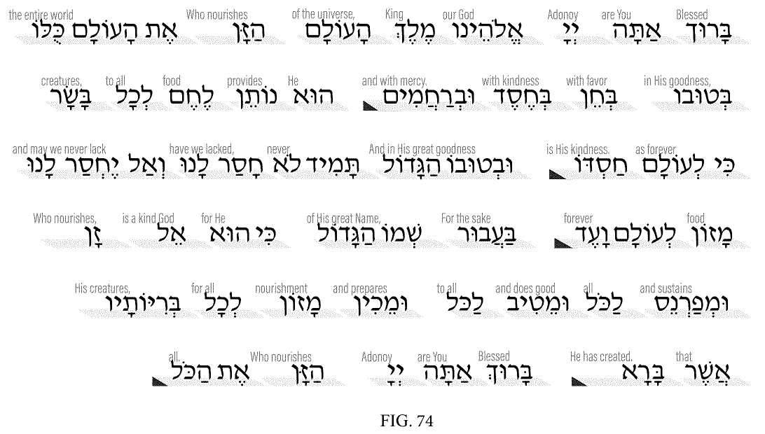

FIG. 74 shows a further non-limiting example of demarcations.

In an embodiment, a primary substring and its corresponding secondary substring have a same appearance characteristic that hints at a correspondence between the primary substring and its corresponding secondary substring. For example, the primary substring and its corresponding substring are both bolded, the primary substring and its corresponding substring are have a left to right shading, the primary substring and its corresponding substring are both displayed in a larger font than other substrings in adjacent substring pairs, etc.

What is further disclosed is a rendering engine to display a primary text string and a secondary text string in a clutter-reducing manner, the system comprising: memory storing executable instructions; a processing device executing the instructions, wherein the instructions cause the system to: receive a primary text string comprised of a plurality of primary substrings; receive a secondary text string comprised of a plurality of secondary substrings, wherein each of the secondary substrings is one of a translation and transliteration of its corresponding primary substring; receive a plurality of shaped markers; render, in real-time, substring pairs for display, wherein each of the rendered substring pairs comprises one of the secondary substrings placed next to its corresponding primary substring; display, on an electronic display, the substring pairs; wherein: a structure of the primary text string includes at least a first superstructure and a second superstructure; each of the first and second superstructures is comprised of a plurality of substructures; the substring pairs are demarcated by the plurality of shaped markers such that the shaped markers define at least one of the substructures and the substructures of the primary text string; the substructures and the superstructures of the primary text string are defined; when, for each of the substring pairs, a given secondary substring is not horizontally offset from its corresponding primary substring: rectangular primary inter-airspaces laterally border primary substrings, wherein the left edge of a given rectangular primary inter-airspace is defined by a first vertical line flush with the rightmost point of an immediately left primary substring or the left edge of a page; the right edge of the given rectangular primary inter-airspace is defined by a second vertical line flush with the leftmost point of an immediately right primary substring or the right edge of the page; the bottom edge of the given rectangular primary inter-airspace is defined by a first horizontal line flush with a descender line of immediately adjacent primary substrings; the top edge of the given rectangular primary inter-airspace is defined by a second horizontal line flush with an ascender line of the immediately adjacent primary substrings; rectangular secondary inter-airspaces laterally border secondary substrings, wherein the left edge of a given rectangular secondary inter-airspace is defined by a first vertical line flush with the rightmost point of an immediately left secondary substring or the left edge of the page; the right edge of the given rectangular secondary inter-airspace is defined by a second vertical line flush with the leftmost point of an immediately right secondary substring or the right edge of the page; the bottom edge of the given rectangular secondary inter-airspace is defined by a first horizontal line flush with a descender line of immediately adjacent secondary substrings; and the top edge of the given rectangular secondary inter-airspace is defined by a second horizontal line flush with an ascender line of the immediately adjacent secondary substrings; a given shaped marker is not entirely within one of the rectangular primary inter-airspace or one of the rectangular secondary inter-airspace, wherein the given shaped marker is not entirely in between adjacent substring pairs, wherein when the leftmost point of the given shaped marker is in between the rightmost point of the immediately left substring pair and the leftmost point of the immediately right substring pair, the rightmost point of the given shaped marker is not in between the rightmost point of the immediately left substring pair and the leftmost point of the immediately right substring pair; adjoining shaped markers form groups of adjoined shaped markers, wherein a given group of adjoined shaped markers or the given shaped marker does not fully enclose a first substring pair and a second substring pair, wherein the first substring pair is positioned on a first line and the second substring pair is positioned on a second line; a substring in the second substring pair is a translation or a transliteration of a substring of the first substring pair.

In an embodiment, for the rendering engine, a first portion of the first superstructure is on a same line as a second portion of the second superstructure.

In an embodiment, for the rendering engine, when the shaped markers only define the substructures of the primary text string: the superstructures of the primary text string are defined by at least one of: an increased spacing between substrings of different superstructures; punctuation between the substrings of different superstructures; when the shaped markers only define the superstructures of the primary text string: the substructures of the primary text string are defined by at least one of: an increased spacing between substrings of the same superstructure; and punctuation between the substrings of the same superstructure.

In an embodiment, for the rendering engine, at least one of the substructures and the superstructures of the primary text string are further defined by an increased spacing in between the substring pairs.

In an embodiment, for the rendering engine, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; a sum of widths of the shaped markers that enter a given substring airspace is equal to or greater than two average character widths of characters in the primary substring, wherein a character width is defined by a horizontal distance between the leftmost point of a character and the rightmost point of a character; and a width of a given shaped marker is defined by a horizontal distance between the leftmost point of the given shaped marker and the rightmost point of the given shaped marker.

In an embodiment, for the rendering engine, the shaped markers are not textual commentary, wherein textual commentary includes at least punctuation, tropes, and accents.

In an embodiment, for the rendering engine, the substructures and the superstructures of the primary text string are defined by the shaped markers.

In an embodiment, for the rendering engine, none of the shaped markers is adjoined to another shaped marker.

In an embodiment, for the rendering engine, the shaped markers within the given group of adjoined shaped markers are laterally joined.

In an embodiment, for the rendering engine, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; for each of the shaped markers within the given rectangular substring airspace: the topmost point of the shaped marker is at or below the topmost point of a corresponding substring pair and the bottommost point of the given shaped marker is at or above the bottommost point of the corresponding substring pair.

In an embodiment, for the rendering engine, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; for each of the shaped markers within the given rectangular substring airspace: the topmost point of the shaped marker is at or below the x-height line of an upper substring the corresponding substring pair and the bottommost point of the given shaped marker is at or above the baseline of a lower substring in the corresponding substring pair.

In an embodiment, for the rendering engine, for each of the substring pairs, a given secondary substring is horizontally offset from the corresponding primary substring.

In an embodiment, for the rendering engine, each of the primary substrings, less a first primary substring, is vertically and horizontally offset from an immediately previous primary substring.

In an embodiment, for the rendering engine, the instructions further cause the system to: set, based on user preference, a first type of grammatical unit for the substructures and a second type of grammatical unit for the superstructures; define structures of the primary text string, wherein the defined structures include at least the substructures and the superstructures of the primary text string; the structures are defined via operations of a natural language processing service; the natural language processing service defines the structures as output from at least one automated parser.

In an embodiment, for the rendering engine, when the first type of grammatical unit is a word, the second type of grammatical unit is a phrase; when the first type of grammatical unit is a phrase, the second type of grammatical unit is a sentence; and when the first typic of grammatical unit is a sentence, the second type of grammatical unit is a plurality of sentences.

In an embodiment, for the rendering engine, at least one of the shaped markers enters one of the primary inter-airspaces and one of the secondary inter-airspaces; and the at least one of the of shaped markers that enters one of the primary inter-airspaces and one of the secondary inter-airspaces defines the superstructures of the primary text string.

In an embodiment, for the rendering engine, the shaped markers comprise at least a first set of shaped markers and a second set of shaped markers; the first set of shaped markers, when viewed individually, defines the substructures of the first superstructure, and, when viewed together, defines the first superstructure; the second set of shaped markers, when viewed individually, defines the substructures of the second superstructure, and, when viewed together, defines the second superstructure; wherein a first visual property of each of the shaped markers in the first set of shaped markers varies in the reading direction of the primary text string; a second visual property of each of the shaped markers in the second set of shaped markers varies in the reading direction of the primary text string; and the variance of the second visual property is not a continuation of the variance of the first visual property such that, when the demarcated substring pairs are displayed, the first set of shaped markers is distinguishable from the second set of shaped markers.

In an embodiment, for the rendering engine, the variance of the first and second visual properties is gradual or discrete.

In an embodiment, for the rendering engine, the first visual property is the color of the shaped markers in the first set of shaped markers; the second visual property is the color of the shaped markers in the second set of shaped markers; and the variance of the first and second visual properties is a color variance.

In an embodiment, for the rendering engine, the first visual property is the color of the shaped markers in the first set of shaped markers; the second visual property is the color of the shaped markers in the second set of shaped markers; and the variance of the first and second visual properties is a shading variance.

In an embodiment, for the rendering engine, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; the shaped markers includes a plurality of narrow shaped markers and a plurality of wide shaped markers, wherein a given narrow shaped marker is mostly within the rectangular airspace of only one of the substring pairs such that the narrow shaped markers define the substructures of the primary text string; and a given wide shaped marker is within the rectangular airspace of at least two of the substring pairs such that the wide shaped markers define the superstructures of the primary substring.

In an embodiment, for the rendering engine, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; each of the rectangular airspaces contains at least one of the shaped markers.

In an embodiment, for the rendering engine, a given shaped marker comprises a shape that causes one of the secondary substrings to appear on a separate perspective plane relative to the corresponding primary substring, conveying a visual appearance of depth for the secondary substring.

In an embodiment, for the rendering engine, the shaped markers are a lighter shade than the primary and secondary text strings; or a majority of a page, on which the substring pairs are rendered, is mono-colored.

In an embodiment, for the rendering engine, for each of the substring pairs, the rightmost point of the secondary substring is at or to the left of the rightmost point of its corresponding primary substring and the leftmost point of the secondary substring is at or to the right of the center point of its corresponding primary substring; or the leftmost point of the secondary substring is at or to the right of the leftmost point of its corresponding primary substring and the rightmost point of the secondary substring is at or to the left of the center point of its corresponding primary substring.

In an embodiment, for the rendering engine, when the primary text string has a same reading direction as the secondary text string, for each of the substring pairs, the leftmost point of the secondary substring is aligned with the leftmost point of its corresponding primary substring when the same reading direction is left to right; and the rightmost point of the secondary substring is aligned with the rightmost point of its corresponding primary substring when the same reading direction is right to left.

In an embodiment, for the rendering engine, the instructions further cause the processing device to: receive torah-related commentary; display, on the electronic display, the torah-related commentary next to its corresponding substring pair, wherein the torah-related commentary elaborates on the meaning or intended purpose of the corresponding substring pair.

In an embodiment, for the rendering engine, for the given group of adjoined shaped markers, a width of the given group of adjoined shaped markers is greater than or equal to a height of the given group of adjoined shaped markers, wherein the width of the given group of adjoined shaped markers is defined by the horizontal distance between the leftmost point of the given group of adjoined shaped markers and the rightmost point of the given group of adjoined shaped markers; and the height of the given group of adjoined shaped markers is defined by the vertical distance between the bottommost point of the given group of adjoined shaped markers and the topmost point of the given group of adjoined shaped markers.

In an embodiment, for the rendering engine, a given substring pair has an upper substring and a lower substring, the upper substring positioned above the lower substring; and the upper substring in the given substring pair is in English.

In an embodiment, text strings are rendered for display according to the following method steps:
1) Conditions to render new content for display are checked once per predetermined interval (e.g., every 10 ms). These conditions can include: text input into a predetermined text area on the display screen; changes in parameters such as font size, position, spacing, color, etc; direct clicks on ‘redraw’ and ‘separate window’ interface buttons; direct sliding of parameter interface sliders. When a condition is met, the program proceeds to render the new content.
2) The first step in rendering the new content is identifying the target portion of the electronic display (container) where the results of the program will be displayed. The size and location of the container depends on factors such as the desired text layout, text characteristics, and demarcation characteristics. Any existing content within this container is cleared.
3) The second step in rendering the new content is processing the input text. The text input is split into lines (e.g., based on newline characters (\n) or other identifiers). Each line of text is then processed individually.
4) The third step in rendering the new content is line processing. Each line of text is further split into substrings (e.g., based on the backslash (\) character). If the split results in exactly two parts, additional processing can occur (e.g., The first character of the second substring is checked to determine a stop parameter based on certain characters (, . : ;). This character helps dictate specific behaviors or styles that are applied later.
5) The fourth step in rendering the new content is creating substring pairs. For lines of text that meet the parsing conditions, the substring pairs are created with parameters derived from the parsed text. Parameters can include the ‘target’ (the container where the unit will be placed), ‘trim1’ (the first part of the split line, trimmed of whitespace), ‘trim2’ (the adjusted second substring of the split line, also trimmed and possibly modified by removing the first character), ‘stop’ (the behavior/style indicator derived from the first character of the second substring), ‘justify’ (a fixed value provided for layout purposes).
6) The fifth step in rendering the new content is appending it to the container.
7) The sixth step in rendering the new content is updating the parameters. After all lines have been processed and the respective units created and appended, a series of updates are performed to ensure the newly added elements are styled and positioned according to the current settings of various parameters. These updates adjust the layout and appearance of the elements within container and example based on updated or existing parameters.

These steps are part of a dynamic update process that ensures the layout and styling of elements (e.g., substring pairs, substrings, demarcations) within the container on the display screen match the updated parameters dictated by user inputs, maintaining consistency and applying new styles as needed.

In some embodiments, the method may further include steps of:
1) Iterating through child elements for steps 4-7. For each substring pair, the method checks for the presence of other elements such as demarcations (indicating the substring pair is a composite element). If the substring pair is determined to be a composite element, steps 4-7 are iterated to update deeper aspects of each element based on the latest parameters.
2) Adjusting positioning. As steps 4-7 are iterated, the method includes managing the positioning of elements by comparing the right boundary of each element to a tracked maximum (left variable). If the current element extends further right than any previous ones, it adjusts the margin left of the previously handled element to 0, effectively tightening the layout.
3) Final margin adjustment. Once the loop completes, if there is a previous element handled in the loop) it ensures this element's left margin is set to 0, finalizing the adjustments for the last element in the sequence.

These steps finalize the layout and appearance of the elements within container, ensuring a more aesthetic appearance.

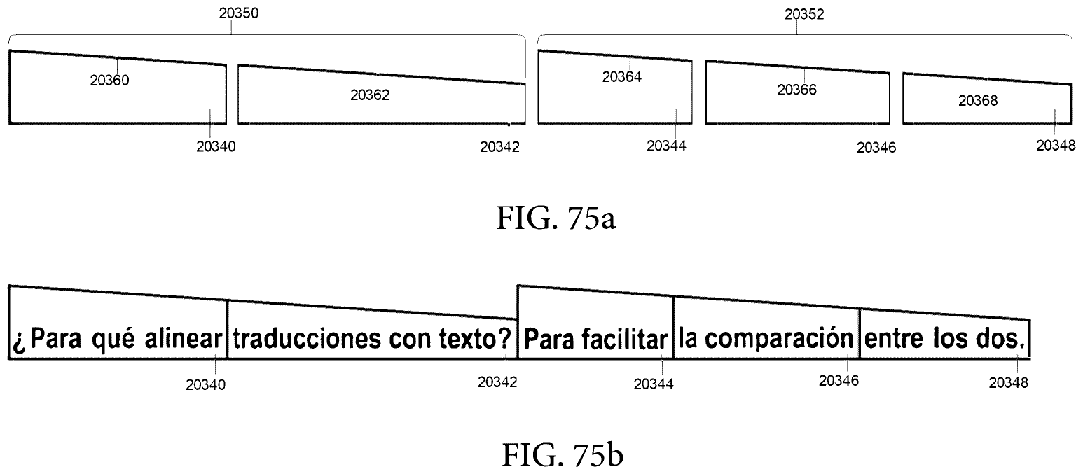

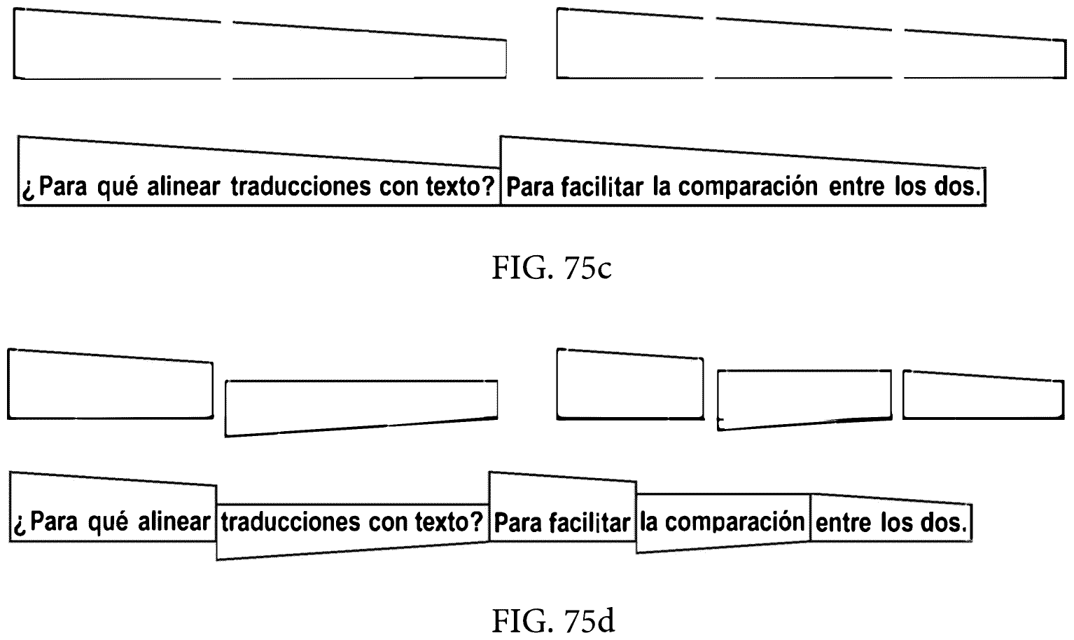

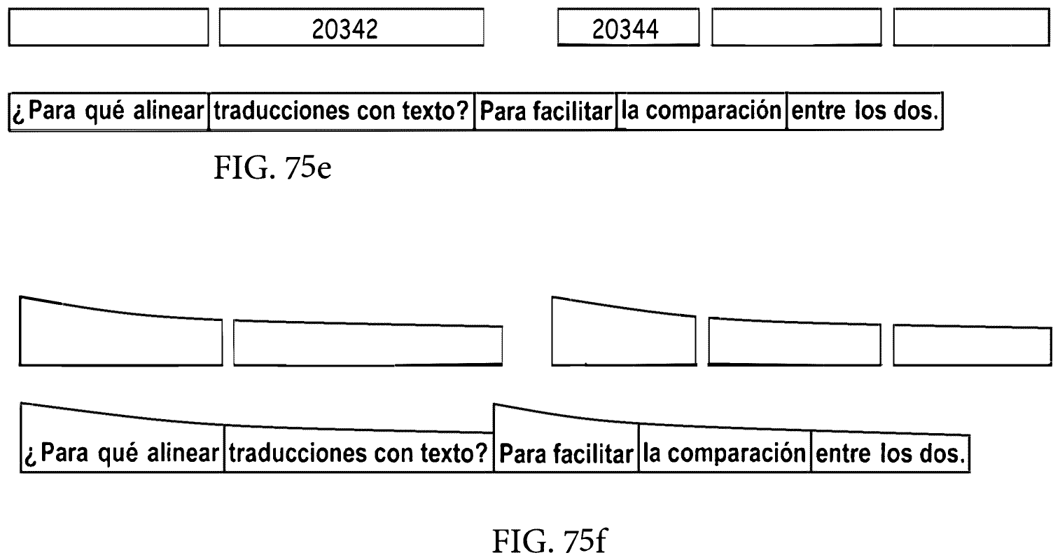

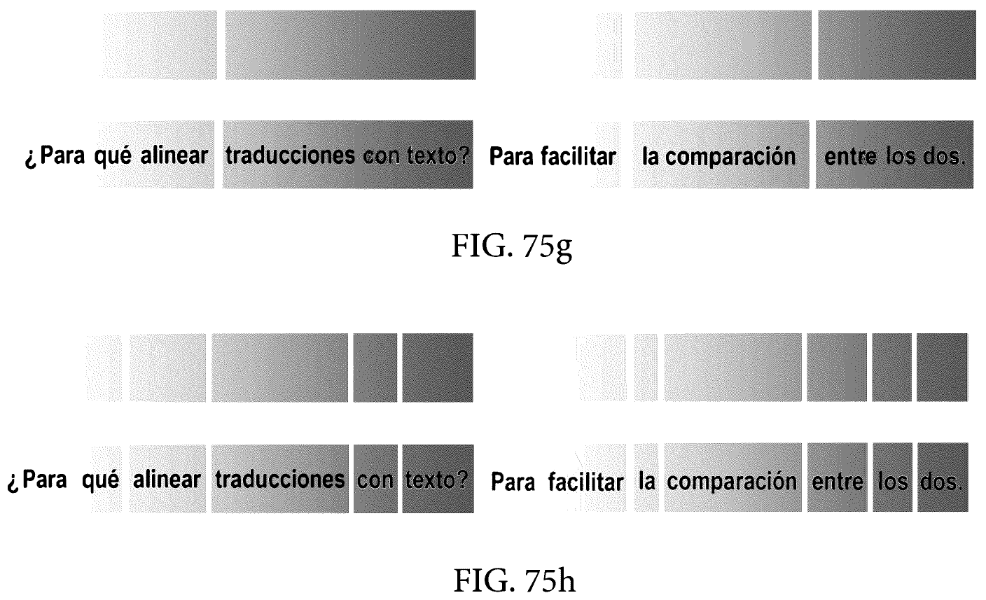

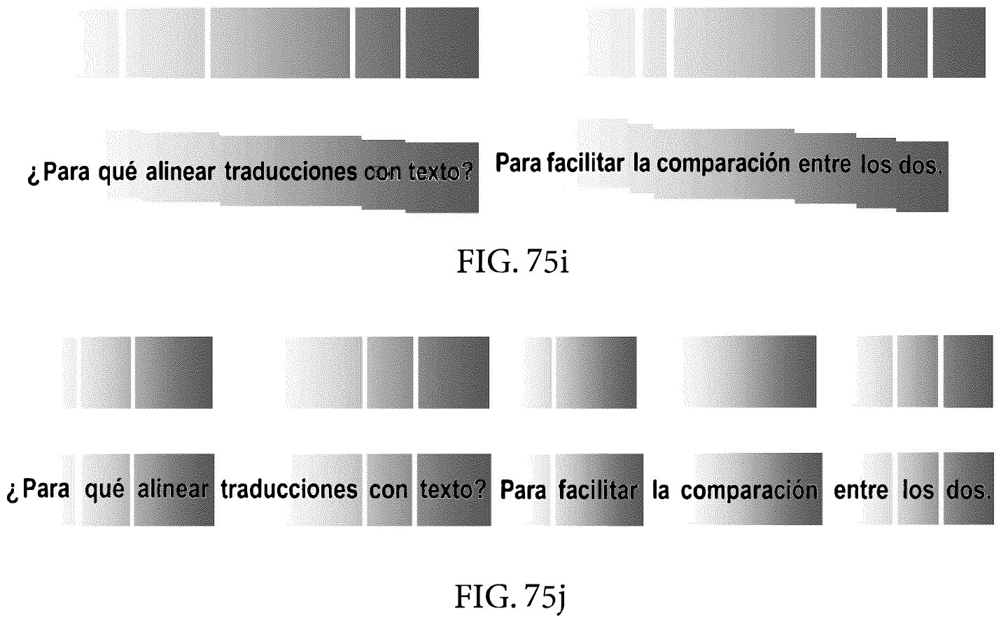

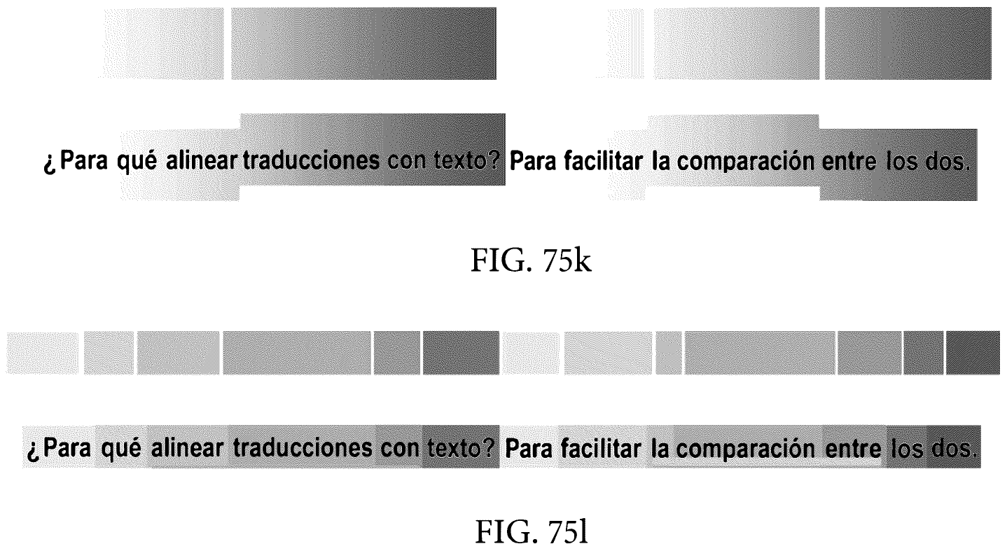

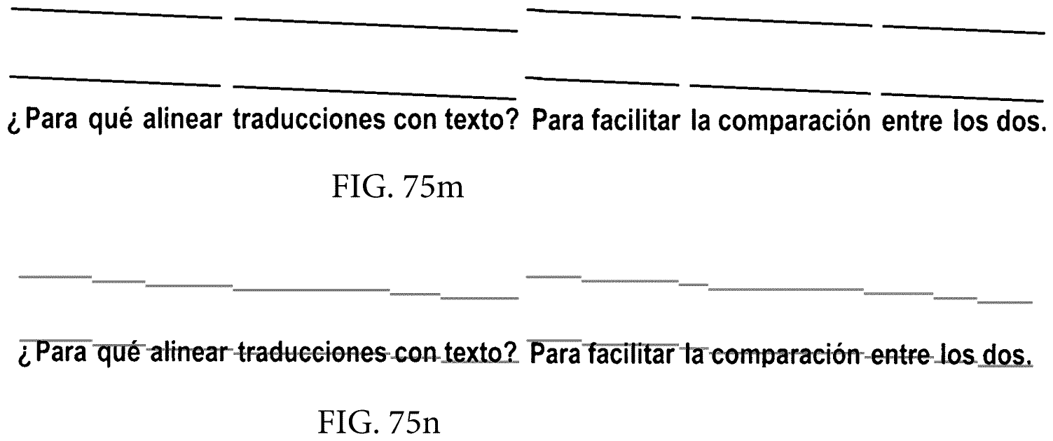

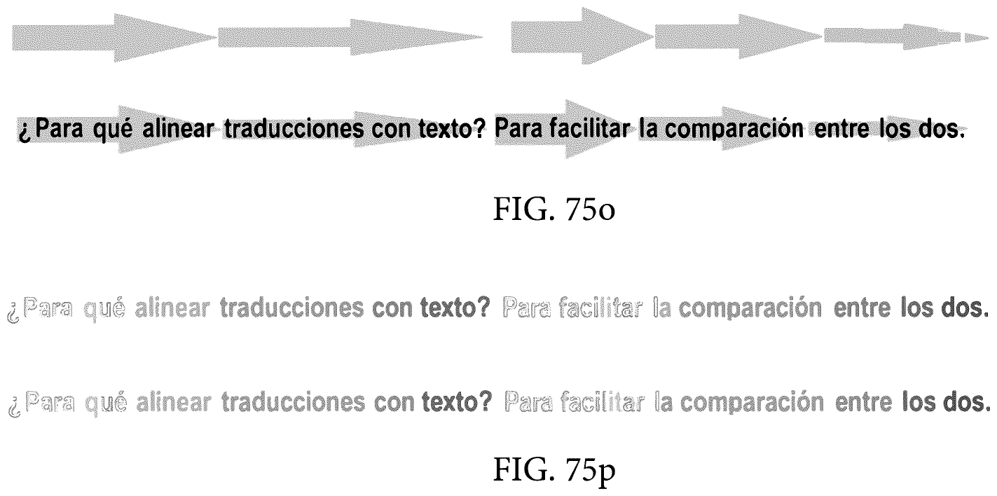

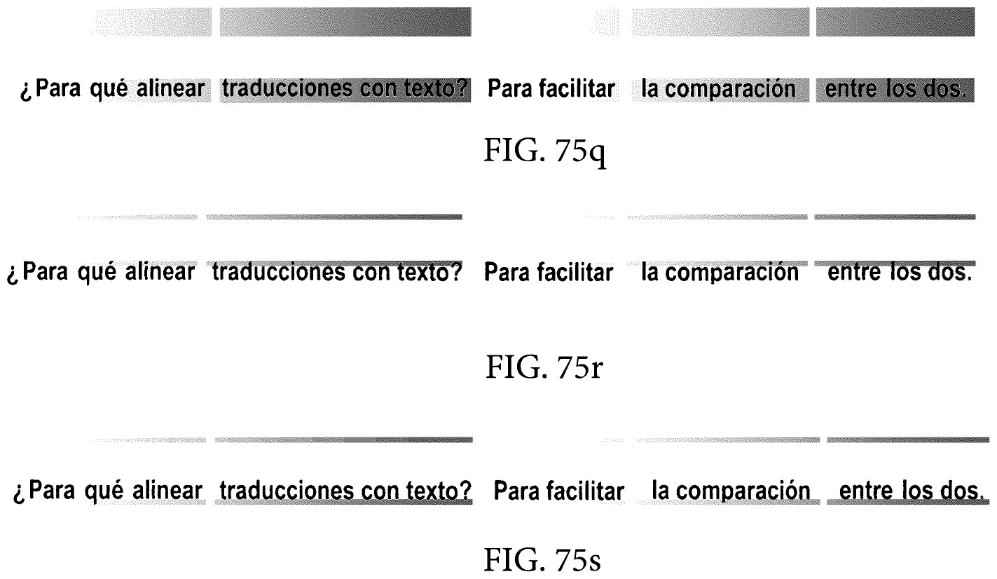

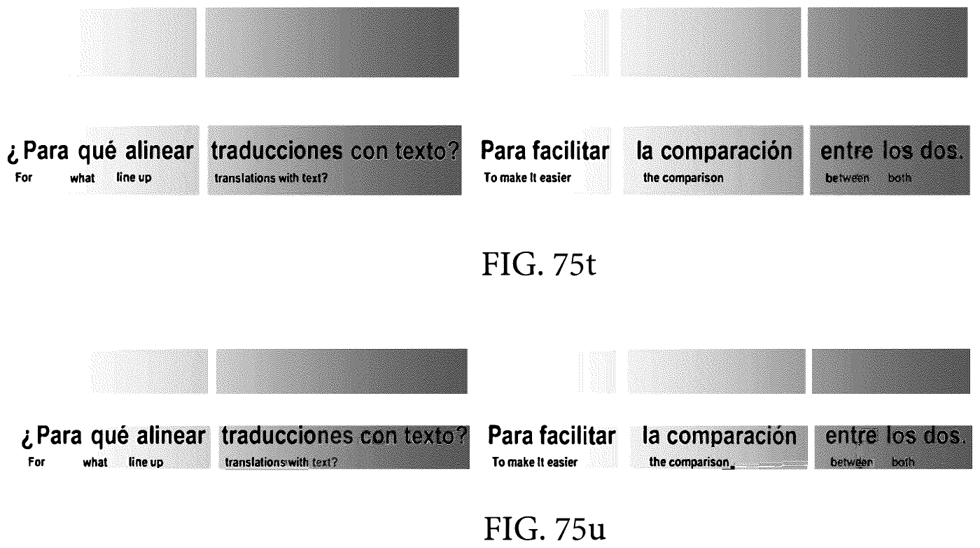

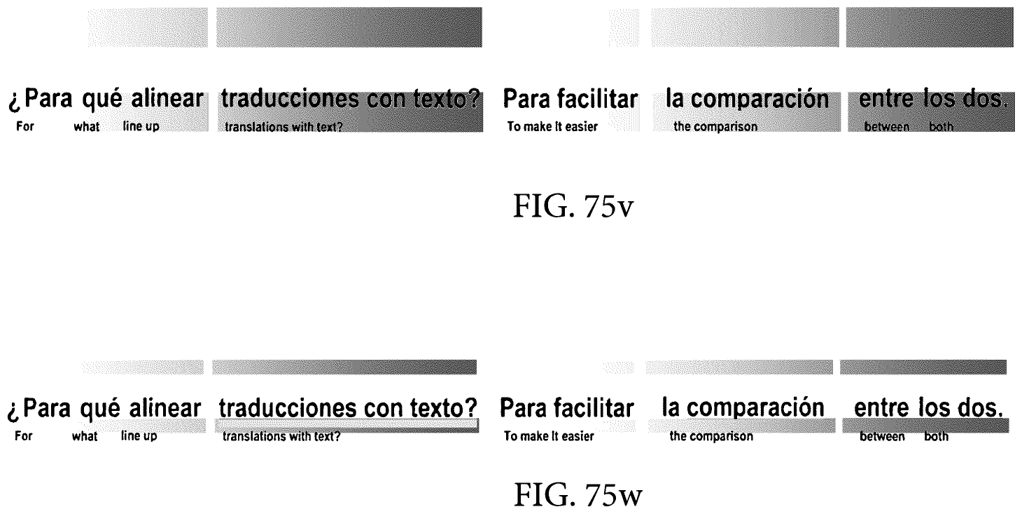

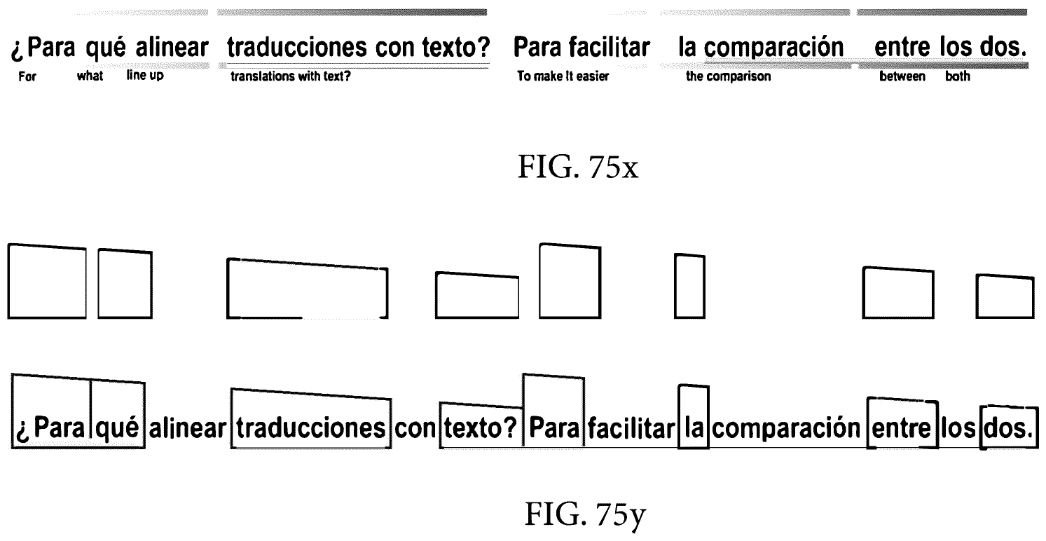

FIG. 75a shows two sets of demarcations, according to an embodiment. Here, the demarcations are hollow enclosing structures. The first set of demarcations 20350 is comprised of related first 20340 and second 20342 demarcations. The second set of demarcations 20352 is comprised of related third 20344, fourth 20346, and fifth 20348 demarcations. Two demarcations belonging to the same set of demarcations will be herein referred to as related demarcations and two demarcations belonging to different sets of demarcations will be herein referred to as unrelated demarcations (e.g., the first demarcation 20340 is related to the second demarcation 20342 but the first demarcation 20340 is unrelated to the third demarcation 20344). Related demarcations are visually linked such that, when several sets of demarcations demarcate a text string, a reader is able to determine whether or not a given demarcation is related to an immediately adjacent demarcation. When separated by spacing, related demarcations maintain a sense of cohesion. When two demarcations are not separated by spacing (e.g., flush with each other), a reader can distinguish between the two flush demarcations. Preferably, when several sets of demarcations demarcate a text string, immediately adjacent unrelated demarcations are not visually linked.

For example, the slope and position of the top edge 20362 of the second demarcation 20342 makes the top edge 20362 of the second demarcation 20342 a natural continuation of the top edge 20360 of the first demarcation 20340, forming a visual link between the first 20340 and second 20342 demarcations. When the first 20340 and second 20342 demarcations demarcate a text string, such as in FIG. 75b, a reader is able to determine that the first demarcation 20340 is related to the immediately adjacent second demarcation 20342.

The slope and position of the top edge 20364 of the third demarcation 20344 makes the top edge 20364 of the third demarcation 20344 not a natural continuation of the top edge 20362 of the second demarcation 20342, not forming a visual link between the second 20342 and third 20344 demarcations. When the second 20342 and third 20344 demarcations demarcate a text string, such as in FIG. 75b, a reader is able to determine that the second demarcation 20342 is unrelated to the immediately adjacent third demarcation 20344.

FIG. 75b shows a demarcated Spanish text string, according to an embodiment. Sets of demarcations define the superstructures of the text string. Here, the superstructures are sentences of “¿Para qué alinear traducciones con texto?” and “Para facilitar la comparación entre los dos.” The first set of demarcations 20350 defines the first sentence of “¿Para que alinear traducciones con texto?” and the second set of demarcations 20352 defines the second sentence of “Para facilitar la comparación entre los dos.” Individual demarcations within a set of demarcations define substructures of the text string. Here, the substructures are phrases of “¿ Para qué alinear” “traducciones con texto?” “Para facilitar” “la comparación” and “entre los dos.” The first demarcation 20340 defines the first phrase of “¿ Para que alinear”, the second demarcation 20342 defines the second phrase of “traducciones con texto?”, the third demarcation 20344 defines the third phrase of “Para facilitar”, the fourth demarcation 20346 defines the fourth phrase of “la comparación”, and the fifth demarcation 20348 defines the fifth phrase of “entre los dos.”

Thus, a preferred method of using sets of demarcations to define substructures and superstructures of a text string requires 1) immediately adjacent demarcations to be distinguishable, 2) immediately adjacent related demarcations to be visually linked, and 3). Immediately adjacent unrelated demarcations to not be visually linked. It shall be appreciated that text string substructures may be any smaller portion of a text string, including, but not limited to, words, groups of words, or phrases while text string super structures may be any larger portion of a text string, including, but not limited to, groups of words, phrases, or sentences where text string superstructures are comprised of a plurality of text string substructures. It shall be appreciated that when sets of demarcations are used to demarcate a text string with a left-to-right or a right-to-left reading directionality, immediately adjacent demarcations can refer to the horizontally adjacent demarcations. Likewise, when sets of demarcations are used to demarcate a text string with a top-to-bottom or a bottom-to-top reading directionality, immediately adjacent demarcations can refer to the vertically adjacent demarcations.

FIG. 75c shows two sets of demarcations (top) and a demarcated Spanish text string (bottom) where, when the two sets of demarcations demarcate the Spanish text string, immediately adjacent demarcations cannot be distinguished from each other. Here, unlike in FIG. 75b, a reader cannot distinguish related demarcations belonging to the same set of demarcations, and, thus, substructures of the text string are not defined. Related demarcations must be differentiable to allow readers to differentiate related demarcations belonging to the same set of demarcations.

FIG. 75d shows two sets of demarcations (top) and a demarcated Spanish text string (bottom) where related demarcations are not visually linked. Here, unlike in FIG. 75b, a reader cannot determine which demarcations are related, and, thus, superstructures of the text string are not defined. Immediately adjacent related demarcations must be visually linked to allow readers to see which demarcations are related.

FIG. 75c shows two sets of demarcations (top) and a demarcated Spanish text string (bottom) where related demarcations are visually linked. Here, unlike in FIG. 75b, immediately adjacent unrelated demarcations are visually linked so a reader cannot determine that the second demarcation 20342 is unrelated to the immediately adjacent third demarcation 20344, and, thus, superstructures of the text string are not defined. Immediately adjacent unrelated demarcations must not be visually linked.

FIGS. 75f-75y show sets of demarcations demarcating a text string. Each of the demarcations is distinguishable from immediately adjacent demarcations, immediately adjacent related demarcations are visually linked, and immediately adjacent unrelated demarcations are not visually linked. The demarcations define substructures and superstructures of the text string. Such demarcations embody a significant advance over traditional demarcations that cannot define substructures and superstructures of a text string.

FIG. 75f shows two sets of demarcations (top) and a demarcated Spanish text string (bottom), according to an embodiment. Here, the demarcations are hollow enclosing structures where immediately adjacent related demarcations are visually linked through the positions and slopes of their top edges. The defined substructures are phrases and the defined superstructures are sentences.

FIG. 75g shows two sets of demarcations (top) and a demarcated Spanish text string (bottom), according to an embodiment. Here, the demarcations are rectangular enclosing structures where immediately adjacent related demarcations are visually linked through a gradual shading gradient. The defined substructures are phrases and the defined superstructures are sentences.

FIG. 75h shows two sets of demarcations (top) and a demarcated Spanish text string (bottom), according to an embodiment. Here, the demarcations are rectangular enclosing structures where immediately adjacent related demarcations are visually linked through a gradual shading gradient. The defined substructures are words and the defined superstructures are sentences.

FIG. 75i shows two sets of demarcations (top) and a demarcated Spanish text string (bottom), according to an embodiment. Here, the demarcations are rectangular enclosing structures where immediately adjacent related demarcations are visually linked through a gradual shading gradient. The defined substructures are words and the defined superstructures are sentences.

FIG. 75j shows five sets of demarcations (top) and a demarcated Spanish text string (bottom), according to an embodiment. Here, the demarcations are rectangular enclosing structures where immediately adjacent related demarcations are visually linked through a gradual shading gradient. The defined substructures are words and the defined superstructures are phrases.

FIG. 75k shows two sets of demarcations (top) and a demarcated Spanish text string (bottom), according to an embodiment. Here, the demarcations are rectangular enclosing structures where immediately adjacent related demarcations are visually linked through a gradual shading gradient. The defined substructures are phrases and the defined superstructures are sentences.

FIG. 751 shows two sets of demarcations (top) and a demarcated Spanish text string (bottom), according to an embodiment. Here, the demarcations are rectangular enclosing structures where immediately adjacent related demarcations are visually linked through a discrete (e.g., non-gradual) shading gradient. The defined substructures are words and the defined superstructures are sentences.

FIG. 75m shows two sets of demarcations (top) and a demarcated Spanish text string (bottom), according to an embodiment. Here, the demarcations are descending lines where immediately adjacent related demarcations are visually linked through the positions and slopes of their top edges. The defined substructures are phrases and the defined superstructures are sentences.

FIG. 75n shows two sets of demarcations (top) and a demarcated Spanish text string (bottom), according to an embodiment. Here, the demarcations are horizontal lines where immediately adjacent related demarcations are visually linked through the positions their top edges. The defined substructures are phrases and the defined superstructures are sentences.

FIG. 750 shows two sets of demarcations (top) and a demarcated Spanish text string (bottom), according to an embodiment. Here, the demarcations are incrementally narrower arrows where immediately adjacent related demarcations are visually linked through the narrowness of their shape. The defined substructures are phrases and the defined superstructures are sentences.

FIG. 75p shows two sets of demarcations (top) and a demarcated Spanish text string (bottom), according to an embodiment. Here, the demarcations are distinctly colored words of the Spanish text string where immediately adjacent related demarcations are visually linked through a discrete color gradient. The defined substructures are words and the defined superstructures are sentences. Alternatively, distinct color gradients can be any recognizable color gradient including, but not limited to, a rainbow where the demarcations are distinctly red, orange, yellow, green, blue, violet, etc.

FIG. 75q shows two sets of demarcations (top) and a demarcated Spanish text string (bottom), according to an embodiment. Here, the demarcations are rectangular enclosing structures where immediately adjacent related demarcations are visually linked through a gradual shading gradient. Furthermore, each demarcation is placed such that the entire demarcation is between the text string descender line and the text string ascender line. Such demarcation placements allow text strings to be demarcated without interfering with adjacent text strings. The defined substructures are phrases and the defined superstructures are sentences.

FIG. 75r shows two sets of demarcations (top) and a demarcated Spanish text string (bottom), according to an embodiment. Here, the demarcations are rectangular enclosing structures where immediately adjacent related demarcations are visually linked through a gradual shading gradient. Furthermore, each demarcation is placed such that the entire demarcation is between the text string mean line and the text string ascender line. Such demarcation placements allow text strings to be demarcated without interfering with adjacent text strings, and with minimal harm to the readability of the text string. The defined substructures are phrases and the defined superstructures are sentences.

FIG. 75s shows two sets of demarcations (top) and a demarcated Spanish text string (bottom), according to an embodiment. Here, the demarcations are rectangular enclosing structures where immediately adjacent related demarcations are visually linked through a gradual shading gradient. Furthermore, each demarcation is placed such that the entire demarcation is between the text string descender line and the text string base line. Such demarcation placements allow text strings to be demarcated without interfering with adjacent text strings, and with minimal harm to the readability of the text string. The defined substructures are phrases and the defined superstructures are sentences.

FIG. 75t shows two sets of demarcations (top) and demarcated Spanish and English text strings (bottom), according to an embodiment. Here, the demarcations are rectangular enclosing structures where immediately adjacent related demarcations are visually linked through a gradual shading gradient. For both text strings, the defined substructures are phrases and the defined superstructures are sentences. Demarcating two text substrings with the same demarcation strengthens a visual association among text substrings within that demarcation. For example, here, the demarcations strengthen a visual association between “Para qué alinear” and “For what line up”, “traducciones con texto?” and “translations with text?,” etc.

FIG. 75u shows two sets of demarcations (top) and demarcated Spanish and English text strings (bottom), according to an embodiment. Here, the demarcations are rectangular enclosing structures where immediately adjacent related demarcations are visually linked through a gradual shading gradient. Each demarcation is placed such that the entire demarcation is in between the descender line of the lower text string and the ascender line of the upper text string. Such demarcation placement allows text strings to be demarcated without interfering with adjacent text strings, and with minimal harm to the readability of the text strings. Furthermore, demarcating two text substrings with the same demarcation strengthens a visual association among text substrings within that demarcation. For both text strings, the defined substructures are phrases and the defined superstructures are sentences.

FIG. 75v shows two sets of demarcations (top) and demarcated Spanish and English text strings (bottom), according to an embodiment. Here, the demarcations are rectangular enclosing structures where immediately adjacent related demarcations are visually linked through a gradual shading gradient. Each demarcation is placed such that the entire demarcation is in between the base line of the lower text string and the mean line of the upper text string. Such demarcation placement allows text strings to be demarcated without interfering with adjacent text strings, and with minimal harm to the readability of the text string. Furthermore, demarcating two text substrings with the same demarcation strengthens a visual association among text substrings within that demarcation. For both text strings, the defined substructures are phrases and the defined superstructures are sentences.

FIG. 75w shows two sets of demarcations (top) and demarcated Spanish and English text strings (bottom), according to an embodiment. Here, the demarcations are rectangular enclosing structures where immediately adjacent related demarcations are visually linked through a gradual shading gradient. Each demarcation is placed such that the entire demarcation is in between the mean line of the lower text string and the base line of the upper text string. Such demarcation placement allows text strings to be demarcated without interfering with adjacent text strings, and with minimal harm to the readability of the text string. Furthermore, demarcating two text substrings with the same demarcation strengthens a visual association among text substrings within that demarcation. For both text strings, the defined substructures are phrases and the defined superstructures are sentences.

FIG. 75x shows two sets of demarcations (top) and demarcated Spanish and English text strings (bottom), according to an embodiment. Here, the demarcations are rectangular enclosing structures where immediately adjacent related demarcations are visually linked through a gradual shading gradient. Each demarcation is placed such that the entire demarcation is in between the ascender line of the lower text string and the descender line of the upper text string. Such demarcation placement allows text strings to be demarcated without interfering with any text strings, and with no harm to the readability of the text string. Furthermore, demarcating two text substrings with the same demarcation strengthens a visual association among text substrings within that demarcation. For both text strings, the defined substructures are phrases and the defined superstructures are sentences.

FIG. 75y shoes two sets of demarcations (top) and a demarcated Spanish text string (bottom), according to an embodiment. Here, the demarcations are hollow enclosing structures where immediately adjacent related demarcations are visually linked through the positions and slopes of their top edges. The defined substructures are phrases and the defined superstructures are sentences. Demarcations are placed on the first and last substructure of every superstructure, as well as on every other substructure. Such demarcation placement allows fewer demarcations to be used to define substructures and superstructures of the text string, potentially reducing clutter.

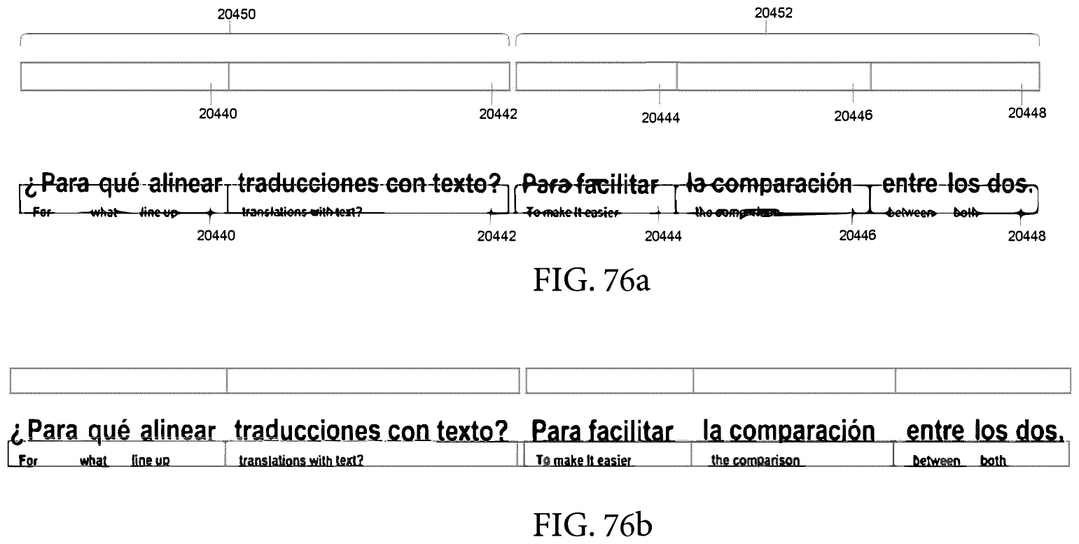

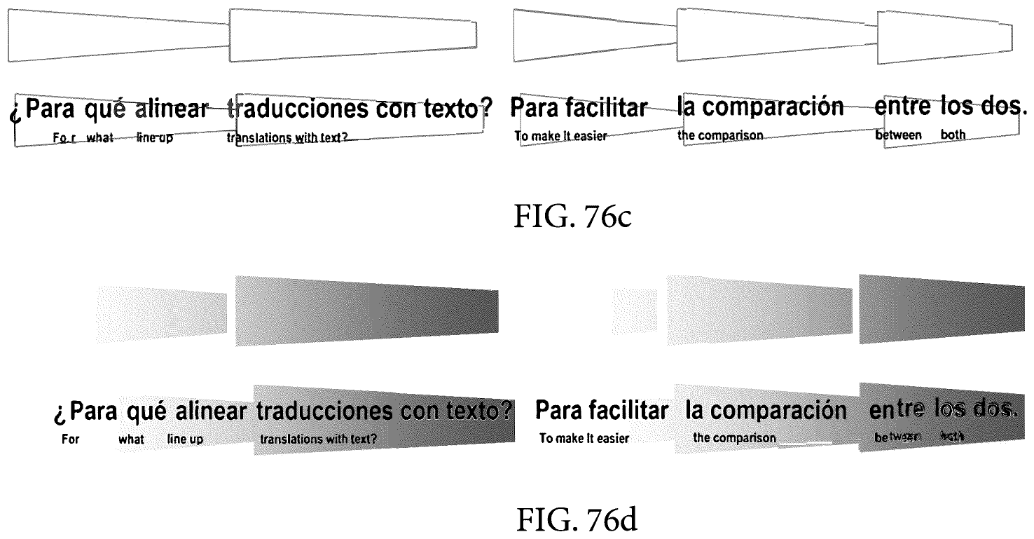

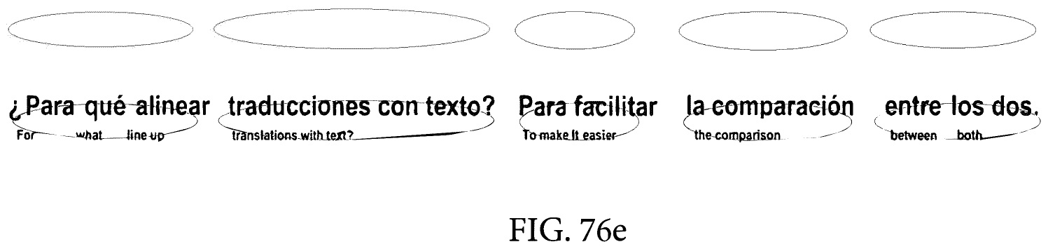

FIG. 76a shows two sets of demarcations (top) and a demarcated Spanish and English text string (bottom), according to an embodiment. The first set of demarcations 20450 is comprised of the related first 20440 and second 20442 demarcations while the second set of demarcations 20452 is comprised of the related third 20444, fourth 20446, and fifth 20448 demarcations. Related demarcations are discrete such that, when placed proximate to a text string, a reader can differentiate one demarcation from adjacent demarcations of the same set. Here, the demarcations are hollow structures.

When the demarcations are placed proximate to a text string, each demarcation interacts with a group of text substrings, defining associations among those text substrings. For example, the first demarcation 20440 interacts with the text substrings of “¿ Para,” “qué,” “alinear,” “For,” “what,” and “line up,” defining an association among those six text substrings. Here the demarcations define a Spanish phrase and its English translation. Each demarcation is placed such that the entire demarcation is in between the descender line of the lower text string and the ascender line of the upper text string. Such demarcation placement allows text strings to be demarcated without interfering with any text strings, and with no harm to the readability of the text string.

Thus, a preferred method of using sets of demarcations to define an association between text substrings requires each demarcation to 1) be discrete and 2) to interact with a group of text substrings. The demarcations define an association between text substrings. Such demarcations embody a significant advance over traditional demarcations that cannot define an association among text substrings.

FIGS. 76b-76d show sets of demarcations where each of the demarcations is discrete and interacts with a group of text substrings. The demarcations define associations among the text substrings. Such demarcations embody a significant advance over traditional demarcations that do not define associations without harming the readability of the text strings.

FIG. 76b shows two sets of demarcations (top) and demarcated Spanish and English text strings (bottom), according to an embodiment. Here, the demarcations are hollow structures that define associations between the Spanish phrases and their English translations. Each demarcation is placed such that the bottom edge of the demarcation is at the base line of lower text string and the top edge of the demarcation is at the base line of the upper text string. Such demarcation placement, where the demarcations do not interact with an inner airspace of the text substrings, allows text strings to be demarcated without interfering with any text strings, and with no harm to the readability of the text string.

FIG. 76c shows two sets of demarcations (top) and demarcated Spanish and English text strings (bottom), according to an embodiment. Here, the demarcations are hollow arrow-like structures that define associations between the Spanish phrases and their English translations.

FIG. 76d shows two sets of demarcations (top) and demarcated Spanish and English text string (bottom), according to an embodiment. Here, the demarcations are arrow-like structures with a gradual gradient that define associations between the Spanish phrases and their English translations.

FIG. 76e shows a set of demarcations (top) and demarcated Spanish and English text string (bottom), according to an embodiment. Here, the demarcations are hollow elliptical structures that define associations between the Spanish phrases and their English translations.

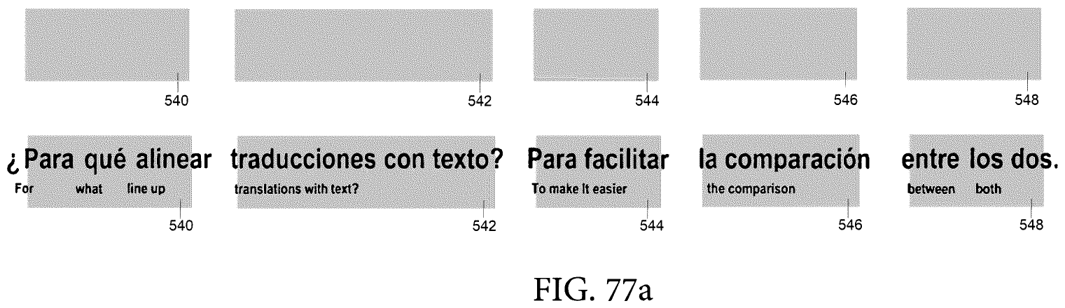

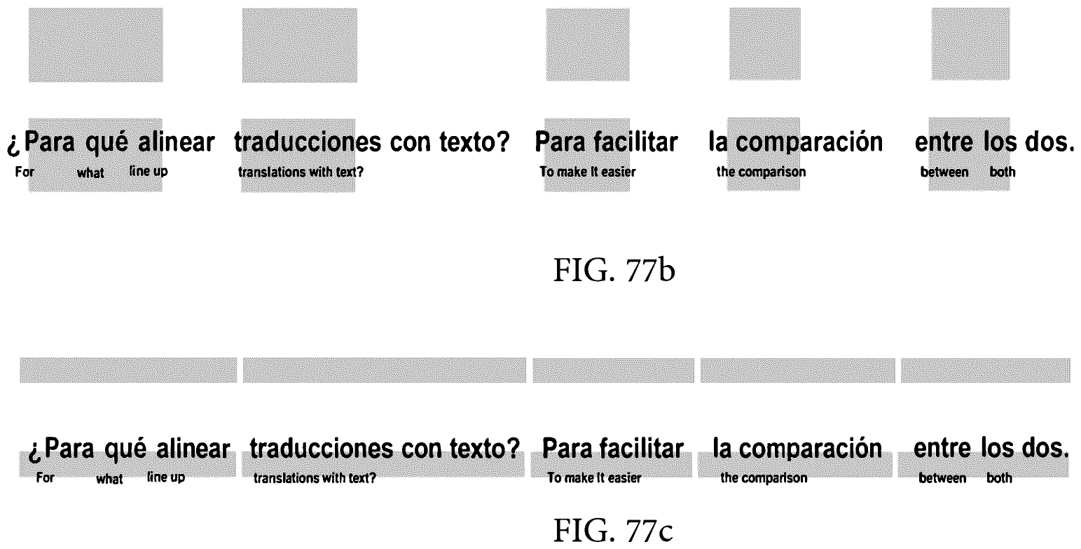

FIG. 77a shows a set of demarcations (top) and a demarcated Spanish and English text string (bottom), according to an embodiment. The set of demarcations 20550 is comprised of related first 20540 and second 20542, third 20544, fourth 20546, and fifth 20548 demarcations. Related demarcations are discrete such that, when placed proximate to a text string, a reader can differentiate one demarcation from adjacent demarcations of the same set. Here, the demarcations are shaded structures.

When the demarcations are placed proximate to a text string, each demarcation interacts with a group of text substrings, defining associations among those text substrings. For example, the first demarcation 20540 interacts, or contains within it, with the text substrings of “¿Para,” “qué,” “alinear,” “For,” “what,” and “line up,” defining an association among those six text substrings. Here the demarcations define Spanish phrases and their English translations. Each demarcation is placed such that an area in between adjacent primary text substructures (here the Spanish text phrases) is completely clear of obstructions. Such demarcation placement allows text strings to be demarcated without interfering with the flow of the primary text string.

Thus, a preferred method of using sets of demarcations to define an association between text substrings requires each demarcation to 1) be discrete, 2) to interact with, or to contain within it, a group of text substrings The demarcations define an association between text substrings. Such demarcations embody a significant advance over traditional demarcations that cannot define an association among text substrings without interfering with the readability of one or both text strings.

FIG. 77b shows a set of demarcations (top) and a demarcated Spanish and English text string (bottom), according to an embodiment. The demarcations are shaded structures that define Spanish phrases and their English translations. Each demarcation is placed such that such that areas in between adjacent primary text substructures (here the Spanish text phrases) and areas in between adjacent secondary text substrings (here the English text phrases) are completely clear of obstructions. Such demarcation placement allows text strings to be demarcated without interfering with the flow of the primary and secondary text strings.

FIG. 77c shows a set of demarcations (top) and a demarcated Spanish and English text string (bottom), according to an embodiment. The demarcations are shaded structures that define Spanish phrases and their English translations. Each demarcation is placed such that such that areas in between adjacent primary text substructures (here the Spanish text phrases) and areas in between adjacent secondary text substrings (here the English text phrases) are mostly clear of obstructions. Such demarcation placement allows text strings to be demarcated with minimal harm to the flow of the primary and secondary text strings.

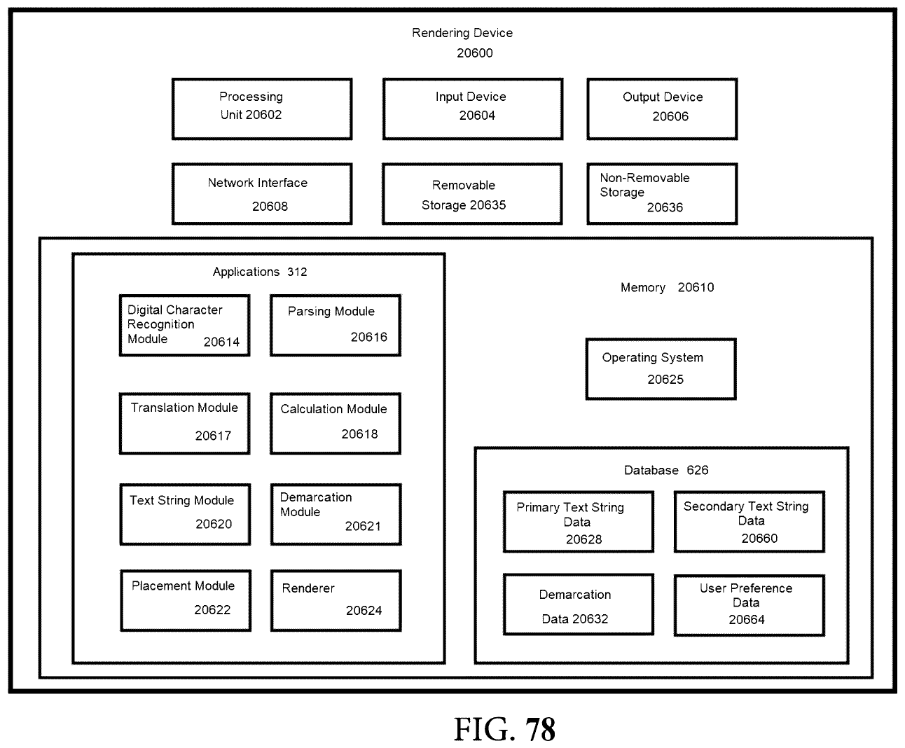

FIG. 78 is a block diagram illustrating example physical components (e.g. hardware) of a rendering device 20600 with which aspects of the disclosure may be practiced, the rendering device 20600 comprising at least one processing unit 20602 and memory 20610. The rendering device 20600 may be referred to as the system.

In an embodiment, the system is configured to display a primary text string and a secondary text string in a clutter-reducing manner, the system comprising: memory storing executable instructions; a processing device executing the instructions, wherein the instructions cause the system to: receive a primary text string comprised of a plurality of primary substrings; receive a secondary text string comprised of a plurality of secondary substrings, wherein each of the secondary substrings is one of a translation and transliteration of its corresponding primary substring; receive a plurality of shaped markers; render, in real-time, substring pairs for display, wherein each of the rendered substring pairs comprises one of the secondary substrings placed next to its corresponding primary substring; display, on an electronic display, the substring pairs; wherein: a structure of the primary text string includes at least a first superstructure and a second superstructure; each of the first and second superstructures is comprised of a plurality of substructures; the substring pairs are demarcated by the plurality of shaped markers such that the shaped markers define at least one of the substructures and the substructures of the primary text string; the substructures and the superstructures of the primary text string are defined; when, for each of the substring pairs, a given secondary substring is not horizontally offset from its corresponding primary substring: rectangular primary inter-airspaces laterally border primary substrings, wherein the left edge of a given rectangular primary inter-airspace is defined by a first vertical line flush with the rightmost point of an immediately left primary substring or the left edge of a page; the right edge of the given rectangular primary inter-airspace is defined by a second vertical line flush with the leftmost point of an immediately right primary substring or the right edge of the page; the bottom edge of the given rectangular primary inter-airspace is defined by a first horizontal line flush with a descender line of immediately adjacent primary substrings; the top edge of the given rectangular primary inter-airspace is defined by a second horizontal line flush with an ascender line of the immediately adjacent primary substrings; rectangular secondary inter-airspaces laterally border secondary substrings, wherein the left edge of a given rectangular secondary inter-airspace is defined by a first vertical line flush with the rightmost point of an immediately left secondary substring or the left edge of the page; the right edge of the given rectangular secondary inter-airspace is defined by a second vertical line flush with the leftmost point of an immediately right secondary substring or the right edge of the page; the bottom edge of the given rectangular secondary inter-airspace is defined by a first horizontal line flush with a descender line of immediately adjacent secondary substrings; and the top edge of the given rectangular secondary inter-airspace is defined by a second horizontal line flush with an ascender line of the immediately adjacent secondary substrings; a given shaped marker is not entirely within one of the rectangular primary inter-airspace or one of the rectangular secondary inter-airspace, wherein the given shaped marker is not entirely in between adjacent substring pairs, wherein when the leftmost point of the given shaped marker is in between the rightmost point of the immediately left substring pair and the leftmost point of the immediately right substring pair, the rightmost point of the given shaped marker is not in between the rightmost point of the immediately left substring pair and the leftmost point of the immediately right substring pair; adjoining shaped markers form groups of adjoined shaped markers, wherein a given group of adjoined shaped markers or the given shaped marker does not fully enclose a first substring pair and a second substring pair, wherein the first substring pair is positioned on a first line and the second substring pair is positioned on a second line; a substring in the second substring pair is a translation or a transliteration of a substring of the first substring pair.

In an embodiment, a first portion of the first superstructure is on a same line as a second portion of the second superstructure.

In an embodiment, when the shaped markers only define the substructures of the primary text string: the superstructures of the primary text string are defined by at least one of: an increased spacing between substrings of different superstructures; punctuation between the substrings of different superstructures; when the shaped markers only define the superstructures of the primary text string: the substructures of the primary text string are defined by at least one of: an increased spacing between substrings of the same superstructure; and punctuation between the substrings of the same superstructure.

In an embodiment, at least one of the substructures and the superstructures of the primary text string are further defined by an increased spacing in between the substring pairs.

In an embodiment, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; a sum of widths of the shaped markers that enter a given substring airspace is equal to or greater than two average character widths of characters in the primary substring, wherein a character width is defined by a horizontal distance between the leftmost point of a character and the rightmost point of a character; and a width of a given shaped marker is defined by a horizontal distance between the leftmost point of the given shaped marker and the rightmost point of the given shaped marker.

In an embodiment, the shaped markers are not textual commentary, wherein textual commentary includes at least punctuation, tropes, and accents.

In an embodiment, the substructures and the superstructures of the primary text string are defined by the shaped markers.

In an embodiment, none of the shaped markers is adjoined to another shaped marker.

In an embodiment, the shaped markers within the given group of adjoined shaped markers are laterally joined.

In an embodiment, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; for each of the shaped markers within the given rectangular substring airspace: the topmost point of the shaped marker is at or below the topmost point of a corresponding substring pair and the bottommost point of the given shaped marker is at or above the bottommost point of the corresponding substring pair. In an embodiment, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; for each of the shaped markers within the given rectangular substring airspace: the topmost point of the shaped marker is at or below the x-height line of an upper substring the corresponding substring pair and the bottommost point of the given shaped marker is at or above the baseline of a lower substring in the corresponding substring pair.

In an embodiment, for each of the substring pairs, a given secondary substring is horizontally offset from the corresponding primary substring.

In an embodiment, each of the primary substrings, less a first primary substring, is vertically and horizontally offset from an immediately previous primary substring.

In an embodiment, the instructions further cause the system to: set, based on user preference, a first type of grammatical unit for the substructures and a second type of grammatical unit for the superstructures; define structures of the primary text string, wherein the defined structures include at least the substructures and the superstructures of the primary text string; the structures are defined via operations of a natural language processing service; the natural language processing service defines the structures as output from at least one automated parser.

In an embodiment, when the first type of grammatical unit is a word, the second type of grammatical unit is a phrase; when the first type of grammatical unit is a phrase, the second type of grammatical unit is a sentence; and when the first typic of grammatical unit is a sentence, the second type of grammatical unit is a plurality of sentences.

In an embodiment, at least one of the shaped markers enters one of the primary inter-airspaces and one of the secondary inter-airspaces; and the at least one of the of shaped markers that enters one of the primary inter-airspaces and one of the secondary inter-airspaces defines the superstructures of the primary text string.

In an embodiment, the shaped markers comprise at least a first set of shaped markers and a second set of shaped markers; the first set of shaped markers, when viewed individually, defines the substructures of the first superstructure, and, when viewed together, defines the first superstructure; the second set of shaped markers, when viewed individually, defines the substructures of the second superstructure, and, when viewed together, defines the second superstructure; wherein a first visual property of each of the shaped markers in the first set of shaped markers varies in the reading direction of the primary text string; a second visual property of each of the shaped markers in the second set of shaped markers varies in the reading direction of the primary text string; and the variance of the second visual property is not a continuation of the variance of the first visual property such that, when the demarcated substring pairs are displayed, the first set of shaped markers is distinguishable from the second set of shaped markers.

In an embodiment, the variance of the first and second visual properties is gradual or discrete.

In an embodiment, the first visual property is the color of the shaped markers in the first set of shaped markers; the second visual property is the color of the shaped markers in the second set of shaped markers; and the variance of the first and second visual properties is a color variance.

In an embodiment, the first visual property is the color of the shaped markers in the first set of shaped markers; the second visual property is the color of the shaped markers in the second set of shaped markers; and the variance of the first and second visual properties is a shading variance.

In an embodiment, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page; the top edge of the given rectangular substring airspace is defined by a sixth horizontal line flush with the bottommost point of the immediately above substring pair or the top edge of the page; the shaped markers includes a plurality of narrow shaped markers and a plurality of wide shaped markers, wherein a given narrow shaped marker is mostly within the rectangular airspace of only one of the substring pairs such that the narrow shaped markers define the substructures of the primary text string; and a given wide shaped marker is within the rectangular airspace of at least two of the substring pairs such that the wide shaped markers define the superstructures of the primary substring.

In an embodiment, each of the substring pairs has a rectangular substring airspace, wherein the left edge of a given rectangular substring airspace is defined by a fifth vertical line flush with the rightmost point the immediately left substring pair or the left edge of the page; the right edge of a given rectangular substring airspace is defined by a sixth vertical line flush with the leftmost point of the immediately right substring pair of the right edge of the page; and the bottom edge of the given rectangular substring airspace is defined by a fifth horizontal line flush with the topmost point of the immediately below substring pair or the bottom edge of the page, the top edge of the given rectangular substring airspace is defined by a sixth horizontal line flush with the bottommost point of the immediately above substring pair or the top edge of the page; each of the rectangular airspaces contains at least one of the shaped markers.

In an embodiment, a given shaped marker comprises a shape that causes one of the secondary substrings to appear on a separate perspective plane relative to the corresponding primary substring, conveying a visual appearance of depth for the secondary substring.

In an embodiment, the shaped markers are a lighter shade than the primary and secondary text strings; or a majority of a page, on which the substring pairs are rendered, is mono-colored.

In an embodiment, for each of the substring pairs, the rightmost point of the secondary substring is at or to the left of the rightmost point of its corresponding primary substring and the leftmost point of the secondary substring is at or to the right of the center point of its corresponding primary substring; or the leftmost point of the secondary substring is at or to the right of the leftmost point of its corresponding primary substring and the rightmost point of the secondary substring is at or to the left of the center point of its corresponding primary substring.

In an embodiment, when the primary text string has a same reading direction as the secondary text string, for each of the substring pairs, the leftmost point of the secondary substring is aligned with the leftmost point of its corresponding primary substring when the same reading direction is left to right; and the rightmost point of the secondary substring is aligned with the rightmost point of its corresponding primary substring when the same reading direction is right to left.

In an embodiment, the instructions further cause the processing device to: receive torah-related commentary; display, on the electronic display, the torah-related commentary next to its corresponding substring pair, wherein the torah-related commentary elaborates on the meaning or intended purpose of the corresponding substring pair.

In an embodiment, for the given group of adjoined shaped markers, a width of the given group of adjoined shaped markers is greater than or equal to a height of the given group of adjoined shaped markers, wherein the width of the given group of adjoined shaped markers is defined by the horizontal distance between the leftmost point of the given group of adjoined shaped markers and the rightmost point of the given group of adjoined shaped markers; and the height of the given group of adjoined shaped markers is defined by the vertical distance between the bottommost point of the given group of adjoined shaped markers and the topmost point of the given group of adjoined shaped markers.

In an embodiment, a given substring pair has an upper substring and a lower substring, the upper substring positioned above the lower substring; and the upper substring in the given substring pair is in English.

The processing unit 20602 executes commands to perform the functions specified in flowcharts and/or block diagram blocks throughout this disclosure. It should be appreciated that processing may be implemented either locally via the processing unit 20602 or remotely via various forms of wireless or wired networking technologies or a combination of both.

The term computer readable media as used herein may include computer storage media.

Computer storage media may include volatile and nonvolatile, removable and non-removable media implemented in any method or technology for storage of information, such as computer readable instructions, data structures, or program modules. The memory 20610, the removable storage device 20635, and the non-removable storage device 20636 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the rendering device 20600. In some embodiments, such computer storage media may be part of the rendering device 20600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Memory 20610 may include various types of short and long-term memory as is known in the art. Memory 20610 may be loaded with various applications 20612 in the form of as computer readable program instructions. These computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Applications 20630 may include a digital recognition module 20614, a parsing module 20616, a translation module 20617, a calculation module 20618, a text string module 20620, a demarcation module 20621, a placement module 20622, and a renderer 20624 as will be further discussed. Accordingly, memory 20610 includes all necessary applications per each embodiment.

The digital character recognition module 20614 identifies, on display screens, text strings and associated text string meta data. According to an embodiment, the digital character recognition module 20614 scans displayed content and uses known character recognition software to identify text strings and associated text string metadata. Metadata (identity, position, typeface, font, size, etc) of each text string may be saved to primary text string data 20628 or secondary text string data 20630.

The parsing module 20616 identifies text strings and associated text string metadata by parsing the tags of HTML content and associated Cascading Style Sheet (CSS) files. According to an embodiment, the parsing module 20616 parses the tags of the HTML content to identify text strings as well as associated Cascading Style Sheet (CSS) files to identify associated text string metadata. Metadata (identity, position, typeface, font, size, etc) of each text string may be saved to primary text string data 20628 or secondary text string data 20630.

The translation module 20617 translates various foreign languages into either English or other chosen languages. According to an embodiment, the translation module 20617 uses known translation software to perform translations of text strings.

The calculation module 20618 defines airspaces of text strings such as airspaces of entire text strings, airspaces of text string substructures, and text string superstructures. Defined text string airspaces may be used for the generation and placement of demarcations, as will be later described. According to an embodiment, the calculation module defines the upper airspace of the text string as the area bounded by the text x-height line, the text ceiling, the leftmost point of the text string, and the rightmost point of the text string. The calculation module defines the inner airspace of the text string as the area bounded by the text base line, the text x-height line, the leftmost point of the text string, and the rightmost point of the text string. The calculation module defines the lower airspace of the text string as the area bounded by the text floor, the text base line, the leftmost point of the string, and the rightmost point of the text string. The calculation module defines the airspace of the text string as the area bounded by the text floor, the text ceiling, the leftmost point of the string, and the rightmost point of the text string.

Alternatively, based on an text string's metadata, the calculation module generates, with the same attributes as the unmodified character, an “x” as well as an exemplary text string of characters with ascenders and descenders such as “pd.” The text ceiling is set to the position of the topmost point of the exemplary string, the text floor is set to the position of the bottommost point of the exemplary string, the text base-line is set to the position of the bottommost point of the “x,” and the text x-height line is set to the position of the topmost point of the “x.” The calculation module defines the upper airspace of the text string as the area bounded by the text x-height line, the text ceiling, the leftmost point of the text string, and the rightmost point of the text string. The calculation module defines the inner airspace of the text string as the area bounded by the text base line, the text x-height line, the leftmost point of the text string, and the rightmost point of the text string. The calculation module defines the lower airspace of the text string as the area bounded by the text floor, the text base line, the leftmost point of the text string, and the rightmost point of the text string. The calculation module defines the airspace of the text string as the area bounded by the text floor, the text ceiling, the leftmost point of the string, and the rightmost point of the text string.

The calculation module 20618 further tokenizes text strings into substructures and superstructures. Tokenized text strings may be used for the generation and placement of demarcations, as will be later described. According to an embodiment, the calculation module 20618 tokenizes a text string into substructures such as words or phrases and into superstructures such as phrases or sentences.

The calculation module 20618 further tokenizes text substrings into groups of associated substrings. Tokenized text strings may be used for the generation and placement of demarcations, as will be later describer. According to an embodiment, the calculation module 20618 tokenizes two text strings into associated text substrings where the substrings are translations of each other.

The calculation module 20617 further identifies which text string structures (e.g., substructures, superstructures, etc.) are split between two lines of text. Tokenized text strings may be used for the generation and placement of demarcations, as will be later described.

The text string module 20621 receives text strings. According to an embodiment, text strings are received from primary text string data 20628 or secondary text string data 20630. Alternatively, when there are no text strings with the desired attributes in primary text string data 20628 or secondary text string data 20630, new text strings may be received when they are input by a user. User preferences for received text strings may be stored in user preference data 20634.

The demarcation module 20621 receives demarcations. According to an embodiment, demarcations are received from demarcation data 20631. The received demarcations may, when placed proximate to the text string, define substructures and superstructures of the text string. The received demarcations may, when placed proximate to the text string, define associations among text substrings. Alternatively, when there are no demarcations with the desired attributes in demarcation data 20631, new demarcations may be received when they are generated by the demarcation modules 20621 or input by a user. Demarcation generation may comprise steps of 1) selecting a type of demarcation and 2) scaling the demarcations. The generated demarcations may, when placed proximate to the text string, define substructures and superstructures of the text string. The received demarcations may, when placed proximate to the text string, define associations among text substrings. The type of demarcation selected may be based on user preferences stored in user preference data 20634. Demarcation scaling may be performed automatically by the calculation module 20618.

The placement module 20622 places and/or superimposes text strings and demarcations during the rendering processes.

The renderer 20624 draws the demarcated text string to be displayed on a display scheme. According to an embodiment, the renderer 20624, in conjunction with the placement module 20622, draws the demarcated text string to be displayed on the display screen.

Memory 20610 may also include an operating system 20625 and a database 20626. The database 20626 may include primary text string data 20628, secondary text string data 20630, demarcation data 20632, and user preference data 20634 as will be further discussed. Accordingly, memory 20610 includes all necessary applications per each embodiment.

The operating system 20625 is suitable for controlling the operation of the rendering device 20600.

Primary text string data 20628 may include all metadata associated with primary text strings including, but not limited to, text string typefaces, fonts, point sizes, dimensions, etc. Secondary text string data 20628 may include metadata of secondary text strings including, but not limited to, text string typefaces, fonts, point sizes, dimensions, etc. Demarcation data 20632 may include all metadata associated with demarcations including, but not limited to, demarcation designs, color, dimensions, etc. User preference data 20634 may include all data associated with user preferences. In certain embodiments, the database 20626 may be implemented locally, whereas in other embodiments, the database 20626 may be implemented remotely.

Text string specific values that depend on text string properties including, but not limited to, text ceiling, text floor, text x-height, and text base line, may be stored as part of primary text string data 20628 or secondary text string data 20630. Accordingly, the database 20626 includes all necessary content per each embodiment.

The rendering device 20600 may further comprise an input device 20604, and output device 606, and a network interface.

The input device 20604 is used to interact with the rendering device 20600. According to an embodiment, the input device 20604 may be a touchscreen or keypad. Alternatively, the input device 20604 may be a microphone for speech capture, a camera for visual text or motion capture, a keyboard, or any other device or method of receiving user inputs and/or commands.

The output device 20606 is used by the rendering device 20600 to interact with a user. According to an embodiment, the output device 20606 may be an electronic display screen in any of the various forms associated with smart devices.

To enable the aforementioned functionality, the rendering device 20600 is operative to employ various Natural Language Processing technologies such as Datasaur OCR labeling tool, Google Cloud Natural Language API, and Apache OpenNLP to perform text string tokenization. Furthermore, the rendering device 20600 is operative to employ various font technologies like variable fonts, raster, vector, TrueType, and Microsoft OpenType and the database 20626 also includes associated font-resource files.

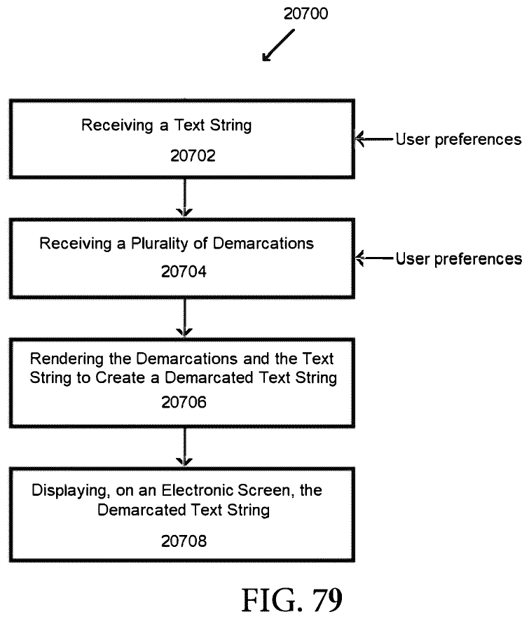

FIG. 79 shows a method 20700 for displaying, on an electronic display, a demarcated text string, according to an embodiment.

In step 1 20702, a text string is received.

According to an embodiment, the text string is received when the digital character recognition module scans the content to identify the text string. Alternatively, the text string is received when the parsing module parses HTML content and associated CSS files. Yet alternatively, the text string is received when a user inputs a text string. The text string may be tokenized into substructures and superstructures. The airspaces of those substructures and superstructures may be defined. The text string may be tokenized into associated substrings. The airspaces of associated text substrings may be defined.

In step 2 20704, a plurality of demarcations are received.

According to an embodiment, the demarcations are received when the demarcations module retrieves demarcations from demarcation data. Alternatively, the demarcations are received when the demarcation module generates demarcations. The type of demarcation generated may be selected based on user preferences and the demarcations may be scaled automatically. The retrieved demarcations may define substructures and superstructures of the text string when placed proximate to the text string. Alternatively, the retrieved demarcations may define associations among text substrings when placed proximate to the text string.

In step 3 20706, the demarcations and the text string are rendered to create a demarcated text string.

According to one embodiment, the renderer, in conjunction with the placement module, draws the demarcated text string to be displayed on the display screen. The demarcated text string may have defined substructures and superstructures. Alternatively, the demarcated text string may have defined associations among its text substrings.

In step 5 20708, the demarcated text string is displayed on an electronic display.

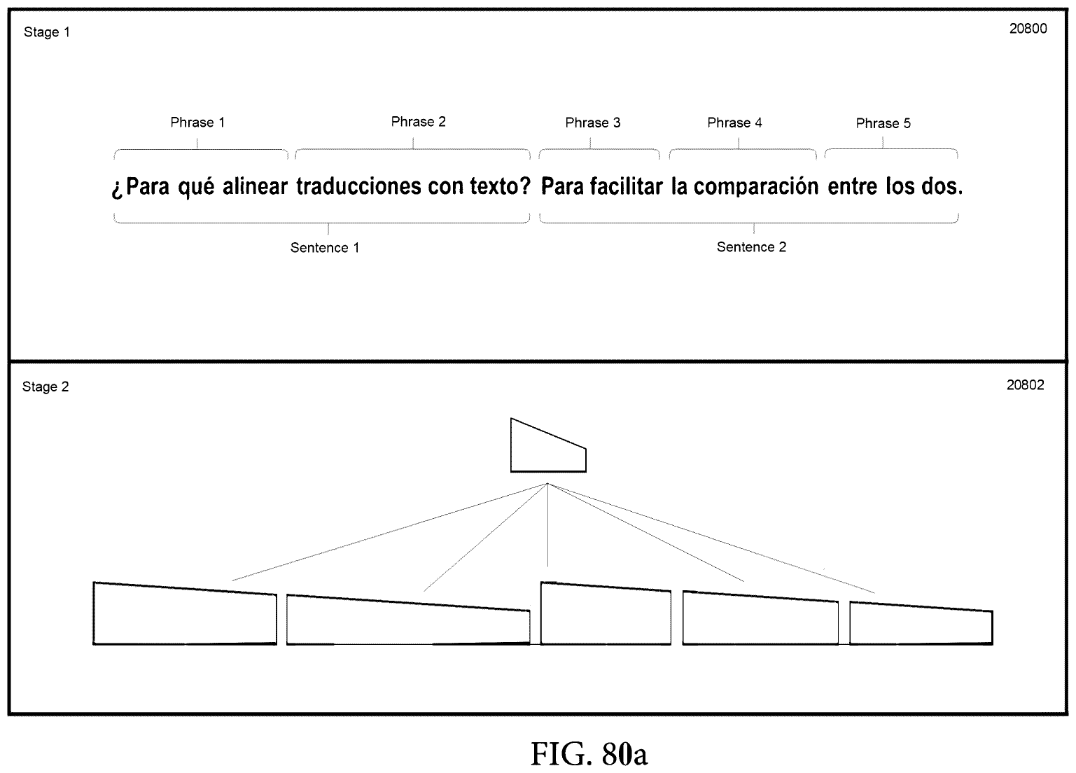

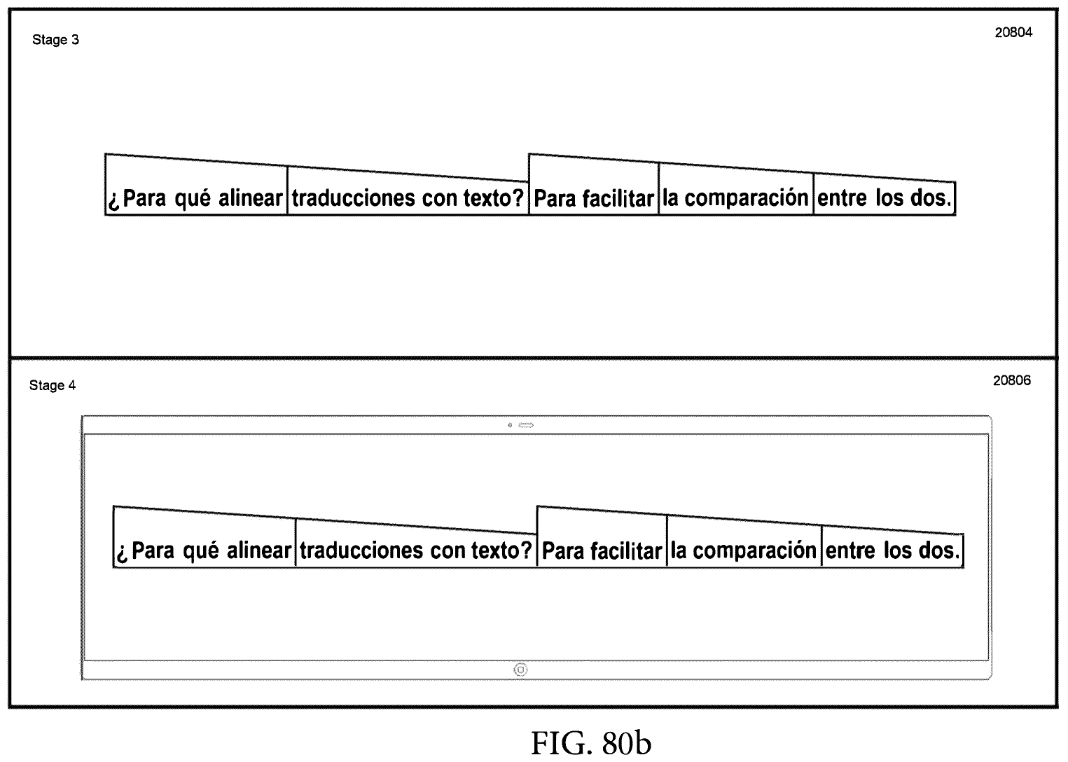

FIGS. 80a-80b show the method of FIG. 79 as applied to an electronic device, according to an embodiment.

Stage 1 20800 shows step 1, in which the text string is received. Here, the text string is identified as “Para qué alinear traducciones con texto? Para facilitar la comparación entre los dos.”

The text string is tokenized into phrases (substructures) of “¿Para qué alinear,” “traducciones con texto?” “Para facilitar,” “la comparación,” and “entre los dos,” and sentences (superstructures) of “¿Para qué alinear traducciones con texto?” and “Para facilitar la comparación entre los dos.” Furthermore, phrase (text string substructure) airspaces have been defined.

Stage 2 20802 shows step 2, in which the demarcations are received when they are generated. The first step of generating demarcations is selecting a type of demarcation (top). Here, the selected demarcation type is a box with an inclined top edge. The second step of generating demarcations is scaling the demarcations (bottom). Here, the demarcations are scaled such that, when placed proximate to a text string, the demarcations surround text substrings and define substructures and superstructures of the text string.

Stage 3 20804 shows step 3, in which the demarcations and the text string are rendered to create a demarcated text string. Here, the demarcated text string has defined substructures and superstructures.

Stage 4 20806 shows step 4, in which the demarcated text string is displayed on an electronic display.

The system embodies a significant advance over existing systems that cannot display text strings in a manner where substructures and superstructures are defined, or, alternatively, in a manner where associations among text substrings are defined.

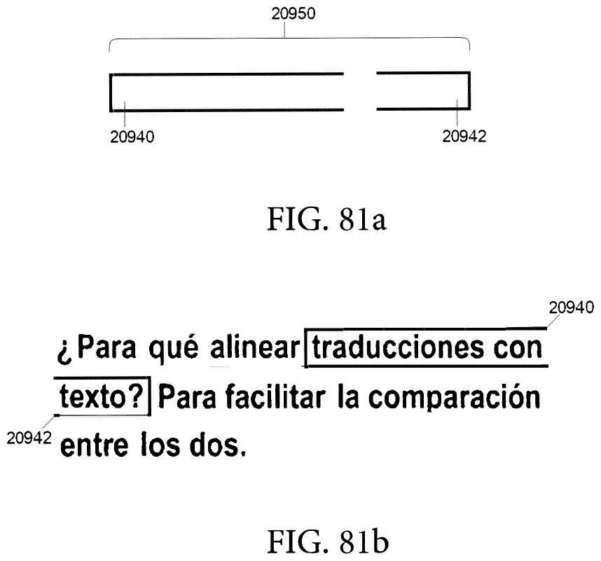

FIG. 81a shows a set of demarcations 20950 comprised of the related first 20940 and second 942 demarcations.

FIG. 81b shows a demarcated Spanish text string, according to an embodiment. One of the phrases, “traducciones con texto?” is split between two lines. The first demarcation 20940 is in placed in proximity to “traducciones con” and the second demarcation is placed in proximity to “texto?” creating a visual association between “traducciones con” and “texto?” Such phrase demarcations allow a reader to effortlessly continue reading from one line to the next. This reduction in mental strain allows the reader focus on the substance of the text rather than looking ahead. It should be appreciated that such demarcations can be placed in proximity to portions of any sentence structure that is split between two lines, including, but not limited to, sentences, words, and groups of words.

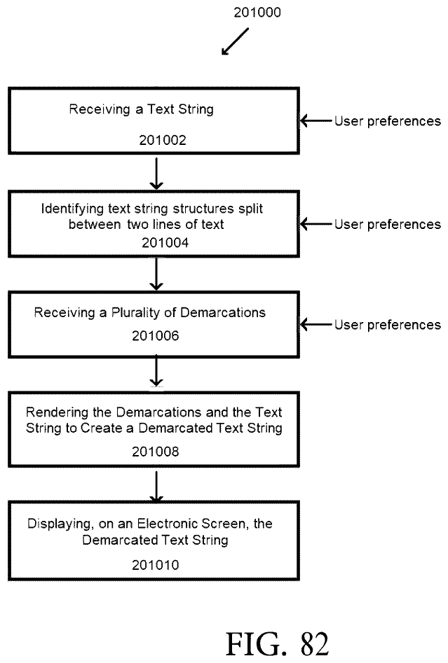

FIG. 82 shows a method 201000 for displaying, on an electronic display, a demarcated text string, according to an embodiment.

In step 1 201002, a text string is received.

According to an embodiment, the text string is received when the digital character recognition module scans the content to identify the text string. Alternatively, the text string is received when the parsing module parses HTML content and associated CSS files. Yet alternatively, the text string is received when a user inputs a text string. The text string may be tokenized into substructures and superstructures. The airspaces of those substructures and superstructures may be defined. The text string may be tokenized into associated substrings. The airspaces of associated text substrings may be defined.

In step 2 201004, a text string structure that is split between two lines of text is identified.

According to an embodiment, the calculation module identifies a text string structure that is split between two lines of text.

In step 3 201006, a plurality of demarcations are received.

According to an embodiment, the demarcations are received when the demarcations module retrieves demarcations from demarcation data. Alternatively, the demarcations are received when the demarcation module generates demarcations. The type of demarcation generated may be selected based on user preferences and the demarcations may be scaled automatically.

In step 4 201008, the demarcations and the text string are rendered to create a demarcated text string.

According to one embodiment, the renderer, in conjunction with the placement module, draws the demarcated text string to be displayed on the display screen. The demarcated text string may have a demarcated text string structure, where the text string structure is split between two lines.

In step 5 201010, the demarcated text string is displayed on an electronic display.

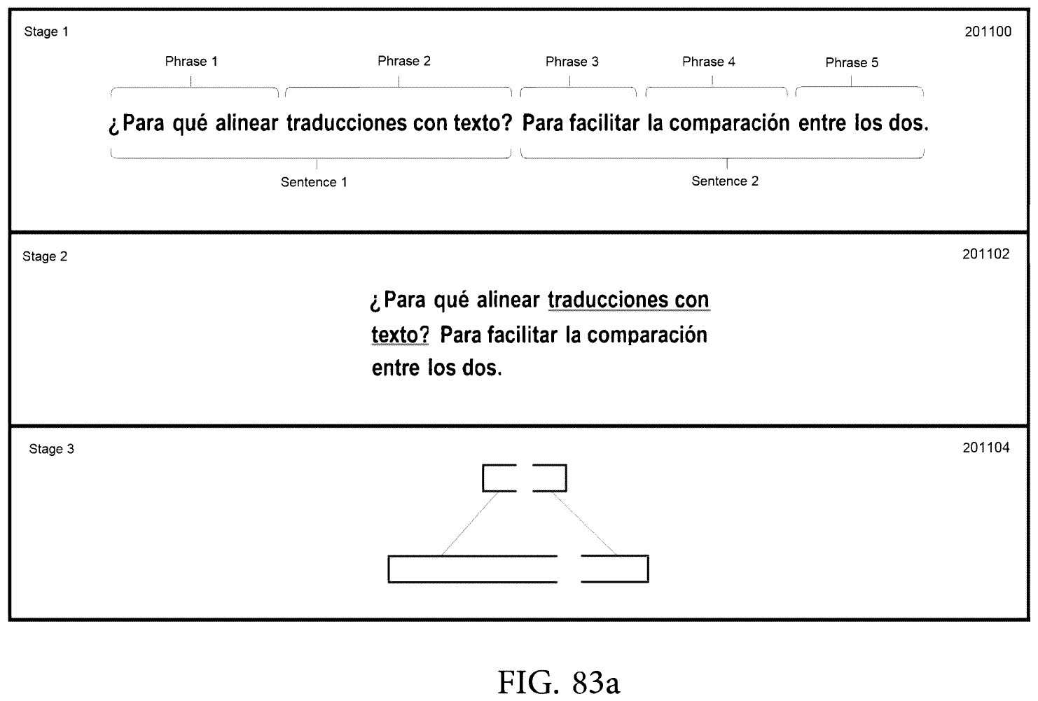

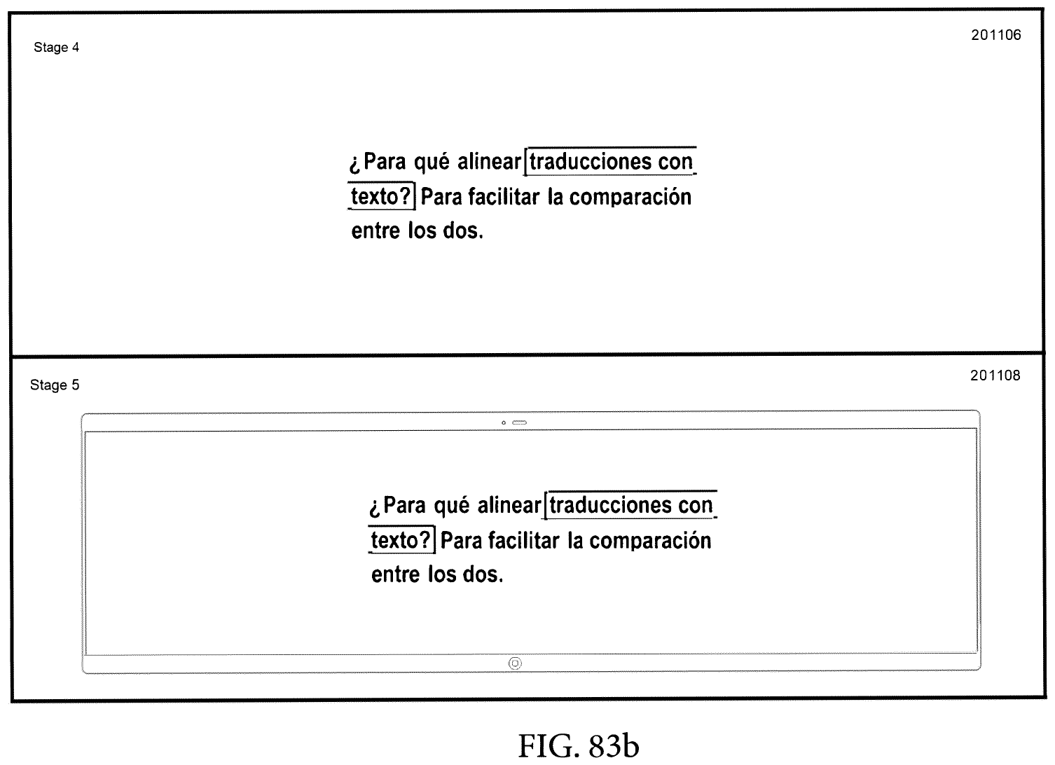

FIGS. 83a-83b show the method of FIG. 82 as applied to an electronic device, according to an embodiment.

Stage 1 201100 shows step 1, in which the text string is received. Here, the text string is identified as “Para qué alinear traducciones con texto? Para facilitar la comparación entre los dos.” The text string is tokenized into phrases (substructures) of “¿Para qué alinear,” “traducciones con texto?” “Para facilitar,” “la comparación,” and “entre los dos,” and sentences (superstructures) of “¿Para qué alinear traducciones con texto?” and “Para facilitar la comparación entre los dos.” Furthermore, phrase (text string substructure) airspaces have been defined.

Stage 2 201102 shows step 2, in which a text string structure that is split between two lines of text is identified. Here, the phrase “traducciones con texto?” is identified as a text string structure that is split between the first and second lines of text.

Stage 3 201104 shows step 3, in which the demarcations are received when they are generated. The first step of generating demarcations is selecting a type of demarcation (top). Here, the selected demarcation type is brackets. The second step of generating demarcations is scaling the demarcations (bottom). Here, the demarcations are scaled such that, when placed proximate to a text string, the demarcations surround portions of the text string structure.

Stage 4 201106 shows step 4, in which the demarcations and the text string are rendered to create a demarcated text string. Here, the demarcated text string may have a demarcated text string structure, where the text string structure is split between two lines.

Stage 5 201108 shows step 5, in which the demarcated text string is displayed on an electronic display.

The system embodies a significant advance over existing systems that cannot display text strings in a manner where text string structures that are split among two lines are demarcated.

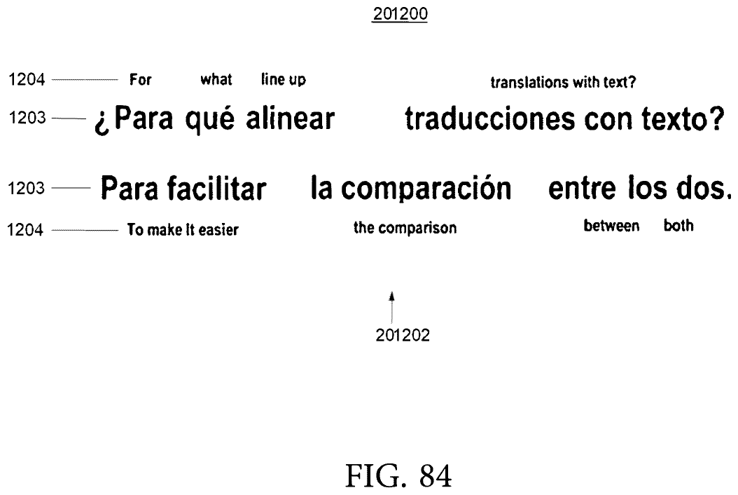

FIG. 84 shows a comparative-text display format (CTDF) 201200 that can employ a related text layout 201202. The text layout 201202 for the CTDF 201200 can include arranging the primary 201203 and secondary 201204 text segments such that 1) the primary text segments are split between a first and second line 2) the secondary text segments corresponding to the primary text segments in the first line are placed above their respective primary text segments and 3) the secondary text segments corresponding to the primary text segments in the second line are placed below their respective primary text segments. Such an arrangement can be used where a display screen has limited width, necessitating the division of a text string into two lines of text.

This arrangement of primary and secondary text segments reduces interference from the secondary text segments when attempting to read the primary text segments uninterrupted. However, the secondary text segments remain close to their corresponding primary text segments in case the reader has to reference the secondary text segments. For example, here, a Spanish language learner can read the first and second lines of “Para qué alinear traducciones con texto?” Para facilitar la comparación entre los dos.” without encountering any of the secondary text segments in between both lines.

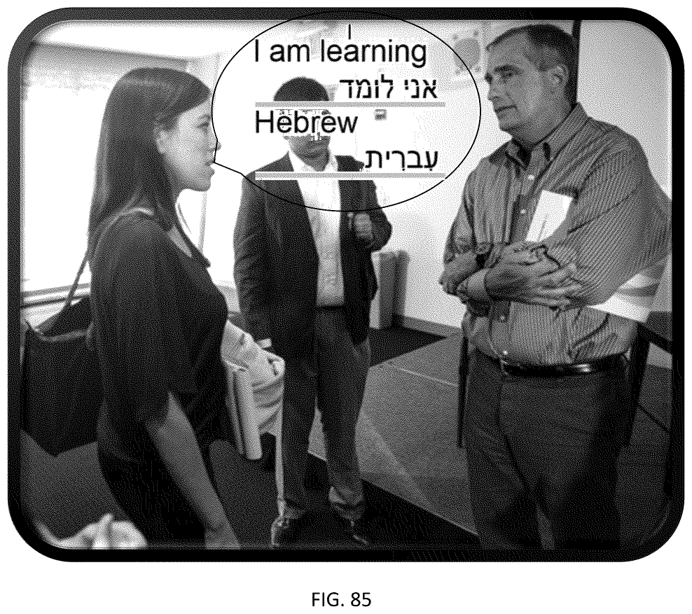

FIG. 85 shows an augmented reality screen with the words heard by the microphone displayed along with a translation of the words, overlaying the real-world video image. In this specific example, three people are talking, with the woman speaking at the specific time of this display. The woman has just said “I am learning Hebrew”, and these words, along with the translation in Hebrew, are placed in the word balloon with the indication that she said these words. The words and the translation could be any of the display techniques and formats described above. In one embodiment, the eye tracking device 344 is used to identify a person who is talking in a room. The eye-tracking information is then used to focus the microphone 340 (perhaps using a directional microphone 340 that is controlled robotically by the computing device 300) on the specific person who is talking, and the spoken words from that person are filtered out of the noise. These spoken words are then processed by the voice-to-text module 346 to generate computer-readable text. This computer-readable text is then sent to the parsing module 316 and the translation module 317, as described above. After the text is processed by the calculation module 318, the placement module 320, and the operations module 322, the translation and the text are sent to the renderer 324 to format for interlinear display on the augmented reality display 342. In some embodiments, the text and the translation are jointly displayed on the augmented reality display 342 in a transparent or translucent word balloon that indicates who said the words. The indication of the speaker with the word balloon is helpful if there is a delay between the speaking and the display of the interlinear translation on the screen. In other embodiments, the words and the translation are displayed in a separate window on one side or another of the augmented reality display 342. In another embodiment, the words and the translation are displayed at the top or the bottom of the augmented reality display 342.

As the words are spoken, the translation may be done in real-time (or close to real-time), allowing the user to hear and see the foreign language conversation as well as to see the translation (silently) in the augmented reality screen 342.

In another embodiment, a virtual reality screen is used in place of the augmented reality display 342. The virtual reality screen could be used to teach a foreign language, with an avatar conducting an audio conversation while the written words and the translation are displayed interlinearly in a word balloon using one or more of the formats described above. This allows the user to hear the foreign language word, see the foreign language word, and see the avatar act out the word, providing three methods of learning the foreign language at the same time.

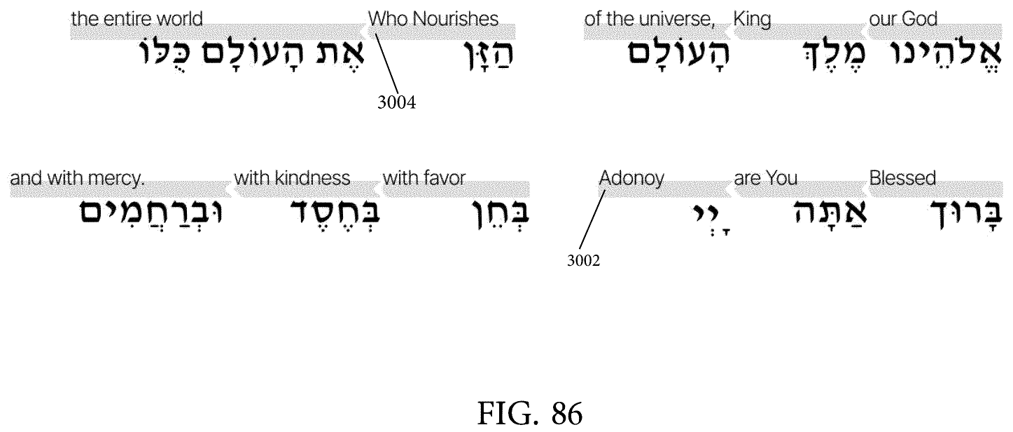

FIG. 86 shows demarcated substring pairs. English substrings are horizontally offset from their corresponding Hebrew substrings. Sets of demarcations (the gray rectangles) define phrases of the Hebrew text string. An appearance or shape of the end of a given demarcation can be used to indicate whether or not the adjacent demarcation is related. For example, if an end 3002 is square, the reader will know that the demarcated substring pair to the left of the end 3002 is unrelated. If an end is rounded 3004, the reader will know that the demarcated substring pair to the left of the end 3004 is related. Thus, using different appearances or shapes for the ends of demarcations helps define substructures and/or superstructures of a text string.

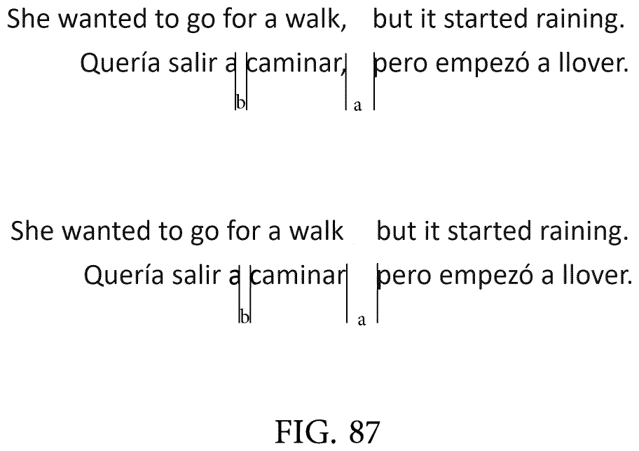

FIG. 87a shows substring pairs. The width of ‘a’ is defined as the horizontal distance between the rightmost point of a comma (or any other punctuation mark used to separate elements within a sentence (e.g., for separating items in a series, setting off introductory elements, and separating clauses)) and the leftmost point of the next primary substring. The width of ‘b’ is defined as the horizontal distance between rightmost points of and leftmost points of adjacent words in the primary substrings. In a preferred embodiment, ‘a’ is at least twice as wide as ‘b’. Alternatively, ‘a’ is at least one and a half times as wide as ‘b’. When substrings pairs are displayed such that ‘a’ is wider than ‘b’, a reader is better able to visualize pauses in the text after each comma (or any other punctuation mark used to separate elements within a sentence).

FIG. 87b shows substring pairs. The width of ‘a’ is defined as the horizontal distance between the rightmost point of a primary substring and the leftmost point of the next primary substring. The width of ‘b’ is defined as the horizontal distance between rightmost points of and leftmost points of adjacent words in the primary substrings. In a preferred embodiment, ‘a’ is at least twice as wide as ‘b’. Alternatively, ‘a’ is at least one and a half times as wide as ‘b’. When substrings pairs are displayed such that ‘a’ is wider than ‘b’, a reader is better able to visualize pauses in the text, even if there is no comma (or any other punctuation mark used to separate elements within a sentence).

Methods in this document are illustrated as blocks in a logical flow graph, which represent sequences of operations that can be implemented in hardware, software, or a combination thereof. In the context of software, the blocks represent computer-executable instructions stored on one or more computer storage media that, when executed by one or more processors, cause the processors to perform the recited operations. Note that the order in which the processes are described is not intended to be construed as a limitation, and any number of the described method blocks can be combined in any order to implement the illustrated method, or alternate methods. Additionally, individual blocks may be deleted from the methods without departing from the spirit and scope of the subject matter described herein.

Any of the methods described can further comprise steps of deemphasizing a portion or an entirety of the first text string and/or deemphasizing a portion or an entirety of a second text string when a deemphasis condition is met. Deemphasis conditions can include, but are not limited to, coming across a word more than once. For example, a user is trying to learn Spanish. A language learning program displays Spanish words with smaller English translations horizontally offset above their corresponding Spanish words. A user can glance at the English translation when they forget the meaning of the Spanish word. However, each time a user comes across the Spanish word, the English translation becomes lighter and lighter, and, eventually, disappears entirely. Such gradual deemphasis prevents the user from over reliance on the English translation.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles. All method steps described within this document may be performed in real-time and automatically by a processer or processors of the system.

We claim:

1. A system for displaying text strings, the system comprising:
a processing circuitry;
a memory, the memory containing instructions that, when executed by the processing circuitry, configure the system to:
receive a first text string comprised of a plurality of first substrings;
receive a translation for each of the plurality of first substrings;
arrange the first substrings and their corresponding translations into a plurality of substring pairs, wherein
each of the plurality of substring pairs includes one of the first substrings and its corresponding translation;
render the plurality of substring pairs, wherein
the plurality of substring pairs is rendered such that each of the translations is horizontally offset from its corresponding first substring; and
display, on an electronic display, the plurality of substring pairs.

2. A method of displaying text strings received by a computing device, the method comprising:
receiving by a processing device within the computing device, a first text string comprised of a plurality of first substrings from a parsing module;
receiving by the processing device a translation for each of the plurality of first substrings from a translation module;
arranging by the processing device the first substrings and their corresponding translations into a plurality of substring pairs by a placement module, wherein
each of the plurality of substring pairs includes one of the first substrings and its corresponding translation;
rendering by the processing device the plurality of substring pairs by a renderer, wherein
the plurality of substring pairs is rendered such that each of the translations is horizontally offset from its corresponding first substring; and
displaying, on an electronic display, the plurality of substring pairs.

3. The method of claim 2, wherein
the electronic display is updated in real-time when an update condition is met; and
the method is performed on the computing device that is configured to continuously monitor for update conditions.

4. The method of claim 2, wherein
each of the translations is horizontally offset from its corresponding first substring in a reading direction of the first text string.

5. The method of claim 2, wherein
each of the translations is horizontally offset from its corresponding first substring by at least a syllable of its corresponding first substring.

6. The method of claim 2, wherein
each of the translations is displayed in a different style than its corresponding first substring.

7. The method of claim 2, wherein
each of the translations horizontally overlaps its corresponding first substring.

8. The method of claim 2, wherein
a rightmost point of each of the translations is at or to the left of the rightmost point of its corresponding first substring; and
a leftmost point of each of the translations is at or to the right of the center point of its corresponding first substring.

9. The method of claim 2, wherein
a leftmost point of each of the translations is at or to the right of the leftmost point of its corresponding first substring; and
a rightmost point of each of the translations is at or to the left of the center point of its corresponding first substring.

10. The method of claim 2, wherein
the first text string is comprised of at least four first substrings;
at least two of the first substrings are displayed on a first line; and
at least two of the first substrings are displayed on a second line.

11. The method of claim 2, wherein
when a given translation is positioned above its corresponding first substring:
a descender line of the given translation is below an ascender line of its corresponding first substring;
when a given translation is positioned below its corresponding first substring:
an ascender line of the given translation is above the descender line of the corresponding first substring.

12. The method of claim 2, wherein
a placement of the translations relative to their corresponding first substrings alternates from above the corresponding first substring to below the corresponding first substring.

13. The method of claim 2, wherein
there is a first spacing in between adjacent first substrings belonging to a same structural unit or in between demarcations corresponding to the first substrings belonging to the same structural unit;
there is a second spacing in between adjacent first substrings belonging to a different structural unit or in between demarcations corresponding to the first substrings belonging to the different structural unit; and
a width of the first spacing is not equal to a width of the second spacing.

14. The method of claim 13, wherein
the width of the first spacing is less than the width of the second spacing.

15. The method of claim 2, wherein
a horizontal spacing in between adjacent first substrings defines substructures of the first text string; and
a vertical spacing in between groups of adjacent first substrings defines superstructures of the first text string.

16. The method of claim 2, wherein
the substring pairs are demarcated by shaped markers.

17. The method of claim 16, wherein
the shaped markers define substructures and superstructures of the first text string.

18. The method of claim 2, wherein
at least four first substrings are received; and
the at least four first substrings are vertically arranged.

19. The method of claim 2, wherein
at least three first substrings are received;
the at least three first substrings are consecutive and horizontally arranged; and
for each of the at least three first substrings, a direction of the horizontal offset in between the translation and its corresponding first substring is the same.

20. The method of claim 2, wherein
a reading direction of the first text string and the translations is left to right.

21. The method of claim 2, wherein
for at least one line, each of the translations on the at least one line is horizontally offset from its corresponding first substring.

22. The method of claim 2, wherein
each of the translations is horizontally offset from its corresponding first substring by at least the first two characters of its corresponding first substring.

23. The method of claim 2, wherein
a first horizontal overlap between a given translation and its corresponding first substring is greater than a second horizontal overlap between the given translation and an adjacent first substring belonging to an adjacent substring pair.

24. The method of claim 2, wherein
when a given translation cannot positioned such that a first horizontal overlap between a given translation and its corresponding first substring is greater than a second horizontal overlap between the given translation and an adjacent first substring belonging to an adjacent substring pair:
the method further includes steps of:
reducing a width of the given translation; or
dividing the translation among two lines.

25. The method of claim 2, wherein
a portion of one of the first substrings is distinguished from a remainder of the one of the first substrings;
a portion of one of the translations is distinguished from a remainder of the one of the translations;
the portion of the one of the translations corresponds to the portion of the one of the first substrings.

26. The method of claim 2, wherein
a majority of the first substrings contain five or fewer words; and
a majority of the translations contain five or fewer words.

27. The method of claim 2, wherein
for a given first substring pair in a first line and a given second substring pair in a second line, the second line being the line immediately below the first line:
a first vertical distance in between a baseline of a topmost substring in the first given substring pair and the baseline of a bottommost substring in the given first substring pair is less than a second vertical distance in between a baseline of the bottommost substring in the given first substring pair and the baseline of the topmost substring in the given second substring pair.

28. The method of claim 2, wherein
when a given substring pair has an immediately right substring pair:
a horizontal distance in between a rightmost point of a given substring pair and a leftmost point of the immediately right substring pair is zero;
when the given substring pair has an immediately left substring pair:
a horizontal distance in between a leftmost point of a given substring pair and the rightmost point of the immediately left substring pair is zero.

29. A non-transitory computer readable medium having stored thereon instructions for causing a processing circuitry to execute a process, the process comprising:
receiving a first text string comprised of a plurality of first substrings;
receiving a translation for each of the plurality of first substrings;
arranging the first substrings and their corresponding translations into a plurality of substring pairs, wherein
each of the plurality of substring pairs includes one of the first substrings and its corresponding translation;
rendering the plurality of substring pairs, wherein
the plurality of substring pairs is rendered such that each of the translations is horizontally offset from its corresponding first substring; and
displaying, on an electronic display, the plurality of substring pairs.
